(19) United States
(12) Patent Application Publication
(10) Pub. No.: US 2026/0245490 A1
(43) Pub. Date: Aug. 20, 2026

(54) PIXEL CIRCUIT, PIXEL DRIVING METHOD AND DISPLAY DEVICE

(71) Applicants: Beijing BOE Technology Development Co., Ltd., Beijing (CN); BOE TECHNOLOGY GROUP CO., LTD., Beijing (CN)

(72) Inventors: Can Wang, Beijing (CN); Ying Zhou, Beijing (CN); Can Zhang, Beijing (CN); Minghua Xuan, Beijing (CN); Ning Cong, Beijing (CN); Jinfei Niu, Beijing (CN); Jiakui Yan, Beijing (CN)

(73) Assignees: Beijing BOE Technology Development Co., Ltd., Beijing (CN); BOE TECHNOLOGY GROUP CO., LTD., Beijing (CN)

(21) Appl. No.: 18/852,748

(22) PCT Filed: Sep. 1, 2023
(86) PCT No.: PCT/CN2023/116391

§ 371 Date: Sep. 30, 2024

(30) Foreign Application Priority Data
Sep. 1, 2022 (WO) PCT/CN2022/116456

(51) Int. Cl. G09G 3/20

(52) U.S. Cl. CPC G09G 3/2007; G09G 2300/0852; G09G 2300/0861; G09G 2310/08; G09G 2320/0233

(57) ABSTRACT

The pixel circuit includes a first light emitting control circuit, a light emitting element, a driving circuit and a light emitting gating circuit; the light emitting gating circuit controls, under the control of a first control signal, according to the light emitting data voltage, to form a current path between the second terminal of the driving circuit and the light emitting element in the light emitting phase under the control of the light emitting control voltage, to control the driving circuit to control the light emitting element to emit light, or to control to form the current path between the second terminal of the driving circuit and the light emitting element in the light emitting phase, to control the driving circuit to control the light emitting element to emit light.

### CROSS-REFERENCE TO RELATED APPLICATION

The present disclosure claims the priority of PCT international application No. PCT/CN2022/116456 filed on Sep. 1, 2022, which is incorporated herein by reference in its entirety.

### TECHNICAL FIELD

The present disclosure relates to the field of display technology, in particular to a pixel circuit, a pixel driving method and a display device.

### BACKGROUND

The light emitting element (the light emitting element may be, for example, a mini light emitting diode or a micro light emitting diode) has the problems of poor brightness uniformity at low current density and insufficient low grayscale control capability, and the brightness control capability of low grayscale is poor.

### SUMMARY

In one aspect, the present disclosure provides in some embodiments a pixel circuit, including a first light emitting control circuit, a light emitting element, a driving circuit and a light emitting gating circuit; wherein the first light emitting control circuit is electrically connected to a first light emitting control terminal, a first voltage terminal and a first terminal of the driving circuit respectively, and is configured to control the connection between the first voltage terminal and the first terminal of the driving circuit under the control of a first light emitting control signal provided by the first light emitting control terminal during a light emitting phase; a second terminal of the driving circuit is electrically connected to a first electrode of the light emitting element, and the driving circuit is configured to drive the light emitting element; the light emitting gating circuit is configured to control, under the control of a first control signal provided by the first control terminal, according to a light emitting data voltage provided by the light emitting data voltage terminal, to form a current path between the second terminal of the driving circuit and the light emitting element in the light emitting phase under the control of a light emitting control voltage provided by the light emitting control voltage terminal, to control the driving circuit to control the light emitting element to emit light, or to control to form the current path between the second terminal of the driving circuit and the light emitting element in the light emitting phase, to control the driving circuit to control the light emitting element to emit light, or to control to generate the current path between the second terminal of the driving circuit and the light emitting element in the light emitting phase under the control of the first light emitting control signal, to control the driving circuit to control the light emitting element to emit light.

Optionally, the light emitting gating circuit includes a second light emitting control circuit and a first gating control circuit; the first gating control circuit is electrically connected to the first control terminal, the light emitting data voltage terminal, a gating control terminal, a second light emitting control terminal, a light emitting control voltage terminal and the first light emitting control terminal respectively, and is configured to write a light emitting data voltage provided by the light emitting data voltage terminal into the gating control terminal under the control of the first control signal, and control the second light emitting control terminal to be connected to the light emitting control voltage terminal or to be connected to the first light emitting control terminal under the control of a potential of the gating control terminal; the second light emitting control circuit is electrically connected to the second light emitting control terminal, the second terminal of the driving circuit and the first electrode of the light emitting element respectively, and is configured to control the second terminal of the driving circuit to be connected to the first electrode of the light emitting element under the control of a potential of the second light emitting control terminal; a second electrode of the light emitting element is electrically connected to the second voltage terminal.

Optionally, the light emitting gating circuit further comprises a first capacitor; a first terminal of the first capacitor is electrically connected to the gating control terminal, and a second terminal of the first capacitor is electrically connected to the first initial voltage terminal.

Optionally, the first gating control circuit comprises a first transistor, a second transistor and a third transistor; a control electrode of the first transistor is electrically connected to the first control terminal, a first electrode of the first transistor is electrically connected to the light emitting data voltage terminal, and a second electrode of the first transistor is electrically connected to the gating control terminal; a control electrode of the second transistor is electrically connected to the gating control terminal, a first electrode of the second transistor is electrically connected to the light emitting control voltage terminal, and a second electrode of the second transistor is electrically connected to the second light emitting control terminal; a control electrode of the third transistor is electrically connected to the gating control terminal, a first electrode of the third transistor is electrically connected to the first light emitting control terminal, and a second electrode of the third transistor is electrically connected to the second light emitting control terminal.

Optionally, the second light emitting control circuit comprises a fourth transistor; a control electrode of the fourth transistor is electrically connected to the second light emitting control terminal, a first electrode of the fourth transistor is electrically connected to the second terminal of the driving circuit, and a second electrode of the fourth transistor is electrically connected to the first electrode of the light emitting element.

Optionally, the first transistor is an n-type transistor, the second transistor is a p-type transistor, and the third transistor is an n-type transistor; or, the first transistor is an n-type transistor, the second transistor is an n-type transistor, and the third transistor is a p-type transistor; or, the first transistor is a p-type transistor, the second transistor is an n-type transistor, and the third transistor is a p-type transistor.

Optionally, when the second transistor is a p-type transistor and the third transistor is an n-type transistor, a width-to-length ratio of a channel of the third transistor is greater than a width-to-length ratio of a channel of the second transistor.

Optionally, the light emitting gating circuit includes a second gating control circuit, a third light emitting control circuit and a fourth light emitting control circuit; the second gating control circuit is electrically connected to the first control terminal, the light emitting data voltage terminal and the gating control terminal respectively, and is configured to write the light emitting data voltage into the gating control terminal under the control of the first control signal; the third light emitting control circuit is electrically connected to the gating control terminal, the second electrode of the light emitting element and the second voltage terminal respectively, and is configured to control the connection between the second electrode of the light emitting element and the second voltage terminal under the control of the potential of the gating control terminal; the fourth light emitting control circuit is electrically connected to the light emitting control voltage terminal, the second electrode of the light emitting element and the second voltage terminal respectively, and is configured to control the connection between the second electrode of the light emitting element and the second voltage terminal under the control of the light emitting control voltage provided by the light emitting control voltage terminal.

Optionally, the pixel circuit further includes a fifth light emitting control circuit; wherein the fifth light emitting control circuit is electrically connected to the first light emitting control terminal, the second terminal of the driving circuit and the first electrode of the light emitting element respectively, and is configured to control the connection between the second terminal of the driving circuit and the first electrode of the light emitting element under the control of the first light emitting control signal.

Optionally, the light emitting gating circuit further comprises a second capacitor; a first terminal of the second capacitor is electrically connected to the gating control terminal, a second terminal of the second capacitor is electrically connected to the first initial voltage terminal.

Optionally, the second gating control circuit includes a fifth transistor, the third light emitting control circuit includes a sixth transistor, and the fourth light emitting control circuit includes a seventh transistor; a control electrode of the fifth transistor is electrically connected to the first control terminal, a first electrode of the fifth transistor is electrically connected to the light emitting data voltage terminal, and a second electrode of the fifth transistor is electrically connected to the gating control terminal; a control electrode of the sixth transistor is electrically connected to the gating control terminal, a first electrode of the sixth transistor is electrically connected to the second electrode of the light emitting element, and a second electrode of the sixth transistor is electrically connected to the second voltage terminal; a control electrode of the seventh transistor is electrically connected to the light emitting control voltage terminal, a first electrode of the seventh transistor is electrically connected to the second electrode of the light emitting element, and a second electrode of the seventh transistor is electrically connected to the second voltage terminal.

Optionally, the seventh transistor is a p-type transistor, the sixth transistor is an n-type transistor, and the fifth transistor is an n-type transistor; or the seventh transistor is a p-type transistor, the sixth transistor is an n-type transistor, and the fifth transistor is a p-type transistor; or, the seventh transistor is an n-type transistor, the sixth transistor is a p-type transistor, and the fifth transistor is an n-type transistor; or, the seventh transistor is an n-type transistor, the sixth transistor is a p-type transistor, and the fifth transistor is a p-type transistor.

Optionally, the pixel circuit further includes a data writing-in circuit, a compensation control circuit, a first initialization circuit, a second initialization circuit and a third capacitor; wherein the data writing-in circuit is electrically connected to the second control terminal, a data line and the first terminal of the driving circuit respectively, and is configured to write a data voltage provided by the data line into the first terminal of the driving circuit under the control of the second control signal provided by the second control terminal; the compensation control circuit is electrically connected to a third control terminal, the control terminal of the driving circuit and the second terminal of the driving circuit respectively, and is configured to control the communication between the control terminal of the driving circuit and the second terminal of the driving circuit under the control of a third control signal provided by the third control terminal; the first initialization circuit is electrically connected to a first reset control terminal, the control terminal of the driving circuit and a third initial voltage terminal respectively, and is configured to write a third initial voltage provided by the third initial voltage terminal into the control terminal of the driving circuit under the control of a first reset control signal provided by the first reset control terminal; the second initialization circuit is electrically connected to a second reset control terminal, the first electrode of the light emitting element and a fourth initial voltage terminal respectively, and is configured to write a fourth initial voltage provided by the fourth initial voltage terminal into the first electrode of the light emitting element under the control of a second reset control signal provided by the second reset control terminal; a first terminal of the third capacitor is electrically connected to the control terminal of the driving circuit, and a second terminal of the third capacitor is electrically connected to the first voltage terminal.

Optionally, the first initialization circuit includes an eighth transistor, the compensation control circuit includes a ninth transistor, the data writing-in circuit includes a tenth transistor, and the second initialization circuit includes an eleventh transistor; a control electrode of the eighth transistor is electrically connected to the first reset control terminal, a first electrode of the eighth transistor is electrically connected to the third initial voltage terminal, and a second electrode of the eighth transistor is electrically connected to the control terminal of the driving circuit; a control electrode of the ninth transistor is electrically connected to the third control terminal, a first electrode of the ninth transistor is electrically connected to the control terminal of the driving circuit, and a second electrode of the ninth transistor is electrically connected to the second terminal of the driving circuit; a control electrode of the tenth transistor is electrically connected to the second control terminal, a first electrode of the tenth transistor is electrically connected to the data line, and a second electrode of the tenth transistor is electrically connected to the first terminal of the driving circuit; or the control electrode of the tenth transistor is electrically connected to the first reset control terminal, the first electrode of the tenth transistor is electrically connected to the light emitting data voltage terminal, and a second electrode of the tenth transistor is electrically connected to the first terminal of the driving circuit; a control electrode of the eleventh transistor is electrically connected to the second reset control terminal, a first electrode of the eleventh transistor is electrically connected to the fourth initial voltage terminal, and a second electrode of the eleventh transistor is electrically connected to the first electrode of the light emitting element.

Optionally, the eighth transistor and the ninth transistor are oxide thin film transistors.

Optionally, the eleventh transistor is an oxide thin film transistor, and a control electrode of the eleventh transistor is electrically connected to the first reset control terminal.

Optionally, at least one of the eighth transistor and the ninth transistor is a dual-gate transistor.

Optionally, the light emitting element is a micro light emitting diode or a mini light emitting diode.

In a second aspect, an embodiment of the present disclosure provides a pixel driving method, applied to the pixel circuit, the pixel driving method includes: in the light emitting phase, controlling, by the first light emitting control circuit, the first voltage terminal to be connected to the first terminal of the driving circuit under the control of the first light emitting control signal; controlling, by the light emitting gating circuit, under the control of the first control signal, according to the light emitting data voltage, during the light emitting phase and under the control of the light emitting control voltage provided by the light emitting control voltage terminal, to generate the current path between the second terminal of the driving circuit and the light emitting element, to control the driving circuit to control the light emitting element to emit light, or to generate the current path between the second terminal of the driving circuit and the light emitting element during the light emitting phase, so as to control the driving circuit to control the light emitting element to emit light.

Optionally, the light emitting gating circuit includes a second light emitting control circuit and a first gating control circuit; and the pixel driving method includes: writing, by the first gating control circuit, under the control of the first control signal, the light emitting data voltage into the gating control terminal, and, under the control of the potential of the gating control terminal, controlling the second light emitting control terminal to be connected to the light emitting control voltage terminal, or controlling the second light emitting control terminal to be connected to the first light emitting control terminal; controlling, by the second light emitting control circuit, the connection between the second terminal of the driving circuit and the first electrode of the light emitting element under the control of the potential of the second light emitting control terminal.

Optionally, the light emitting gating circuit includes a second gating control circuit, a third light emitting control circuit and a fourth light emitting control circuit; and the pixel driving method includes: writing, by the second gating control circuit, the light emitting control voltage into the gating control terminal under the control of the first control signal; controlling, by the third light emitting control circuit, the second electrode of the light emitting element to be connected to the second voltage terminal under the control of the potential of the gating control terminal; controlling, by the fourth light emitting control circuit, the second electrode of the light emitting element to be connected to the second voltage terminal under the control of the light emitting control voltage.

In a third aspect, an embodiment of the present disclosure provides a pixel driving method, applied to the pixel circuit, wherein the display period includes a first phase and a light emitting phase which are arranged successively; the pixel driving method includes: in the first phase, writing, by the light emitting gating circuit, the light emitting data voltage provided by the light emitting data voltage terminal under the control of the first control signal; controlling, by the first light emitting control circuit, the first voltage terminal to be disconnected from the first terminal of the driving circuit under the control of the first light emitting control signal; in the light emitting phase, controlling, by the first light emitting control circuit, the first voltage terminal to be connected to the first terminal of the driving circuit under the control of the first light emitting control signal; in the light emitting phase, controlling, by the light emitting gating circuit, to generate the current path between the second terminal of the driving circuit and the light emitting element according to the light emitting data voltage and under the control of the light emitting control voltage provided by the light emitting control voltage terminal, to control the driving circuit to control the light emitting element to emit light, or controlling, by the light emitting gating circuit, to generate the current path between the second terminal of the driving circuit and the light emitting element under the control of the first light emitting control signal, to control the driving circuit to control the light emitting element to emit light.

Optionally, in the light emitting phase, both the first light emitting control signal and the light emitting control voltage are square wave voltage signals.

Optionally, the light emitting gating circuit includes a second light emitting control circuit and a first gating control circuit; the pixel driving method includes: in a first display mode, in the first phase, writing, by the first gating control circuit, the light emitting data voltage into the gating control terminal under the control of the first control signal, and controlling, by the first gating control circuit, the second light emitting control terminal to be connected to the first light emitting control terminal under the control of the potential of the gating control terminal; in the light emitting phase, when the first light emitting control signal is a valid voltage signal, controlling. by the first light emitting control circuit, the connection between the first voltage terminal and the first terminal of the driving circuit under the control of the first light emitting control signal, and controlling, by the second light emitting control circuit, the connection between the second terminal of the driving circuit and the first electrode of the light emitting element under the control of the first light emitting control signal, and driving, by the driving circuit, the light emitting element to emit light.

Optionally, the light emitting gating circuit comprises a second light emitting control circuit and a first gating control circuit; the pixel driving method comprises: in a second display mode, in the first phase, writing, by the first gating control circuit, the light emitting data voltage into the gating control terminal under the control of the first control signal, and controlling, by the first gating control circuit, the connection between the second light emitting control terminal and the light emitting control voltage terminal under the control of the potential of the gating control terminal; in the light emitting phase, when the first light emitting control signal is a valid voltage signal, controlling, by the first light emitting control circuit, the first voltage terminal to be connected to the first terminal of the driving circuit under the control of the first light emitting control signal; in the light emitting phase, when the light emitting control voltage is a valid voltage, controlling, by the second light emitting control circuit, under the control of the first light emitting control signal, the second terminal of the driving circuit to be connected to the first electrode of the light emitting element, and driving. by the driving circuit, the light emitting element to emit light; when the light emitting control voltage is an invalid voltage, controlling, by the second light emitting control circuit, under the control of the first light emitting control signal, the second terminal of the driving circuit to be disconnected from the first electrode of the light emitting element.

Optionally, a frequency of the first light emitting control signal is less than a frequency of the light emitting control voltage; in the display period, a time length during which a potential of the first light emitting control signal continues to be an invalid voltage is shorter than a time length during which the light emitting control voltage continues to be an invalid voltage.

Optionally, a frequency of the light emitting control voltage is greater than or equal to twice a frequency of the first light emitting control signal.

Optionally, in the display period, a time length during which the potential of the first light emitting control signal continues to be the valid voltage is greater than 2×t1+t2; wherein t1 is a time during which the light emitting control voltage continues to be a valid voltage, and t2 is a time during which the light emitting control voltage continues to be an invalid voltage.

Optionally, a pixel density of the pixel circuit included in a display panel is less than or equal to a pixel density threshold.

Optionally, the frequency of the first light emitting control signal is equal to the frequency of the light emitting control voltage; in the display period, a time length during which the potential of the first light emitting control signal continues to be an invalid voltage is shorter than a time length during which the light emitting control voltage continues to be an invalid voltage.

Optionally, a pixel density of the pixel circuit included in the display panel is greater than a pixel density threshold.

In a fourth aspect, an embodiment of the present disclosure provides a display device, including the pixel circuit.

### BRIEF DESCRIPTION OF THE DRAWINGS

FIG. 1A is a structural diagram of a pixel circuit according to at least one embodiment of the present disclosure;

FIG. IB is a structural diagram of a pixel circuit according to at least one embodiment of the present disclosure;

FIG. 2A is a structural diagram of a pixel circuit according to at least one embodiment of the present disclosure;

FIG. 2B is a structural diagram of a pixel circuit according to at least one embodiment of the present disclosure;

FIG. 3 is a waveform diagram of the potential of the second light emitting control terminal EM2 according to at least one embodiment of the present disclosure;

FIG. 4A is a structural diagram of a pixel circuit according to at least one embodiment of the present disclosure;

FIG. 4B is a structural diagram of a pixel circuit according to at least one embodiment of the present disclosure;

FIG. 5A is a structural diagram of a pixel circuit according to at least one embodiment of the present disclosure;

FIG. 5B is a structural diagram of a pixel circuit according to at least one embodiment of the present disclosure;

FIG. 6A is a structural diagram of a pixel circuit according to at least one embodiment of the present disclosure;

FIG. 6B is a structural diagram of a pixel circuit according to at least one embodiment of the present disclosure;

FIG. 7A is a circuit diagram of a pixel circuit according to at least one embodiment of the present disclosure;

FIG. 7B is a circuit diagram of a pixel circuit according to at least one embodiment of the present disclosure;

FIG. 7C is a structural diagram of a pixel circuit according to at least one embodiment of the present disclosure;

FIG. 8A is a timing diagram of the pixel circuit shown in FIG. 7A;

FIG. 8B is a timing diagram of the pixel circuit shown in FIG. 7A;

FIG. 9 is a simulation timing diagram of the pixel circuit shown in FIG. 7A;

FIG. 10 is a circuit diagram of a pixel circuit according to at least one embodiment of the present disclosure;

FIG. 11A is a timing diagram of the pixel circuit shown in FIG. 10;

FIG. 11B is a timing diagram of the pixel circuit shown in FIG. 10;

FIG. 12A is a circuit diagram of a pixel circuit according to at least one embodiment of the present disclosure;

FIG. 12B is a timing diagram of the pixel circuit shown in FIG. 12A;

FIG. 12C is a timing diagram of the pixel circuit shown in FIG. 12A;

FIG. 13 is a circuit diagram of a pixel circuit according to at least one embodiment of the present disclosure;

FIG. 14 is a circuit diagram of a pixel circuit according to at least one embodiment of the present disclosure;

FIG. 15 is a circuit diagram of a pixel circuit according to at least one embodiment of the present disclosure;

FIG. 16A is a timing diagram of the pixel circuit shown in FIG. 15;

FIG. 16B is a timing diagram of the pixel circuit shown in FIG. 15;

FIG. 17 is a waveform diagram of the potential of the gating control terminal ch and the second light emitting control signal provided by the second light emitting control terminal EM2 according to at least one embodiment of the present disclosure;

FIG. 18 is a simulation timing diagram of the pixel circuit shown in FIG. 15;

FIG. 19 is a circuit diagram of a pixel circuit according to at least one embodiment of the present disclosure;

FIG. 20A is a timing diagram of the pixel circuit shown in FIG. 19;

FIG. 20B is a timing diagram of the pixel circuit shown in FIG. 19;

FIG. 21 is a circuit diagram of a pixel circuit according to at least one embodiment of the present disclosure;

FIG. 22 is a circuit diagram of a pixel circuit according to at least one embodiment of the present disclosure;

FIG. 23 is a circuit diagram of a pixel circuit according to at least one embodiment of the present disclosure;

FIG. 24A is a timing diagram of the pixel circuit shown in FIG. 23;

FIG. 24B is a timing diagram of the pixel circuit shown in FIG. 23;

FIG. 25 is a circuit diagram of a pixel circuit according to at least one embodiment of the present disclosure;

FIG. 26A is a timing diagram of the pixel circuit shown in FIG. 25;

FIG. 26B is a timing diagram of the pixel circuit shown in FIG. 25;

FIG. 27 is a structural diagram of a pixel circuit according to at least one embodiment of the present disclosure;

FIG. 28 is a structural diagram of a pixel circuit according to at least one embodiment of the present disclosure;

FIG. 29 is a structural diagram of a pixel circuit according to at least one embodiment of the present disclosure;

FIG. 30 is a circuit diagram of a pixel circuit according to at least one embodiment of the present disclosure;

FIG. 31A is a timing diagram of the pixel circuit shown in FIG. 30;

FIG. 31B is a timing diagram of the pixel circuit shown in FIG. 30;

FIG. 32 is a circuit diagram of a pixel circuit according to at least one embodiment of the present disclosure;

FIG. 33 is a circuit diagram of a pixel circuit according to at least one embodiment of the present disclosure;

FIG. 34A is a timing diagram of the pixel circuit shown in FIG. 33;

FIG. 34B is a timing diagram of the pixel circuit shown in FIG. 33;

FIG. 35A is a circuit diagram of a pixel circuit according to at least one embodiment of the present disclosure;

FIG. 35B is a timing diagram of the pixel circuit shown in FIG. 33;

FIG. 35C is a timing diagram of the pixel circuit shown in FIG. 33;

FIG. 36 is a waveform diagram of a first light emitting control signal provided by EMI and a waveform diagram of a light emitting control voltage HF when the pixel circuit shown in FIG. 7A performs low grayscale display;

FIG. 37 is a timing diagram of the pixel circuit shown in FIG. 10 when performing low grayscale display;

FIG. 38A is a timing diagram of the pixel circuit shown in FIG. 10 when performing high grayscale display;

FIG. 38B is a timing diagram of the pixel circuit shown in FIG. 10 when performing high grayscale display.

### DETAILED DESCRIPTION

The technical solutions in the embodiments of the present disclosure will be clearly and completely described below with reference to the accompanying drawings in the embodiments of the present disclosure. Obviously, the described embodiments are only some of the embodiments of the present disclosure, rather than all of the embodiments. Based on the embodiments in the present disclosure, all other embodiments obtained by those of ordinary skill in the art without making creative efforts fall within the scope of protection of the present disclosure.

The transistors used in all embodiments of the present disclosure may be transistors, thin film transistors, field effect transistors, or other devices with the same characteristics. In the embodiment of the present disclosure, in order to distinguish the two electrodes of the transistor except the control electrode, one electrode is called the first electrode and the other electrode is called the second electrode.

In actual operation, when the transistor is a triode, the control electrode may be a base electrode, the first electrode may be a collector, and the second electrode may be an emitter; or, the control electrode may be a base electrode, the first electrode may be an emitter, and the second electrode may be a collector.

In actual operation, when the transistor is a thin film transistor or a field effect transistor, the control electrode may be a gate electrode, the first electrode may be a drain electrode, and the second electrode may be a source electrode; or, the control electrode may be a gate electrode, the first electrode may be a source electrode, and the second electrode may be a drain electrode.

The pixel circuit according to an embodiment of the present disclosure includes a first light emitting control circuit, a light emitting element, a driving circuit and a light emitting gating circuit;

The first light emitting control circuit is electrically connected to a first light emitting control terminal, a first voltage terminal and a first terminal of the driving circuit respectively, and is configured to control the connection between the first voltage terminal and the first terminal of the driving circuit under the control of a first light emitting control signal provided by the first light emitting control terminal during the light emitting phase;

a second terminal of the driving circuit is electrically connected to a first electrode of the light emitting element, and the driving circuit is configured to drive the light emitting element;

The light emitting gating circuit is configured to control, under the control of a first control signal provided by the first control terminal, according to the light emitting data voltage provided by the light emitting data voltage terminal, to form a current path between the second terminal of the driving circuit and the light emitting element in the light emitting phase under the control of the light emitting control voltage provided by the light emitting control voltage terminal, so as to control the driving circuit to control the light emitting element to emit light, or to control to form a current path between the second terminal of the driving circuit and the light emitting element in the light emitting phase, so as to control the driving circuit to control the light emitting element to emit light, or to control to generate a current path between the second terminal of the driving circuit and the light emitting element in the light emitting phase under the control of the first light emitting control signal, so as to control the driving circuit to control the light emitting element to emit light.

In at least one embodiment of the present disclosure, the light emitting control voltage may be a Pulse Width Modulation (PWM) signal, and the light emitting control voltage may be a high-frequency signal, but is not limited thereto.

When the pixel circuit described in the embodiment of the present disclosure is working, in the light emitting phase, the light emitting gating circuit forms a current path between the second terminal of the driving circuit and the light emitting element under the control of the first control signal according to the light emitting data voltage, in the light emitting phase, under the control of the light emitting control voltage, to control the light emitting element to emit light at a short time and high frequency to achieve low grayscale, using PWM dimming mode; or, in the light emitting phase, control the light emitting element to emit light for a long time (the light emitting element emits light for a long time, which may mean that the light emitting element emits light at all times during the light emitting phase, and the grayscale is completely determined by the data voltage) to achieve high grayscale, using PAM dimming mode. The embodiment of the present disclosure can improve the brightness control capability of high and low grayscales.

In at least one embodiment of the present disclosure, the light emitting control voltage can be a high-frequency PWM signal. In the light emitting phase, when the light emitting gating circuit forms a current path between the second terminal of the driving circuit and the light emitting element under the control of the light emitting control voltage, the light emitting element emits light for multiple short periods of time. The higher the frequency of the light emitting control voltage is, the less likely the human eye can perceive the flicker. Since the light emitting time is reduced, low grayscale can be achieved.

The pixel circuit described in the embodiment of the present disclosure can perform PWM dimming to improve the brightness control capability of low grayscale, in order to solve the problems of poor brightness uniformity and insufficient low grayscale control capability of the light emitting element at low current density.

The pixel circuit having PWM dimming function according to an embodiment of the present disclosure solves the problem of uneven light emitting brightness under low current density, the pixel circuit adopts long-time light emitting in PAM mode under high grayscale, and adopts short-time high-frequency light emitting of PWM mode under low grayscale.

In at least one embodiment of the present disclosure, the light emitting gating circuit includes a second light emitting control circuit and a first gating control circuit;

The first gating control circuit is electrically connected to the first control terminal, a light emitting data voltage terminal, a gating control terminal, a second light emitting control terminal, a light emitting control voltage terminal and a first light emitting control terminal respectively, and is configured to write a light emitting data voltage provided by the light emitting data voltage terminal into the gating control terminal under the control of the first control signal, and control the second light emitting control terminal to be connected to the light emitting control voltage terminal or to be connected to the first light emitting control terminal under the control of a potential of the gating control terminal;

The second light emitting control circuit is electrically connected to the second light emitting control terminal, the second terminal of the driving circuit and the first electrode of the light emitting element respectively, and is configured to control the second terminal of the driving circuit to be connected to the first electrode of the light emitting element under the control of a potential of the second light emitting control terminal;

A second electrode of the light emitting element is electrically connected to the second voltage terminal.

In a specific implementation, the light emitting gating circuit may include a second light emitting control circuit and a first gating control circuit, the first gating control circuit controls the connection between the second light emitting control terminal and the light emitting control voltage terminal, or controls the connection between the second light emitting control terminal and the first light emitting control terminal, and the second light emitting control circuit controls the connection between the second terminal of the driving circuit and the first electrode of the light emitting element under the control of the potential of the second light emitting control terminal.

Optionally, the first voltage terminal may be a high voltage terminal, and the second voltage terminal may be a low voltage terminal, but is not limited thereto.

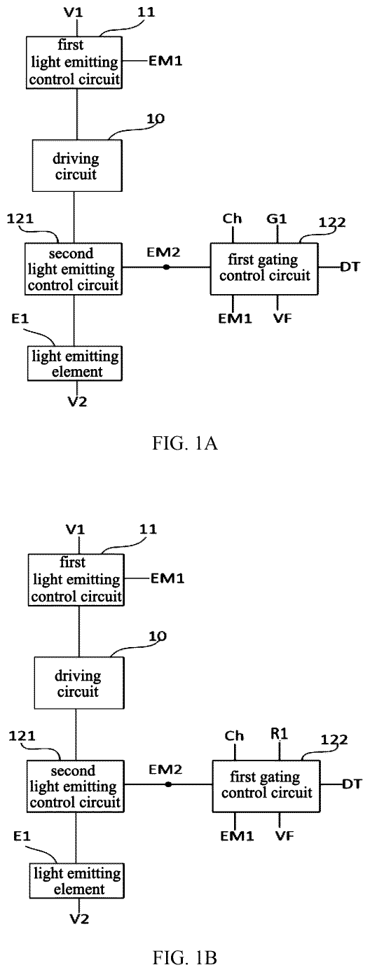

As shown in FIG. 1A, the pixel circuit according to at least one embodiment of the present disclosure includes a first light emitting control circuit 11, a light emitting element E1, a driving circuit 10, and a light emitting gating circuit;
The first light emitting control circuit 11 is electrically connected to the first light emitting control terminal EM1, the first voltage terminal V1 and the first terminal of the driving circuit 10 respectively, and is configured to control the connection between the first voltage terminal V1 and the first terminal of the driving circuit 10 under the control of the first light emitting control signal provided by the first light emitting control terminal EM1 during the light emitting phase;
The second terminal of the driving circuit 10 is electrically connected to the first electrode of the light emitting element E1, and the driving circuit 10 is configured to drive the light emitting element E1;
The light emitting gating circuit includes a second light emitting control circuit 121 and a first gating control circuit 122;
The first gating control circuit 122 is electrically connected to the first control terminal G1, the light emitting data voltage terminal DT, the gating control terminal ch, the second light emitting control terminal EM2, the light emitting control voltage terminal VF and the first light emitting control terminal EMI respectively, and is configured to write the light emitting data voltage provided by the light emitting data voltage terminal DT into the gating control terminal ch under the control of the first control signal provided by the first control terminal G1, and control the second light emitting control terminal EM2 to be connected to the light emitting control voltage terminal VF or to control the second light emitting control terminal EM2 to be connected to the first light emitting control terminal EM1 under the control of the potential of the gating control terminal ch;
The second light emitting control circuit 121 is electrically connected to the second light emitting control terminal EM2, the second terminal of the driving circuit 10 and the first electrode of the light emitting element E1 respectively, and is configured to control the second terminal of the driving circuit 10 to be connected to the first electrode of the light emitting element E1 under the control of the potential of the second light emitting control terminal EM2;
A second electrode of the light emitting element E1 is electrically connected to the second voltage terminal V2.

When one embodiment of the pixel circuit shown in FIG. 1A of the present disclosure is in operation, a display period may include a data writing-in phase and a light emitting phase that are arranged in sequence;

In the data writing-in phase, the first gating control circuit 122 writes the light emitting data voltage into the gating control terminal ch under the control of the first control signal, and controls the second light emitting control terminal EM2 to be connected to the light emitting control voltage terminal VF or controls the second light emitting control terminal EM2 to be connected to the first light emitting control terminal EM1 under the control of the potential of the gating control terminal ch;
In the light emitting phase, the second light emitting control circuit 121 controls the second terminal of the driving circuit 10 to be connected to the first electrode of the light emitting element E1 under the control of the potential of the second light emitting control terminal EM2;
In the light emitting phase, when the second light emitting control terminal EM2 is connected to the light emitting control voltage terminal VF, the light emitting element E1 emits light at a high frequency and for a short time to achieve low grayscale display; when the second light emitting control terminal EM2 is connected to the first light emitting control terminal EM1, in the light emitting phase, the light emitting element E1 emits light for a long time to achieve high grayscale display.

As shown in FIG. 1B, the pixel circuit according to at least one embodiment of the present disclosure includes a first light emitting control circuit 11, a light emitting element E1, a driving circuit 10, and a light emitting gating circuit;
The first light emitting control circuit 11 is electrically connected to the first light emitting control terminal EMI, the first voltage terminal V1 and the first terminal of the driving circuit 10 respectively, and is configured to control the connection between the first voltage terminal V1 and the first terminal of the driving circuit 10 under the control of the first light emitting control signal provided by the first light emitting control terminal EM1 during the light emitting phase;
The second terminal of the driving circuit 10 is electrically connected to the first electrode of the light emitting element E1, and the driving circuit 10 is configured to drive the light emitting element E1;
The light emitting gating circuit includes a second light emitting control circuit 121 and a first gating control circuit 122;
The first gating control circuit 122 is electrically connected to the first reset control terminal R1, the light emitting data voltage terminal DT, the gating control terminal ch, the second light emitting control terminal EM2, the light emitting control voltage terminal VF and the first light emitting control terminal EM1, respectively, and is configured to write the light emitting data voltage provided by the light emitting data voltage terminal DT into the gating control terminal ch under the control of the first reset control signal provided by the first reset control terminal R1, and control the second light emitting control terminal EM2 to be connected to the light emitting control voltage terminal VF or to control the second light emitting control terminal EM2 to be connected to the first light emitting control terminal EM1 under the control of the potential of the gating control terminal ch;
The second light emitting control circuit 121 is electrically connected to the second light emitting control terminal EM2, the second terminal of the driving circuit 10 and the first electrode of the light emitting element E1 respectively, and is configured to control the second terminal of the driving circuit 10 to be connected to the first electrode of the light emitting element E1 under the control of the potential of the second light emitting control terminal EM2;
The second electrode of the light emitting element E1 is electrically connected to the second voltage terminal V2.

When one embodiment of the pixel circuit shown in FIG. IB of the present disclosure is in operation, a display period may include an initialization phase and a light emitting phase that are arranged successively;

In the initialization phase, the first gating control circuit 122 writes the light emitting data voltage into the gating control terminal ch under the control of the first reset control signal, and controls the second light emitting control terminal EM2 to be connected to the light emitting control voltage terminal VF or controls the second light emitting control terminal EM2 to be connected to the first light emitting control terminal EMI under the control of the potential of the gating control terminal ch;

In the light emitting phase, the second light emitting control circuit 121 controls the second terminal of the driving circuit 10 to be connected to the first electrode of the light emitting element E1 under the control of the potential of the second light emitting control terminal EM2;

In the light emitting phase, when the second light emitting control terminal EM2 is connected to the light emitting control voltage terminal VF, the light emitting element E1 emits light at a high frequency and for a short time to achieve low grayscale display; when the second light emitting control terminal EM2 is connected to the first light emitting control terminal EM1, in the light emitting phase, the light emitting element E1 emits light for a long time to achieve high grayscale display.

Optionally, the light emitting gating circuit further includes a first capacitor;
a first terminal of the first capacitor is electrically connected to the gating control terminal, and a second terminal of the first capacitor is electrically connected to the first initial voltage terminal.

Optionally, the first gating control circuit includes a first transistor, a second transistor and a third transistor;
a control electrode of the first transistor is electrically connected to the first control terminal, a first electrode of the first transistor is electrically connected to the light emitting data voltage terminal, and a second electrode of the first transistor is electrically connected to the gating control terminal;
a control electrode of the second transistor is electrically connected to the gating control terminal, a first electrode of the second transistor is electrically connected to the light emitting control voltage terminal, and a second electrode of the second transistor is electrically connected to the second light emitting control terminal;
a control electrode of the third transistor is electrically connected to the gating control terminal, a first electrode of the third transistor is electrically connected to the first light emitting control terminal, and a second electrode of the third transistor is electrically connected to the second light emitting control terminal.

Optionally, the second light emitting control circuit includes a fourth transistor;
a control electrode of the fourth transistor is electrically connected to the second light emitting control terminal, a first electrode of the fourth transistor is electrically connected to the second terminal of the driving circuit, and a second electrode of the fourth transistor is electrically connected to the first electrode of the light emitting element.

Optionally, the first transistor is an n-type transistor, the second transistor is a p-type transistor, and the third transistor is an n-type transistor; or,
The first transistor is an n-type transistor, the second transistor is an n-type transistor, and the third transistor is a p-type transistor; or,
The first transistor is a p-type transistor, the second transistor is an n-type transistor, and the third transistor is a p-type transistor;
But it is not limited to this.

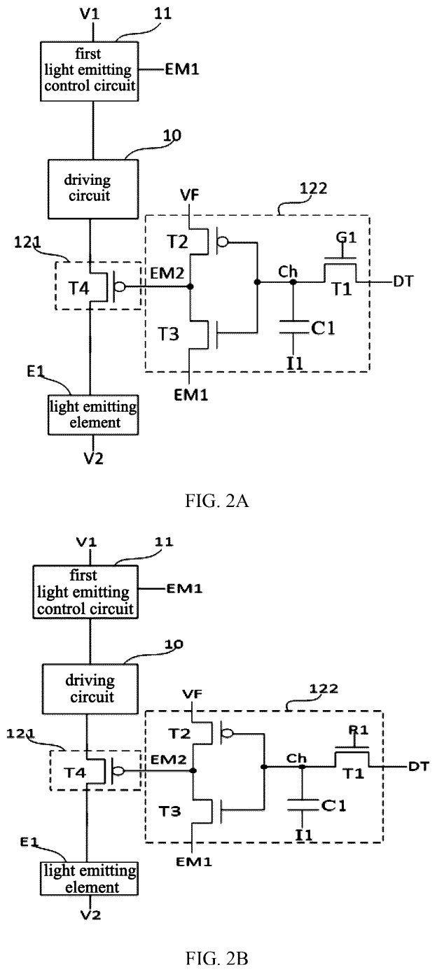

As shown in FIG. 2A, based on at least one embodiment of the pixel circuit shown in FIG. 1A of the present disclosure, the light emitting gating circuit further includes a first capacitor C1;
The first terminal of the first capacitor C1 is electrically connected to the gating control terminal ch, and the second terminal of the first capacitor C1 is electrically connected to the first initial voltage terminal I1; the first initial voltage terminal I1 is configured to provide a first initial voltage Vini1;
The first gating control circuit 122 includes a first transistor T1, a second transistor T2 and a third transistor T3;
The gate electrode of the first transistor T1 is electrically connected to the first control terminal G1, the source electrode of the first transistor T1 is electrically connected to the light emitting data voltage terminal DT, and the drain electrode of the first transistor T1 is electrically connected to the gating control terminal ch;
The gate electrode of the second transistor T2 is electrically connected to the gating control terminal ch, the source electrode of the second transistor T2 is electrically connected to the light emitting control voltage terminal VF, and the drain electrode of the second transistor T2 is electrically connected to the second light emitting control terminal EM2; the light emitting control voltage terminal VF is configured to provide a light emitting control voltage HF;
The gate electrode of the third transistor T3 is electrically connected to the gating control terminal ch, the source electrode of the third transistor T3 is electrically connected to the first light emitting control terminal EM1, and the drain electrode of the third transistor T3 is electrically connected to the second light emitting control terminal EM2;
The second light emitting control circuit 121 includes a fourth transistor T4;
The gate electrode of the fourth transistor T4 is electrically connected to the second light emitting control terminal EM2, the source electrode of the fourth transistor T4 is electrically connected to the second terminal of the driving circuit 10, and the drain electrode of the fourth transistor T4 is electrically connected to the first electrode of the light emitting element E1.

In one embodiment of the pixel circuit shown in FIG. 2A, T1 is an n-type transistor, T2 is a p-type transistor, T3 is an n-type transistor, and T4 is a p-type transistor, but not limited thereto.

When one embodiment of the pixel circuit shown in FIG. 2A of the present disclosure is in operation, a display period may include a data writing-in phase and a light emitting phase that are arranged in sequence;
In the data writing-in phase, G1 provides a high voltage signal, EMI provides a high voltage signal, T1 is turned on to write the light emitting data voltage provided by DT into the gating control terminal ch, and C1 maintains the potential of the gating control terminal ch; when the light emitting data voltage is a high voltage, T3 can be turned on in the data writing-in phase and the light emitting phase; when the light emitting data voltage is a low voltage, T2 can be turned on in the data writing-in phase and the light emitting phase;
In the light emitting phase, when T3 is turned on, EM2 is connected to EM1, and the light emitting element E1 emits light for a long time; when T2 is turned on, EM2 is connected to VF, EM2 is connected to the light emitting control voltage HF, and the light emitting element E1 emits light at a high frequency and for a short time.

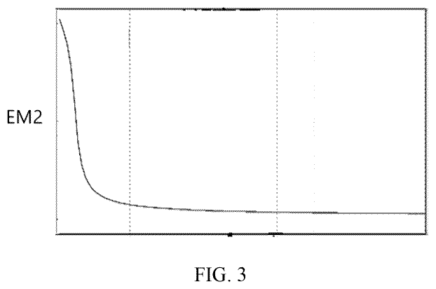

When one embodiment of the pixel circuit shown in FIG. 2A of the present disclosure is in operation, when the PAM emits light for a long time, the high voltage signal provided by DT needs to enter the gate electrode of T3 through T1 to turn on T3, so that the high voltage signal or low voltage signal provided by EM1 passes through. When the high voltage signal provided by EM1 passes through, a higher tum-on voltage is required, so that the demand for the first control signal provided by GI is relatively large. This can be solved by the following scheme: when DT provides a high voltage signal, the voltage of the light emitting data voltage provided by DT can be made lower, and the light emitting data voltage can turn on T2 when HF is a high voltage, provide a high voltage signal to EM2 through HF, and turn off T2 when HF is a low voltage; at the same time, T3 can be turned off when EM1 provides a high voltage signal, and turned on T3 when EM1 provides a low voltage signal. The design coordination required for this setting is: the width W3 of the channel of T3 is greater than the width W2 of the channel of T2, so that the width-to-length ratio of the channel of T3 is greater than the width-to-length ratio of the channel of T2, so that EM1 provides a low voltage signal and HF is a high voltage, and the potential of EM2 is a low voltage. In actual operation, the larger W3 is compared to W2, when EM1 provides a low voltage signal and HF is a high voltage, as shown in FIG. 3, the potential of EM2 is closer to the low voltage signal provided by EM1; otherwise, the potential of EM2 is closer to the high voltage of HF.

Optionally, W3 may be twice as large as W2, but is not limited thereto.

As shown in FIG. 2B, based on at least one embodiment of the pixel circuit shown in FIG. 1B of the present disclosure, the light emitting gating circuit further includes a first capacitor C1;
The first terminal of the first capacitor CI is electrically connected to the gating control terminal ch, and the second terminal of the first capacitor CI is electrically connected to the first initial voltage terminal I1; the first initial voltage terminal I1 is configured to provide a first initial voltage Vini1;
The first gating control circuit 122 includes a first transistor TI, a second transistor T2 and a third transistor T3;
The gate electrode of the first transistor T1 is electrically connected to the first reset control terminal RI, the source electrode of the first transistor TI is electrically connected to the light emitting data voltage terminal DT, and the drain electrode of the first transistor T1 is electrically connected to the gating control terminal ch;
The gate electrode of the second transistor T2 is electrically connected to the gating control terminal ch, the source electrode of the second transistor T2 is electrically connected to the light emitting control voltage terminal VF, and the drain electrode of the second transistor T2 is electrically connected to the second light emitting control terminal EM2; the light emitting control voltage terminal VF is configured to provide a light emitting control voltage HF;
The gate electrode of the third transistor T3 is electrically connected to the gating control terminal ch, the source electrode of the third transistor T3 is electrically connected to the first light emitting control terminal EM1, and the drain electrode of the third transistor T3 is electrically connected to the second light emitting control terminal EM2;
The second light emitting control circuit 121 includes a fourth transistor T4;
The gate electrode of the fourth transistor T4 is electrically connected to the second light emitting control terminal EM2, the source electrode of the fourth transistor T4 is electrically connected to the second terminal of the driving circuit 10, and the drain electrode of the fourth transistor T4 is electrically connected to the first electrode of the light emitting element E1.

In one embodiment of the pixel circuit shown in FIG. 2B, T1 is an n-type transistor, T2 is a p-type transistor, T3 is an n-type transistor, and T4 is a p-type transistor, but the present invention is not limited thereto.

When one embodiment of the pixel circuit of the present disclosure as shown in FIG. 2B is in operation, a display period may include an initialization phase and a light emitting phase which are arranged successively;
In the initialization phase, RI provides a high voltage signal, EM1 provides a high voltage signal, T1 is turned on to write the light emitting data voltage provided by DT into the gating control terminal ch, and C1 maintains the potential of the gating control terminal ch; when the light emitting data voltage is a high voltage, T3 can be turned on in the initialization phase and the light emitting phase; when the light emitting data voltage is a low voltage, T2 can be turned on in the initialization phase and the light emitting phase;
In the light emitting phase, when T3 is turned on, EM2 is connected to EM1, and the light emitting element E1 emits light for a long time; when T2 is turned on, EM2 is connected to VF, EM2 is connected to the light emitting control voltage HF and the light emitting element E1 emits light at a high frequency and for a short time.

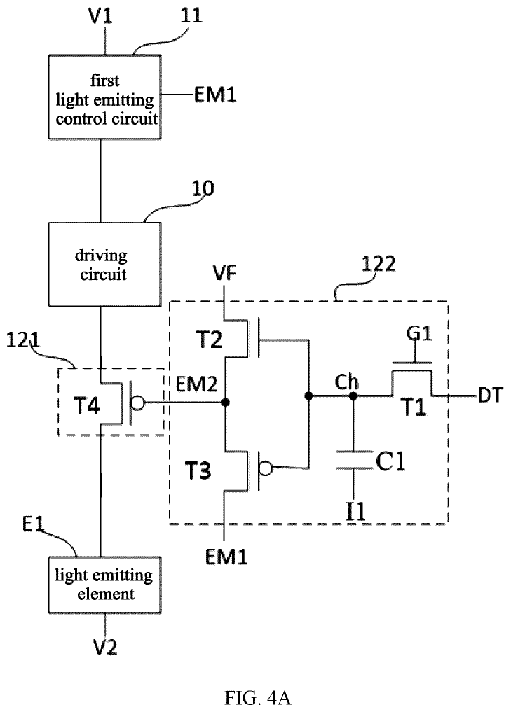

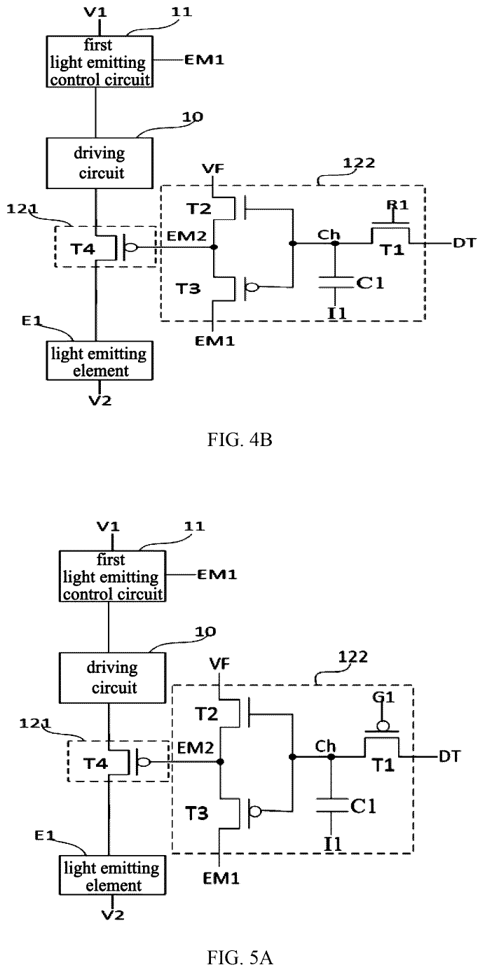

The difference between one embodiment of the pixel circuit shown in FIG. 4A of the present disclosure and at least one embodiment of the pixel circuit shown in FIG. 2A of the present disclosure is that the second transistor T2 is an n-type transistor, and the third transistor T3 is a p-type transistor.

When one embodiment of the pixel circuit shown in FIG. 4A of the present disclosure is in operation, a display period may include a data writing-in phase and a light emitting phase that are arranged in sequence;
In the data writing-in phase, G1 provides a high voltage signal, EM1 provides a high voltage signal, T1 is turned on to write the light emitting data voltage provided by DT into the gating control terminal ch, and C1 maintains the potential of the gating control terminal ch; when the light emitting data voltage is a low voltage, T3 can be turned on in the data writing-in phase and the light emitting phase; when the light emitting data voltage is a high voltage, T2 can be turned on in the data writing-in phase and the light emitting phase;
In the light emitting phase, when T3 is turned on, EM2 is connected to EM1, and the light emitting element E1 emits light for a long time; when T2 is turned on, EM2 is connected to VF, EM2 is connected to the light emitting control voltage HF. and the light emitting element E1 emits light at a high frequency and for a short time.

When one embodiment of the pixel circuit of the present disclosure as shown in FIG. 4A is in operation, when DT provides a low voltage signal in the data writing-in phase, in the light emitting phase, it is necessary to satisfy the requirement of turning on T3 so that the low voltage signal provided by EM1 passes through; when DT provides a high voltage signal in the data writing-in phase, it is necessary to satisfy the requirement of turning on T2 so that HF passes through; since the high and low voltage span provided by DT is large, the requirement for the potential of the high voltage signal provided by G1 is also large; and, when the potential of the gating control terminal ch is maintained at a low voltage, T1 requires a lower off voltage, so the high and low voltage span of the first control signal provided by G1 is large.

When one embodiment of the pixel circuit of the present disclosure as shown in FIG. 4A is in operation, when the potential of ch is a low voltage during the data writing-in phase, T3 is turned on. After entering the light emitting phase, the potential of ch needs to maintain the voltage value of the low voltage signal provided by DT (the voltage value may be −9V, for example) to ensure the turned-on state of T3. If the voltage value of the low voltage signal provided by G1 is −7V at this time, T1 is prone to reverse leakage, resulting in an increase in the potential of ch. Therefore, it is necessary to adjust the voltage value of the low voltage signal provided by G1 to −12V to −9V (if it is necessary to completely turn off T1 so that ch has no reverse leakage, it is necessary to reduce the voltage value of the low voltage signal provided by G1 to −12V, but in order to meet the needs, it is also possible to reduce it to −9V).

The difference between one embodiment of the pixel circuit shown in FIG. 4B of the present disclosure and at least one embodiment of the pixel circuit shown in FIG. 4A of the present disclosure is that the gate electrode of T1 is electrically connected to the first reset control terminal R1.

When at least one embodiment of the pixel circuit shown in FIG. 4B of the present disclosure is in operation, a display period may include an initialization phase and a light emitting phase that are sequentially set;
In the initialization phase, R1 provides a high voltage signal, EM1 provides a high voltage signal, T1 is turned on to write the light emitting data voltage provided by DT into the gating control terminal ch, and C1 maintains the potential of the gating control terminal ch; when the light emitting data voltage is a low voltage, T3 can be turned on in the initialization phase and the light emitting phase; when the light emitting data voltage is a high voltage, T2 can be turned on in the initialization phase and the light emitting phase;
In the light emitting phase, when T3 is turned on, EM2 is connected to EM1, and the light emitting element E1 emits light for a long time; when T2 is turned on, EM2 is connected to VF, EM2 is connected to the light emitting control voltage HF, and the light emitting element E1 emits light at a high frequency and for a short time.

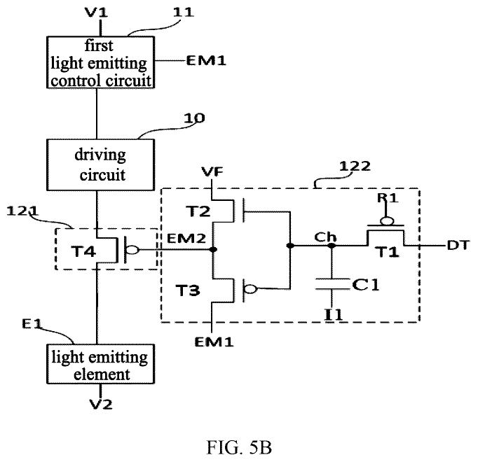

The difference between one embodiment of the pixel circuit as shown in FIG. 5A of the present disclosure and at least one embodiment of the pixel circuit as shown in FIG. 4A of the present disclosure is that T1 is a p-type transistor.

When one embodiment of the pixel circuit shown in FIG. 5A of the present disclosure is in operation, a display period may include a data writing-in phase and a light emitting phase that are arranged in sequence;
In the data writing-in phase, G1 provides a low voltage signal, EM1 provides a high voltage signal, T1 is turned on to write the light emitting data voltage provided by DT into the gating control terminal ch, and C1 maintains the potential of the gating control terminal ch; when the light emitting data voltage is a low voltage, T3 can be turned on in the data writing-in phase and the light emitting phase; when the light emitting data voltage is a high voltage, T2 can be turned on in the data writing-in phase and the light emitting phase;
In the light emitting phase, when T3 is turned on, EM2 is connected to EM1, and the light emitting element E1 emits light for a long time; when T2 is turned on. EM2 is connected to VF, EM2 is connected to the light emitting control voltage HF, and the light emitting element E1 emits light at a high frequency and for a short time.

In at least one embodiment of the present disclosure, when T2 is an n-type transistor, T3 is a p-type transistor; when T2 is a p-type transistor, T3 is an n-type transistor, which is a CMOS (complementary metal oxide semiconductor) or LTPO (low temperature polycrystalline oxide) structure.

In a specific implementation, when T2 is an oxide transistor, the width of the channel of T2 may be greater than the width of the channel of T3, but the present invention is not limited thereto.

The difference between one embodiment of the pixel circuit as shown in FIG. 5B of the present disclosure and at least one embodiment of the pixel circuit as shown in FIG. 5A of the present disclosure is that the gate electrode of T1 is electrically connected to the first reset control terminal R1.

When one embodiment of the pixel circuit shown in FIG. 5B of the present disclosure is in operation, a display period may include an initialization phase and a light emitting phase that are arranged successively;

In the initialization phase, RI provides a low voltage signal, EM1 provides a high voltage signal, T1 is turned on to write the light emitting data voltage provided by DT into the gating control terminal ch, and C1 maintains the potential of the gating control terminal ch; when the light emitting data voltage is a low voltage, T3 can be turned on in the initialization phase and the light emitting phase; when the light emitting data voltage is a high voltage, T2 can be turned on in the initialization phase and the light emitting phase;

In the light emitting phase, when T3 is turned on, EM2 is connected to EM1, and the light emitting element E1 emits light for a long time; when T2 is turned on, EM2 is connected to VF, EM2 is connected to the light emitting control voltage HF, and the light emitting element E1 emits light at a high frequency and for a short time.

The pixel circuit according to at least one embodiment of the present disclosure may further include a data writing-in circuit, a compensation control circuit, a first initialization circuit, a second initialization circuit and a third capacitor;
The data writing-in circuit is electrically connected to the second control terminal, the data line and the first terminal of the driving circuit respectively, and is configured to write the data voltage provided by the data line into the first terminal of the driving circuit under the control of the second control signal provided by the second control terminal, for writing of the data voltage;
The compensation control circuit is electrically connected to the third control terminal, the control terminal of the driving circuit and the second terminal of the driving circuit respectively, and is configured to control the communication between the control terminal of the driving circuit and the second terminal of the driving circuit under the control of a third control signal provided by the third control terminal, so as to compensate for the threshold voltage of the driving transistor included in the driving circuit;
The first initialization circuit is electrically connected to the first reset control terminal, the control terminal of the driving circuit and the third initial voltage terminal respectively, and is configured to write a third initial voltage provided by the third initial voltage terminal into the control terminal of the driving circuit under the control of a first reset control signal provided by the first reset control terminal, so as to initialize the potential of the control terminal of the driving circuit;
The second initialization circuit is electrically connected to the second reset control terminal, the first electrode of the light emitting element and the fourth initial voltage terminal respectively, and is configured to write the fourth initial voltage provided by the fourth initial voltage terminal into the first electrode of the light emitting element under the control of the second reset control signal provided by the second reset control terminal, so as to initialize the potential of the first electrode of the light emitting element;
A first terminal of the third capacitor is electrically connected to the control terminal of the driving circuit, and a second terminal of the third capacitor is electrically connected to the first voltage terminal.

Optionally, the first initial voltage terminal, the third initial voltage terminal and the fourth initial voltage terminal may be the same voltage terminal, but is not limited thereto.

In at least one embodiment of the present disclosure, the third control terminal may be the same control terminal as the first control terminal, but not limited thereto.

Optionally, the first initialization circuit includes an eighth transistor, the compensation control circuit includes a ninth transistor, the data writing-in circuit includes a tenth transistor, and the second initialization circuit includes an eleventh transistor;
a control electrode of the eighth transistor is electrically connected to the first reset control terminal, a first electrode of the eighth transistor is electrically connected to the third initial voltage terminal, and a second electrode of the eighth transistor is electrically connected to the control terminal of the driving circuit;
a control electrode of the ninth transistor is electrically connected to the third control terminal, a first electrode of the ninth transistor is electrically connected to the control terminal of the driving circuit, and a second electrode of the ninth transistor is electrically connected to the second terminal of the driving circuit;
a control electrode of the tenth transistor is electrically connected to the second control terminal, a first electrode of the tenth transistor is electrically connected to the data line, and a second electrode of the tenth transistor is electrically connected to the first terminal of the driving circuit;
a control electrode of the eleventh transistor is electrically connected to the second reset control terminal, a first electrode of the eleventh transistor is electrically connected to the fourth initial voltage terminal, and a second electrode of the eleventh transistor is electrically connected to the first electrode of the light emitting element.

Optionally, the eighth transistor and the ninth transistor are oxide thin film transistors to reduce leakage.

In at least one embodiment of the present disclosure, at least one of the eighth transistor and the ninth transistor may be a dual-gate transistor to reduce current leakage.

Optionally, the light emitting element is a micro light emitting diode or a mini light emitting diode, but is not limited thereto.

In at least one embodiment of the present disclosure, the first light emitting control circuit includes a twelfth transistor;
a control electrode of the twelfth transistor is electrically connected to the first light emitting control terminal, a first electrode of the twelfth transistor is electrically connected to the first voltage terminal, and a second electrode of the twelfth transistor is electrically connected to the first terminal of the driving circuit;

The driving circuit includes a driving transistor;
a control electrode of the driving transistor is electrically connected to the control terminal of the driving circuit, a first electrode of the driving transistor is electrically connected to the first terminal of the driving circuit, and a second electrode of the driving transistor is electrically connected to the second terminal of the driving circuit.

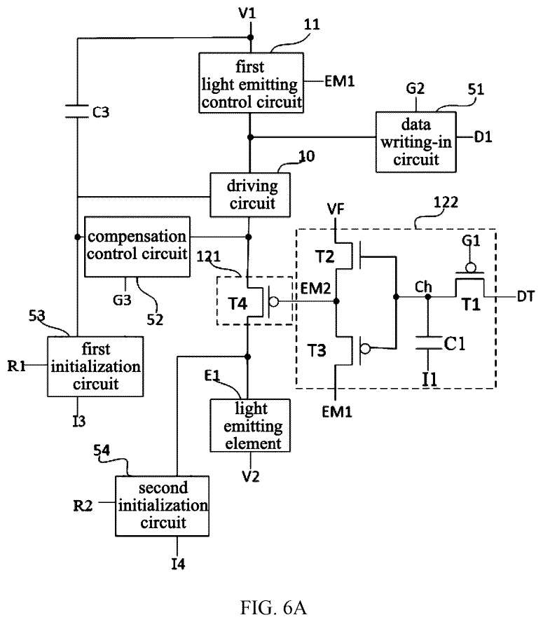

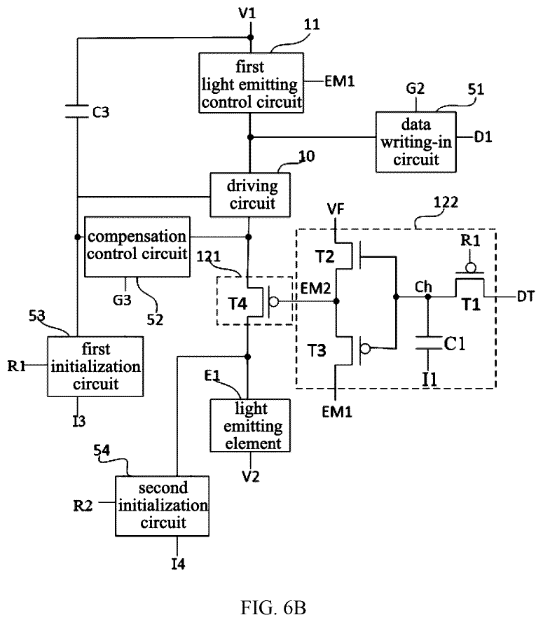

As shown in FIG. 6A, based on at least one embodiment of the pixel circuit shown in FIG. 1A of the present disclosure, the pixel circuit described in at least one embodiment of the present disclosure may further include a data writing-in circuit 51, a compensation control circuit 52, a first initialization circuit 53, a second initialization circuit 54 and a third capacitor C3; the light emitting element is a micro light emitting diode MI;
The data writing-in circuit 51 is electrically connected to the second control terminal G2, the data line D1 and the first terminal of the driving circuit 10 respectively, and is configured to write the data voltage Vdata provided by the data line D1 into the first terminal of the driving circuit 10 under the control of the second control signal provided by the second control terminal G2;
The compensation control circuit 52 is electrically connected to the third control terminal G3, the control terminal of the driving circuit 10 and the second terminal of the driving circuit 10 respectively, and is configured to control the control terminal of the driving circuit 10 to be connected to the second terminal of the driving circuit 10 under the control of the third control signal provided by the third control terminal G3;
The first initialization circuit 53 is electrically connected to the first reset control terminal R1, the control terminal of the driving circuit 10 and the third initial voltage terminal 13 respectively, and is configured to write the third initial voltage provided by the third initial voltage terminal 13 into the control terminal of the driving circuit 10 under the control of the first reset control signal provided by the first reset control terminal R1, so as to initialize the potential of the control terminal of the driving circuit 10;
The second initialization circuit 54 is electrically connected to the second reset control terminal R2, the anode of the micro light emitting diode M1 and the fourth initial voltage terminal 14 respectively, and is configured to write the fourth initial voltage provided by the fourth initial voltage terminal 14 into the anode of the micro light emitting diode MI under the control of the second reset control signal provided by the second reset control terminal R2;
A first terminal of the third capacitor C3 is electrically connected to the control terminal of the driving circuit 10, and a second terminal of the third capacitor C3 is electrically connected to the first voltage terminal V1.

In one embodiment of the pixel circuit shown in FIG. 6A, the first initial voltage terminal, the third initial voltage terminal and the fourth initial voltage terminal can be the same voltage terminal, the first voltage terminal can be a high voltage terminal, and the first control terminal and the third control terminal can be the same control terminal, but are not limited to this.

The difference between one embodiment of the pixel circuit shown in FIG. 6B of the present disclosure and at least one embodiment of the pixel circuit shown in FIG. 6A of the present disclosure is that the gate electrode of T1 is electrically connected to the first reset control terminal R1.

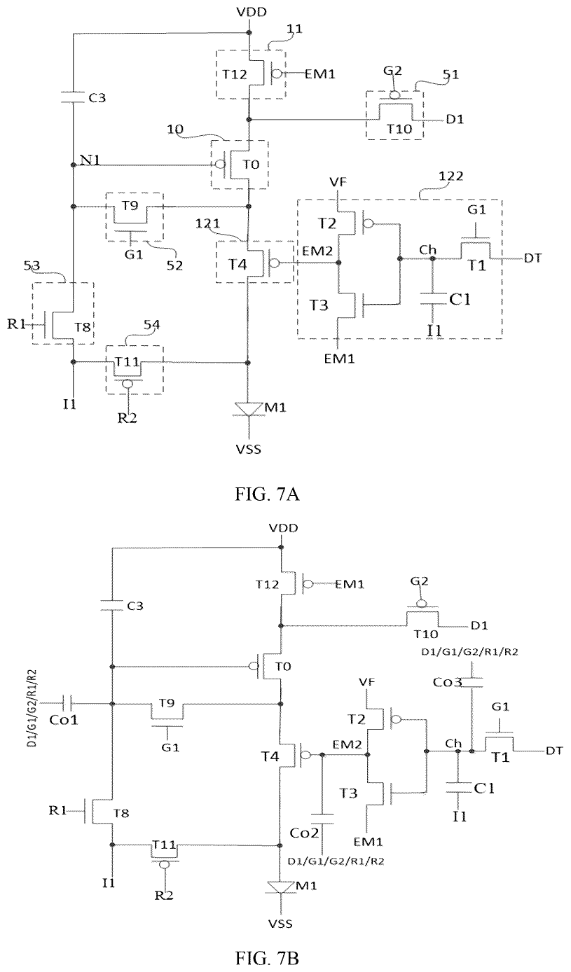

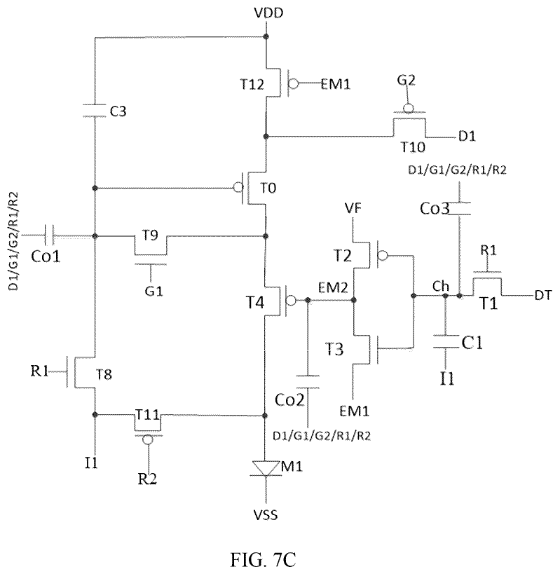

As shown in FIG. 7A, based on at least one embodiment of the pixel circuit shown in FIG. 6A, the light emitting gating circuit further includes a first capacitor C1; the driving circuit 10 includes a driving transistor T0;
The first terminal of the first capacitor C1 is electrically connected to the gating control terminal ch, and the second terminal of the first capacitor C1 is electrically connected to the first initial voltage terminal I1; the first initial voltage terminal I1 is configured to provide a first initial voltage Vini1;
The first gating control circuit 122 includes a first transistor T1, a second transistor T2 and a third transistor T3;
The gate electrode of the first transistor T1 is electrically connected to the first control terminal G1, the source electrode of the first transistor T1 is electrically connected to the light emitting data voltage terminal DT, and the drain electrode of the first transistor T1 is electrically connected to the gating control terminal ch;
The gate electrode of the second transistor T2 is electrically connected to the gating control terminal ch, the source electrode of the second transistor T2 is electrically connected to the light emitting control voltage terminal VF, and the drain electrode of the second transistor T2 is electrically connected to the second light emitting control terminal EM2; the light emitting control voltage terminal VF is configured to provide a light emitting control voltage HF;
The gate electrode of the third transistor T3 is electrically connected to the gating control terminal ch, the source electrode of the third transistor T3 is electrically connected to the first light emitting control terminal EM1, and the drain electrode of the third transistor T3 is electrically connected to the second light emitting control terminal EM2;
The second light emitting control circuit 121 includes a fourth transistor T4;
The gate electrode of the fourth transistor T4 is electrically connected to the second light emitting control terminal EM2, the source electrode of the fourth transistor T4 is electrically connected to the second terminal of the driving circuit 10, the drain electrode of the fourth transistor T4 is electrically connected to the anode of the micro light emitting diode MI; the cathode of the micro light emitting diode MI is electrically connected to the low voltage terminal VSS;
The first initialization circuit 53 includes an eighth transistor T8, the compensation control circuit 52 includes a ninth transistor T9, the data writing-in circuit 51 includes a tenth transistor T10, and the second initialization circuit 54 includes an eleventh transistor T11;
The gate electrode of the eighth transistor T8 is electrically connected to the first reset control terminal RI, the source electrode of the eighth transistor T8 is electrically connected to the first initial voltage terminal II, and the drain electrode of the eighth transistor T8 is electrically connected to the gate electrode of the driving transistor T0;
The gate electrode of the ninth transistor T9 is electrically connected to the first control terminal G1, the source electrode of the ninth transistor T9 is electrically connected to the gate electrode of the driving transistor T0, and the drain electrode of the ninth transistor T9 is electrically connected to the drain electrode of the driving transistor T0;
The gate electrode of the tenth transistor T10 is electrically connected to the second control terminal G2, the source electrode of the tenth transistor T10 is electrically connected to the data line D1, and the gate electrode of the tenth transistor T10 is electrically connected to the source electrode of the driving transistor T0;
The gate electrode of the eleventh transistor T11 is electrically connected to the second reset control terminal R2, the source electrode of the eleventh transistor T11 is electrically connected to the first initial voltage terminal I1, and the drain electrode of the eleventh transistor T11 is electrically connected to the anode of the micro light emitting diode M1;
The first light emitting control circuit 11 includes a twelfth transistor T12;
A gate electrode of the twelfth transistor T12 is electrically connected to the first light emitting control terminal EM1, a source electrode of the twelfth transistor T12 is electrically connected to the high voltage terminal VDD, and a drain electrode of the twelfth transistor T12 is electrically connected to the source electrode of the driving transistor T0.

In FIG. 7A, the node labeled NI is a first node, and the first node NI is electrically connected to the gate electrode of T0.

In one embodiment of the pixel circuit shown in FIG. 7A, T1 is an n-type transistor, T2 is a p-type transistor, T3 is an n-type transistor, and T4 is a p-type transistor, but the present invention is not limited thereto.

In one embodiment of the pixel circuit shown in FIG. 7A, the first voltage terminal is a high voltage terminal VDD, the second voltage terminal is a low voltage terminal VSS, the first control terminal and the third control terminal are the same control terminal, and the first initial voltage terminal, the third initial voltage terminal and the fourth initial voltage terminal are the same voltage terminal.

In one embodiment of the pixel circuit shown in FIG. 7A, T12, T0, T10 and T11 are p-type transistors, T8 and T9 are n-type transistors, and T12, T0, T10 and T11 are low-temperature polysilicon thin film transistors; but not limited thereto.

In one embodiment shown in FIG. 7A, T8 and T9 are oxide thin film transistors to reduce leakage and maintain the potential of the gate electrode of T0.

In one embodiment of the pixel circuit shown in FIG. 7A, T2 and T3 form an inverter-like structure, and the first light emitting control signal provided by EM1 and the light emitting control voltage HF are respectively connected to two sides of the inverter-like structure as input signals.

In one embodiment of the pixel circuit shown in FIG. 7A, T8 may be replaced by a p-type transistor, T9 may be replaced by a p-type transistor, and T10 may be replaced by an n-type transistor, but not limited thereto.

In one embodiment of the pixel circuit shown in FIG. 7A, T1 may also be replaced by a p-type transistor, and the signal connected to the gate electrode of T1 may be inverted, but not limited thereto.

In at least one embodiment of the present disclosure, T0 is a driving transistor, and the length of the channel of T0 can be increased. For example, the length of the channel of T0 can be greater than or equal to 10 um and less than or equal to 30 um, and because T4 and T12 are on the light emitting current path, the width of the channel of T4 and the width of the channel of T12 can be appropriately increased. For example, the width of the channel of T4 and the width of the channel of T12 can be greater than or equal to 5 mu and less than or equal to 10 um.

In one embodiment of the pixel circuit shown in FIG. 7A of the present disclosure, except for T0, T4 and T12, other transistors are switching transistors. When the switching transistor is a low-temperature polycrystalline silicon thin film transistor, the width-to-length ratio of the channel of the switching transistor can be 3 um/3 um; when the switching transistor is an oxide thin film transistor, the width-to-length ratio of the channel of the switching transistor can be within a fluctuation range centered on 5 um/5 um; but not limited to this.

In FIG. 7B, based on at least one embodiment of the pixel circuit shown in FIG. 7A, a coupling capacitor is added as follows:
A first coupling capacitor Col between the gate electrode of T0 and the signal line;
A second coupling capacitor Co2 between the gate electrode of T4 and the signal line;
A third coupling capacitor Co3 between the gate electrode of T2 and the signal line;
The signal line may be at least one of: a data line, a first control terminal, a second control terminal, a first reset control terminal, and a second reset control terminal.

The difference between one embodiment of the pixel circuit shown in FIG. 7C of the present disclosure and at least one embodiment of the pixel circuit shown in FIG. 7B of the present disclosure is that:
The gate electrode of T1 is electrically connected to the first reset control terminal R1.

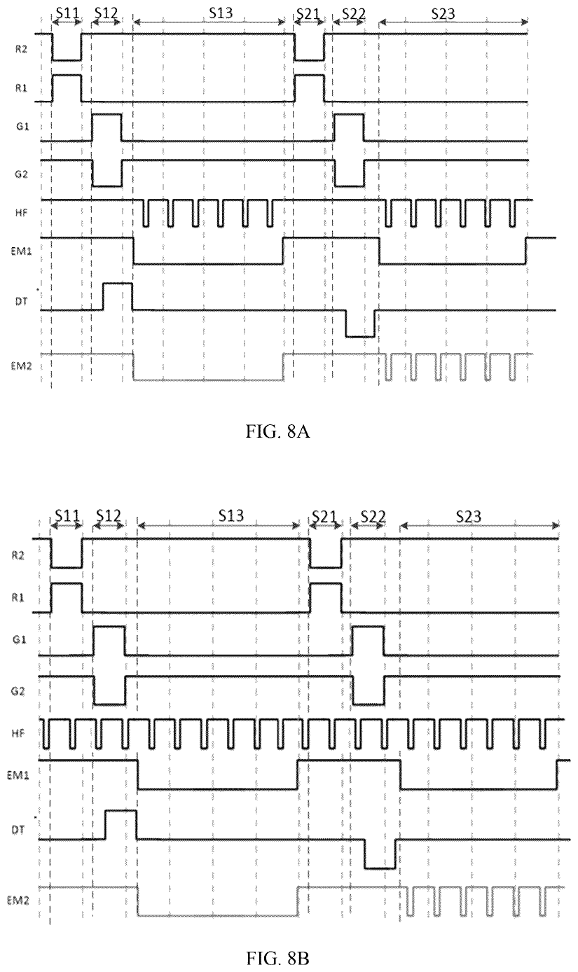

As shown in FIG. 8A, when at least one embodiment of the pixel circuit shown in FIG. 7A of the present disclosure is in operation, the first display period includes a first initialization phase S11, a first data writing-in phase S12, and a first light emitting phase S13 which are successively arranged:

In the first initialization phase S11, R1 provides a high voltage signal, R2 provides a low voltage signal, G1 provides a low voltage signal, G2 provides a high voltage signal, EM1 provides a high voltage signal, T8 and T11 are turned on, and the first initial voltage terminal I1 provides a first initial voltage Vinil to the gate electrode of T0 and the anode of MI, so that when the first data writing-in phase S12 begins, T0 can be turned on and clear the residual charge on the anode of M1;
In the first initialization phase S11, T9 is turned off, T10 is turned off, and T12 is turned off;
In the first data writing-in phase S12, R1 provides a low voltage signal, R2 provides a high voltage signal, G1 provides a high voltage signal, G2 provides a low voltage signal, EM1 provides a high voltage signal, D1 provides a data voltage Vdata, DT provides a high voltage signal, and T10 is turned on to write Vdata into the source electrode of T0;
At the beginning of the first data writing-in phase S12, T0 is turned on, T9 is turned on, and C3 is charged by Vdata to change the potential of the gate electrode of T0 until T0 is turned off. The gate potential of T0 is related to the threshold voltage of T0;
In the first data writing-in phase S12, T8 and T11 are turned off, T12 is turned off, and T1 is turned on to control DT to be connected with ch, the potential of ch is a high voltage, T3 is turned on, and T2 is turned off to control EM1 to be connected with EM2;
In the first light emitting phase S13, R1 provides a low voltage signal, R2 provides a high voltage signal, G1 provides a low voltage signal, G2 provides a high voltage signal, EM1 provides a low voltage signal, T12 is turned on, C1 maintains the potential of ch at a high voltage, T2 is turned off, T3 is turned on, so as to control the connection between EM1 and EM2, the potential of EM2 is a low voltage signal, T4 is turned on, and T0 drives MI to emit light, so as to perform PAM long-time light emitting;
The second display period includes a second initialization phase S21, a second data writing-in phase S22, and a second light emitting phase S23 which are arranged successively;
In the second initialization phase S21, R1 provides a high voltage signal, R2 provides a low voltage signal, G1 provides a low voltage signal, G2 provides a high voltage signal, EM1 provides a high voltage signal, TS and T11 are turned on, and the first initial voltage terminal I1 provides the first initial voltage Vini1 to the gate electrode of T0 and the anode of M1, so that when the first data writing-in phase S12 begins, T0 can be turned on and clear the residual charge on the anode of MI;
In the second initialization phase S21, T9 is turned off, T10 is turned off. and T12 is turned off;
In the second data writing-in phase S22, R1 provides a low voltage signal, R2 provides a high voltage signal, G1 provides a high voltage signal, G2 provides a low voltage signal, EM1 provides a high voltage signal, D1 provides a data voltage Vdata, DT provides a low voltage signal, and T10 is turned on to write Vdata into the source electrode of T0;
At the beginning of the second data writing-in phase S22, T0 is turned on, T9 is turned on, and C3 is charged by Vdata to change the potential of the gate electrode of T0 until T0 is turned off. The gate potential of T0 is related to the threshold voltage of T0,
In the second data writing-in phase S22, T8 and T11 are turned off, T12 is turned off, and T1 is turned on to control DT to be connected to ch, the potential of ch is a low voltage, T2 is turned on, and T3 is turned off to control EM2 to access HF;
In the second light emitting phase S23, R1 provides a low voltage signal, R2 provides a high voltage signal, G1 provides a low voltage signal, G2 provides a high voltage signal, EM1 provides a low voltage signal, T12 is turned on, C1 maintains the potential of ch at a low voltage, T2 is turned on, and T3 is turned off to control EM2 to access HF. When the voltage value of HF is a low voltage, T4 is turned on. When T4 is turned on, T0 drives MI to emit light to perform PWM high-frequency short-time light emitting and perform low grayscale display.

As shown in FIG. 8A, the pulse width of the first reset control signal provided by R1, the pulse width of the second reset control signal provided by R2, the pulse width of the first control signal provided by G1, and the pulse width of the second control signal provided by G2 can be the same, the pulse width of the data voltage provided by D1 is the same as the pulse width of the light emitting data voltage provided by DT, at the rising edge of the second control signal provided by G2, D1 provides the data voltage; at the falling edge of the first control signal provided by G1, DT provides the light emitting data voltage.

As shown in FIG. 8A, when the first reset control signal provided by R1 is a high voltage, the second reset control signal provided by R2 is a low voltage, G1 provides a high voltage, and G2 provides a low voltage, the potential of HF is a high voltage.

In one embodiment shown in FIG. SA, HF is provided by a GOA (Gate On Array, a gate driving circuit arranged on an array substrate) circuit. In the light emitting phase, HF is a square wave voltage signal. In the time period other than the light emitting phase included in the display period, HF is a high voltage signal.

The difference between the working timing diagram shown in FIG. 8B and the working timing diagram shown in FIG. 8A is that: during the entire display period, HF is a square wave voltage signal. At this time, HF can be provided by a driver IC (integrated circuit). The driver IC periodically gives a signal. During one frame of display time, the driver IC provides a square wave voltage signal for VF.

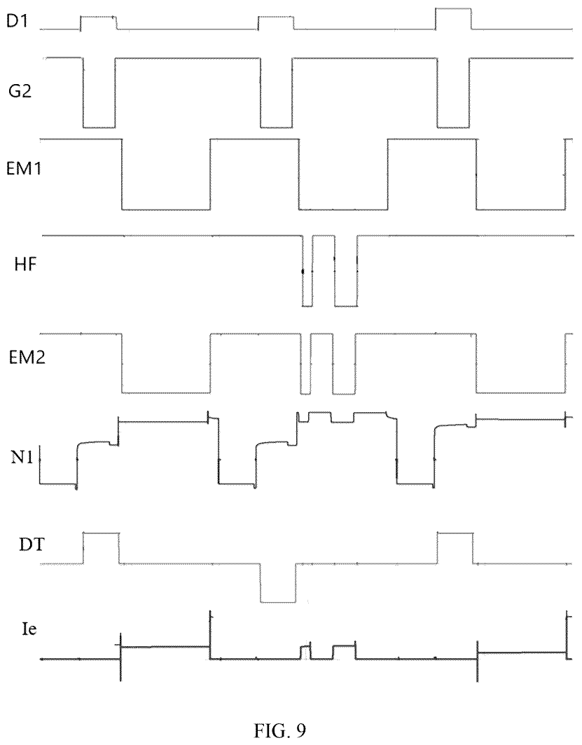

FIG. 9 is the simulation timing diagram of the pixel circuit shown in FIG. 7A of the present disclosure.

In FIG. 9, the one labeled Ie is the current flowing through M1.

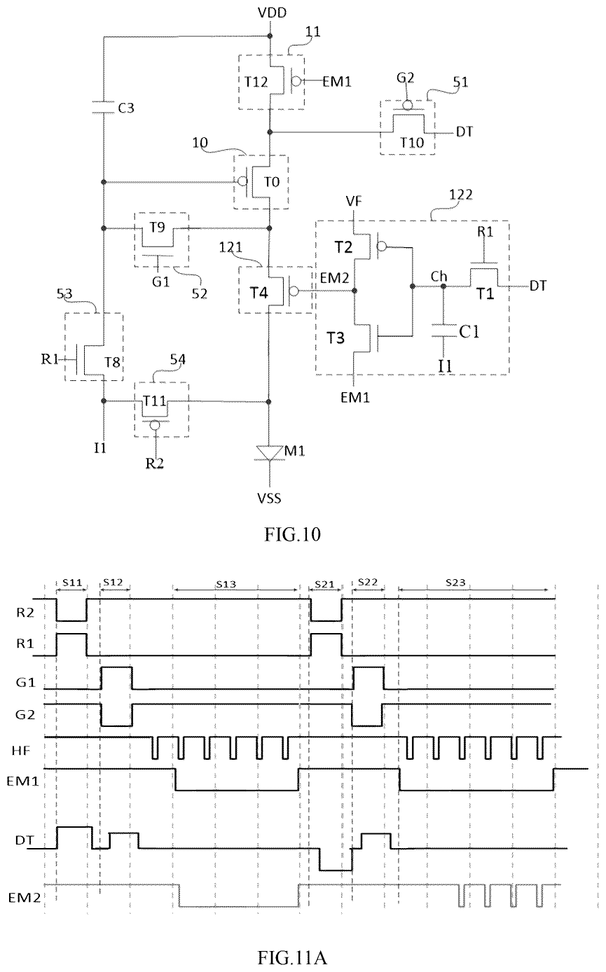

The difference between one embodiment of the pixel circuit shown in FIG. 10 of the present disclosure and at least one embodiment of the pixel circuit shown in FIG. 7A of the present disclosure is that the source electrode of T10 is electrically connected to DT, and the gate electrode of T1 is electrically connected to R1.

In at least one embodiment of the pixel circuit shown in FIG. 10 of the present disclosure, the data voltage and the light emitting data voltage can be combined into one voltage signal. When at least one embodiment of the pixel circuit shown in FIG. 10 of the present disclosure is working, R1 first provides a high voltage signal, and the light emitting data voltage provided by DT charges ch, and then G2 provides a low voltage signal, T10 is turned on, and the data voltage provided by DT charges C3.

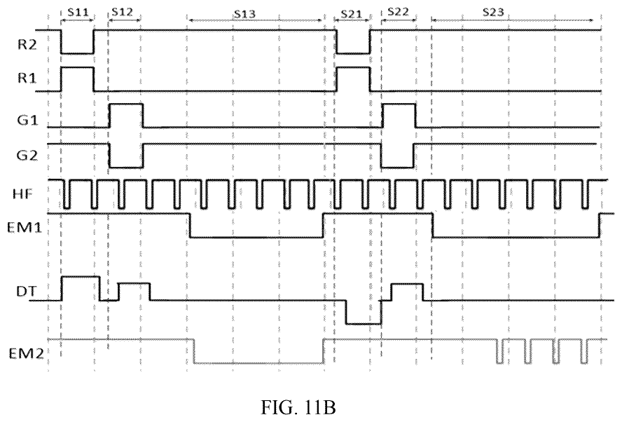

As shown in FIG. 11A, when at least one embodiment of the pixel circuit shown in FIG. 10 of the present disclosure is in operation, the first display period includes a first initialization phase S11, a first data writing-in phase S12, and a first light emitting phase S13 that are successively arranged;

In the first initialization phase S11, R1 provides a high voltage signal, R2 provides a low voltage signal, G1 provides a low voltage signal, G2 provides a high voltage signal, EM1 provides a high voltage signal, T8 and T11 are turned on, and the first initial voltage terminal I1 provides the first initial voltage Vinil to the gate electrode of T0 and the anode of M1, so that when the first data writing-in phase S12 begins, T0 can be turned on and clear the residual charge on the anode of M1; T1 is turned on, DT provides a light emitting data voltage, and the light emitting data voltage provided by DT is a high voltage. C1 is charged by the light emitting data voltage, so that the potential of ch is a high voltage, T3 is turned on, and T2 is turned off to control the connection between EM1 and EM2;
In the first initialization phase S11, T9 is turned off, T10 is turned off, and T12 is turned off;
In the first data writing-in phase S12, R1 provides a low voltage signal, R2 provides a high voltage signal, G1 provides a high voltage signal, G2 provides a low voltage signal, EM1 provides a high voltage signal, DT provides a data voltage Vdata, T10 is turned on to write Vdata into the source electrode of T0, and T1 is turned off;
At the beginning of the first data writing-in phase S12, T0 is turned on, T9 is turned on, and C3 is charged by Vdata to change the potential of the gate electrode of T0 until T0 is turned off. The gate potential of T0 is related to the threshold voltage of T0;
In the first light emitting phase S13, R1 provides a low voltage signal, R2 provides a high voltage signal, G1 provides a low voltage signal, G2 provides a high voltage signal, EM1 provides a low voltage signal, T12 is turned on, C1 maintains the potential of ch at a high voltage, T2 is turned off, T3 is turned on, so as to control the connection between EM1 and EM2, the potential of EM2 is a low voltage signal, T4 is turned on, and T0 drives M1 to emit light, so as to perform PAM long-time light emitting;
The second display period includes a second initialization phase S21, a second data writing-in phase S22, and a second light emitting phase S23 which are arranged successively;
In the second initialization phase S21, R1 provides a high voltage signal, R2 provides a low voltage signal, G1 provides a low voltage signal, G2 provides a high voltage signal, EM1 provides a high voltage signal, T8 and T11 are turned on, and the first initial voltage terminal I1 provides the first initial voltage Vinil to the gate electrode of T0 and the anode of M1, so that at the beginning of the third writing-in time period S221, T0 can be turned on and clear the residual charge of the anode of M1; DT provides a light emitting data voltage, and the light emitting data voltage provided by DT is a low voltage. T8 and T11 are turned off, T12 is turned off, and T1 is turned on to control DT to be connected with ch, and the potential of ch is a low voltage. T2 is turned on, and T3 is turned off to control EM2 to access HF;
In the second initialization phase S21, T9 is turned off, T10 is turned off, and T12 is turned off;
In the second data writing-in phase S22, R1 provides a low voltage signal, R2 provides a high voltage signal, G1 provides a high voltage signal, G2 provides a low voltage signal, EM1 provides a high voltage signal, DT provides a data voltage Vdata, and T10 is turned on to write Vdata into the source electrode of T0;
At the beginning of the second data writing-in phase S221, T0 is turned on, T9 is turned on, and C3 is charged through Vdata to change the potential of the gate electrode of T0 until T0 is turned off. The gate potential of T0 is related to the threshold voltage of T0;
In the second light emitting phase S23, R1 provides a low voltage signal, R2 provides a high voltage signal, G1 provides a low voltage signal, G2 provides a high voltage signal, EM1 provides a low voltage signal, T12 is turned on, C1 maintains the potential of ch at a low voltage, T2 is turned on, and T3 is turned off to control EM2 to access HF. When the voltage value of HF is a low voltage, T4 is turned on. When T4 is turned on, T0 drives M1 to emit light to perform PWM high-frequency short-time light emitting and perform low grayscale display.

In one embodiment shown in FIG. 11A, HF is provided by a GOA (Gate On Array, a gate driving circuit arranged on an array substrate) circuit. In the light emitting phase, HF is a square wave voltage signal. In the time period other than the light emitting phase included in the display period, HF is a high voltage signal.

The difference between the working timing diagram shown in FIG. 11B and the working timing diagram shown in FIG. 11A is that: during the entire display period, HF is a square wave voltage signal. At this time, HF can be provided by a driver IC (integrated circuit). The driver IC periodically gives a signal. Within one frame of display time, the driver IC will provide a square wave voltage signal for VF.

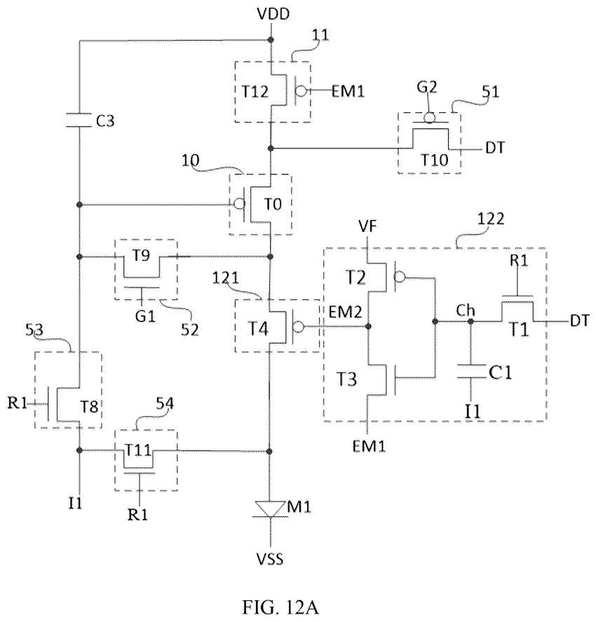

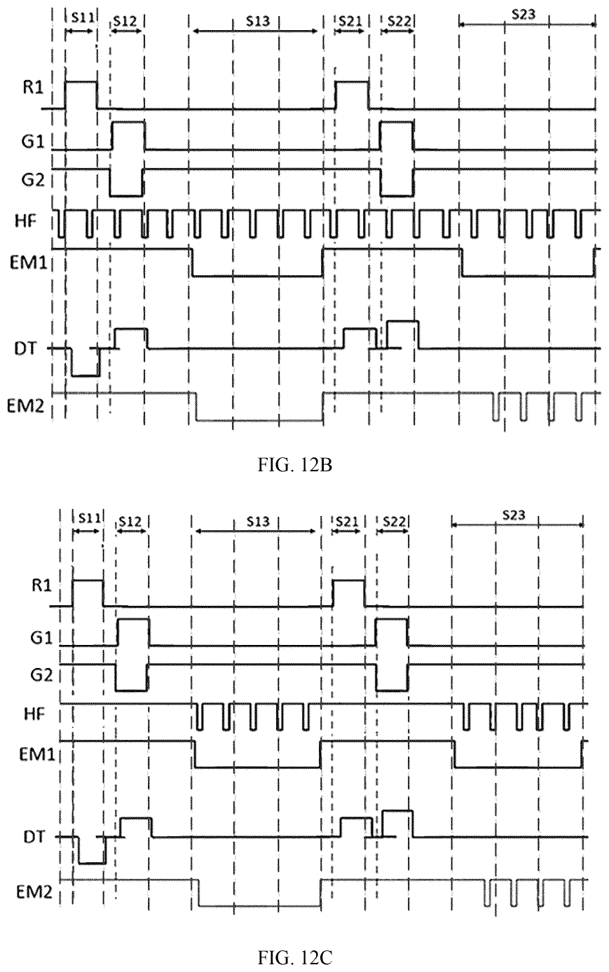

The difference between one embodiment of the pixel circuit shown in FIG. 12A of the present disclosure and at least one embodiment of the pixel circuit shown in FIG. 10 of the present disclosure is that T11 is an n-type transistor, and the gate electrode of T11 is electrically connected to R1.

In one embodiment of the pixel circuit shown in FIG. 12A of the present disclosure, T9, T8 and T11 are connected in series, and T9, T8 and T11 are all oxide thin film transistors, which can simplify the manufacturing process.

FIG. 12B is the timing diagram of the pixel circuit shown in FIG. 12A of the present disclosure.

In one embodiment shown in FIG. 12B, HF is provided by a driver IC, and HF is a square wave voltage signal throughout the entire display period.

FIG. 12C is a timing diagram of the pixel circuit shown in FIG. 12A of at least one embodiment of the present disclosure.

In one embodiment shown in FIG. 12C, HF is provided by a GOA circuit. In the light emitting phase, HF is a square wave voltage signal. In the time period other than the light emitting phase included in the display period, HF is a high voltage signal.

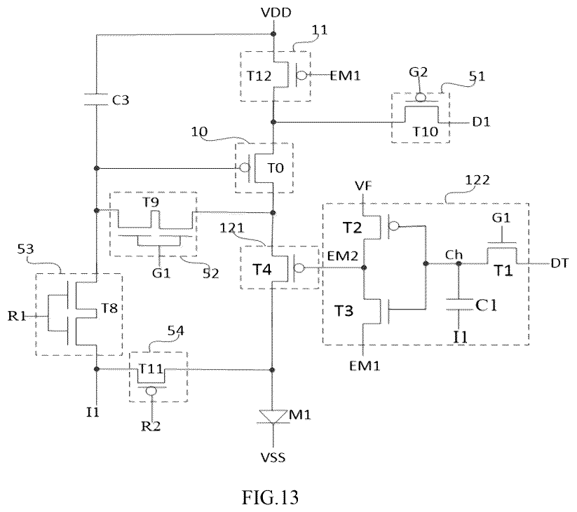

The difference between one embodiment of the pixel circuit shown in FIG. 13 of the present disclosure and at least one embodiment of the pixel circuit shown in FIG. 7A of the present disclosure is that: T8 and T9 are both dual-gate transistors to reduce leakage and maintain the potential of the gate electrode of T0; T8 and T9 are oxide thin film transistors.

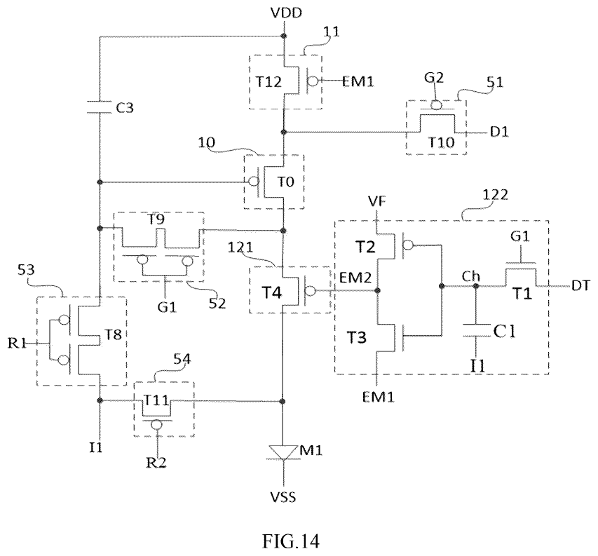

The difference between one embodiment of the pixel circuit shown in FIG. 14 of the present disclosure and at least one embodiment of the pixel circuit shown in FIG. 7A of the present disclosure is that: T8 and T9 are both dual-gate transistors to reduce leakage and maintain the potential of the gate electrode of T0; T8 and T9 are low-temperature polysilicon thin film transistors.

The difference between one embodiment of the pixel circuit shown in FIG. 15 of the present disclosure and at least one embodiment of the pixel circuit shown in FIG. 7A of the present disclosure is that T2 is an n-type transistor and T3 is a p-type transistor.

In one embodiment of the pixel circuit shown in FIG. 15, T8 may be replaced by a p-type transistor, T9 may be replaced by a p-type transistor, and T10 may be replaced by an n-type transistor, but not limited thereto.

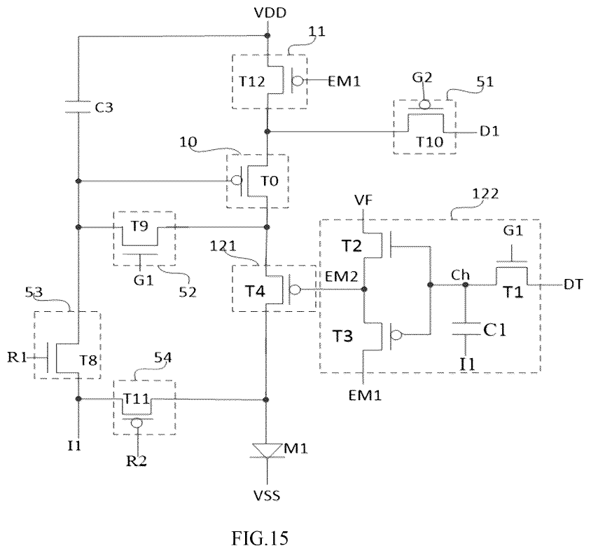

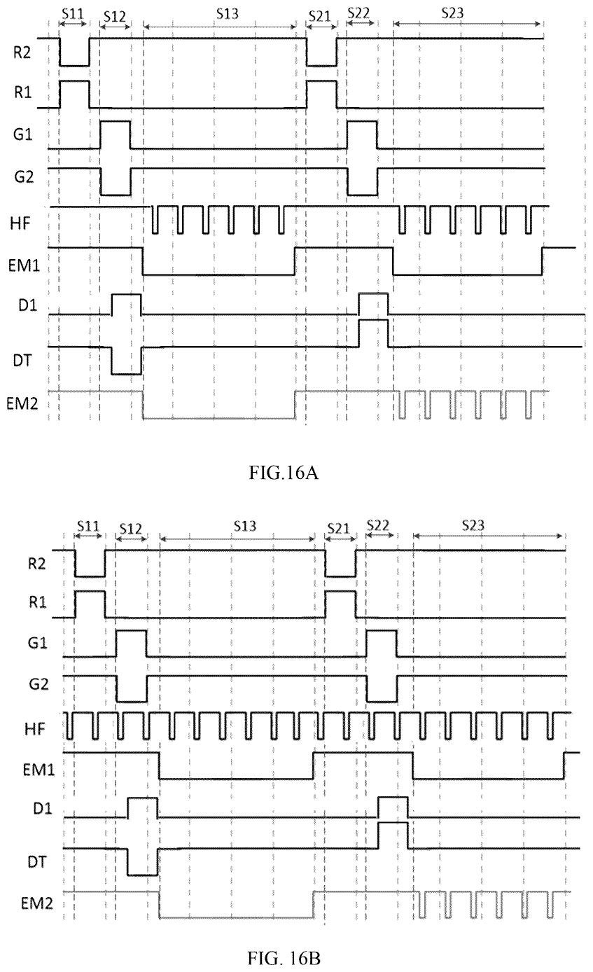

As shown in FIG. 16A, when at least one embodiment of the pixel circuit shown in FIG. 15 of the present disclosure is in operation, the first display period includes a first initialization phase S11, a first data writing-in phase S12, and a first light emitting phase S13 that are successively arranged;
In the first initialization phase S11, R1 provides a high voltage signal, R2 provides a low voltage signal, G1 provides a low voltage signal, G2 provides a high voltage signal, EM1 provides a high voltage signal, T8 and T11 are turned on, and the first initial voltage terminal I1 provides a first initial voltage Vinil to the gate electrode of T0 and the anode of M1, so that when the first data writing-in phase S12 begins, T0 can be turned on and clear the residual charge on the anode of M1;
In the first initialization phase S11, T9 is turned off, T10 is turned off, and T12 is turned off;
In the first data writing-in phase S12, R1 provides a low voltage signal, R2 provides a high voltage signal, G1 provides a high voltage signal, G2 provides a low voltage signal, EM1 provides a high voltage signal, D1 provides a data voltage Vdata, DT provides a low voltage signal, and T10 is turned on to write Vdata into the source electrode of T0;
At the beginning of the first data writing-in phase S12, T0 is turned on, T9 is turned on, and C3 is charged by Vdata to change the potential of the gate electrode of T0 until T0 is turned off. The gate potential of T0 is related to the threshold voltage of T0;
In the first data writing-in phase S12, T8 and T11 are turned off, T12 is turned off, and T1 is turned on to control DT to be connected with ch, the potential of ch is a low voltage, T3 is turned on, and T2 is turned off to control EM1 to be connected with EM2;
In the first light emitting phase S13, R1 provides a low voltage signal, R2 provides a high voltage signal, G1 provides a low voltage signal, G2 provides a high voltage signal, EM1 provides a low voltage signal, T12 is turned on, C1 maintains the potential of ch at a low voltage, T2 is turned off, T3 is turned on, so as to control the connection between EM1 and EM2, the potential of EM2 is a low voltage signal, T4 is turned on, and T0 drives M1 to emit light, so as to perform PAM long-time light emitting;
The second display period includes a second initialization phase S21, a second data writing-in phase S22, and a second light emitting phase S23 which are arranged successively;
In the second initialization phase S21, R1 provides a high voltage signal, R2 provides a low voltage signal, G1 provides a low voltage signal, G2 provides a high voltage signal, EM1 provides a high voltage signal, TS and T11 are turned on, and the first initial voltage terminal I1 provides the first initial voltage Vinil to the gate electrode of T0 and the anode of M1, so that when the first data writing-in phase S12 begins, T0 can be turned on and clear the residual charge on the anode of M1;
In the second initialization phase S21, T9 is turned off, T10 is turned off, and T12 is turned off;
In the second data writing-in phase S22, R1 provides a low voltage signal, R2 provides a high voltage signal, G1 provides a high voltage signal, G2 provides a low voltage signal, EM1 provides a high voltage signal, D1 provides a data voltage Vdata, DT provides a high voltage signal, and T10 is turned on to write Vdata into the source electrode of T0;
At the beginning of the second data writing-in phase S22, T0 is turned on, T9 is turned on, and C3 is charged by Vdata to change the potential of the gate electrode of T0 until T0 is turned off. The gate potential of T0 is related to the threshold voltage of T0;
In the second data writing-in phase S22, TS and T11 are turned off, T12 is turned off, and T1 is turned on to control DT to be connected to ch, the potential of ch is a high voltage, T2 is turned on, and T3 is turned off to control EM2 to access HF;
In the second light emitting phase S23, R1 provides a low voltage signal, R2 provides a high voltage signal, G1 provides a low voltage signal, G2 provides a high voltage signal, EM1 provides a low voltage signal, T12 is turned on, C1 maintains the potential of ch at a high voltage, T2 is turned on, and T3 is turned off to control EM2 to access HF. When the voltage value of HF is a low voltage, T4 is turned on. When T4 is turned on, T0 drives M1 to emit light to perform PWM high-frequency short-time light emitting and perform low grayscale display.

When one embodiment of the pixel circuit of the present disclosure as shown in FIG. 15 is working, in the first data writing-in phase, the potential of ch is a low voltage, T3 is turned on, and after entering the first light emitting phase, the potential of ch needs to maintain the voltage value of the low voltage signal provided by DT (the voltage value may be −9V, for example) to ensure the turned-on state of T3. If the voltage value of the low voltage signal provided by G1 is −7V at this time, T1 is prone to reverse leakage, resulting in an increase in the potential of ch. Therefore, it is necessary to adjust the voltage value of the low voltage signal provided by G1 to −12V to −9V (if it is necessary to completely turn off T1 so that ch has no reverse leakage, it is necessary to reduce the voltage value of the low voltage signal provided by G1 to −12V, but in order to meet the needs, it is also acceptable to reduce it to −9V).

In one embodiment shown in FIG. 16A, HF is provided by a GOA (Gate On Array, a gate driving circuit arranged on an array substrate) circuit. In the light emitting phase, HF is a square wave voltage signal. In the time period other than the light emitting phase included in the display period, HF is a high voltage signal.

The difference between the working timing diagram shown in FIG. 16B and the working timing diagram shown in FIG. 16A is that: during the entire display period, HF is a square wave voltage signal. At this time, HF can be provided by a driver IC (integrated circuit). The driver IC periodically gives a signal. Within one frame of display time, the driver IC will provide a square wave voltage signal for VF.

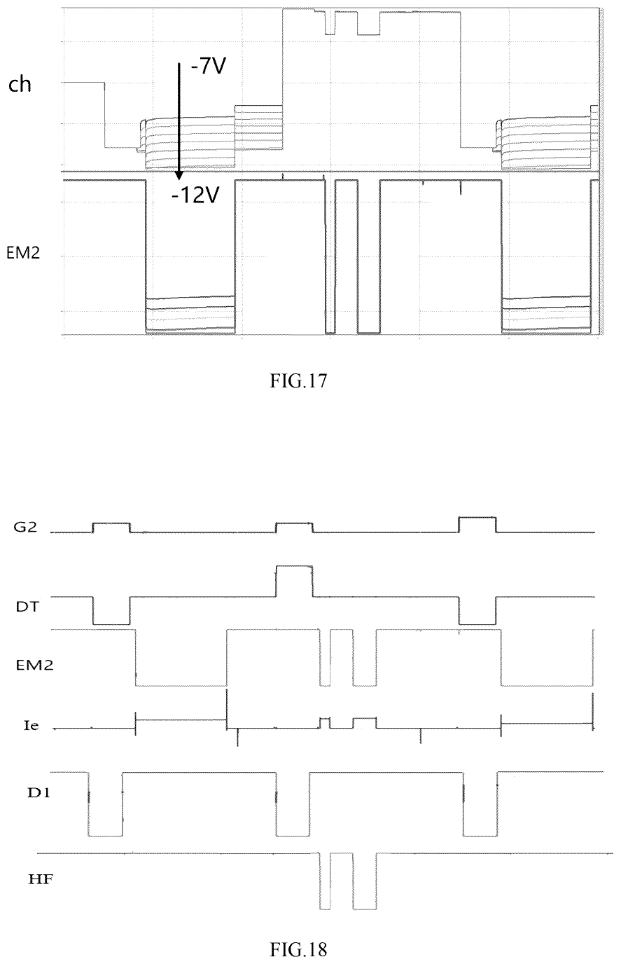

As shown in FIG. 17, when at least one embodiment of the pixel circuit shown in FIG. 15 of the present disclosure is in operation, the lower the potential of ch is, the lower the potential of EM2 is.

FIG. 18 is the simulation timing diagram of the pixel circuit shown in FIG. 15 of the present disclosure.

In FIG. 9 and FIG. 18, the current labeled Ie is the current flowing through M1.

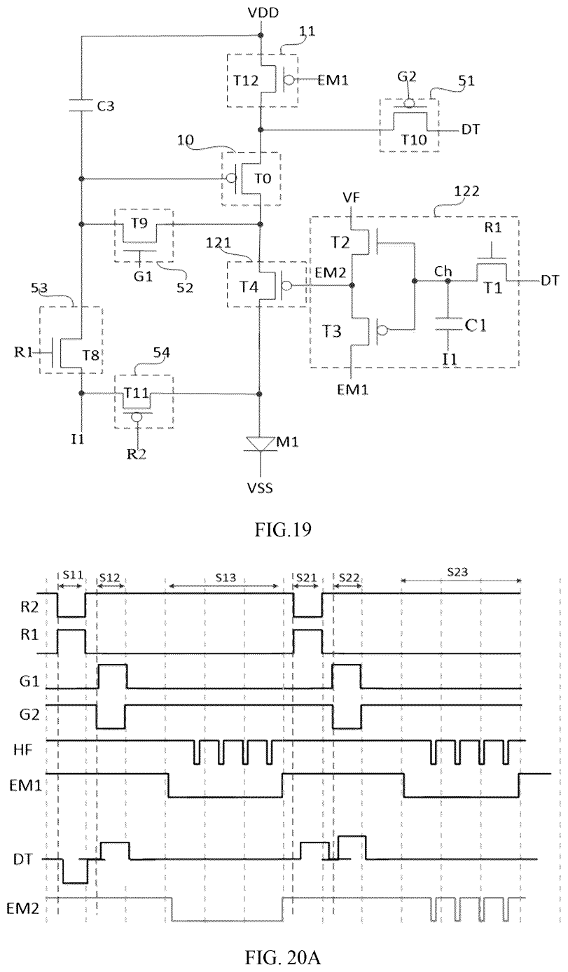

The difference between one embodiment of the pixel circuit shown in FIG. 19 of the present disclosure and at least one embodiment of the pixel circuit shown in FIG. 15 of the present disclosure is that the source electrode of T10 is electrically connected to DT, and the gate electrode of T1 is electrically connected to R1.

In at least one embodiment of the pixel circuit shown in FIG. 19 of the present disclosure, the data voltage and the light emitting data voltage may be combined into one voltage signal.

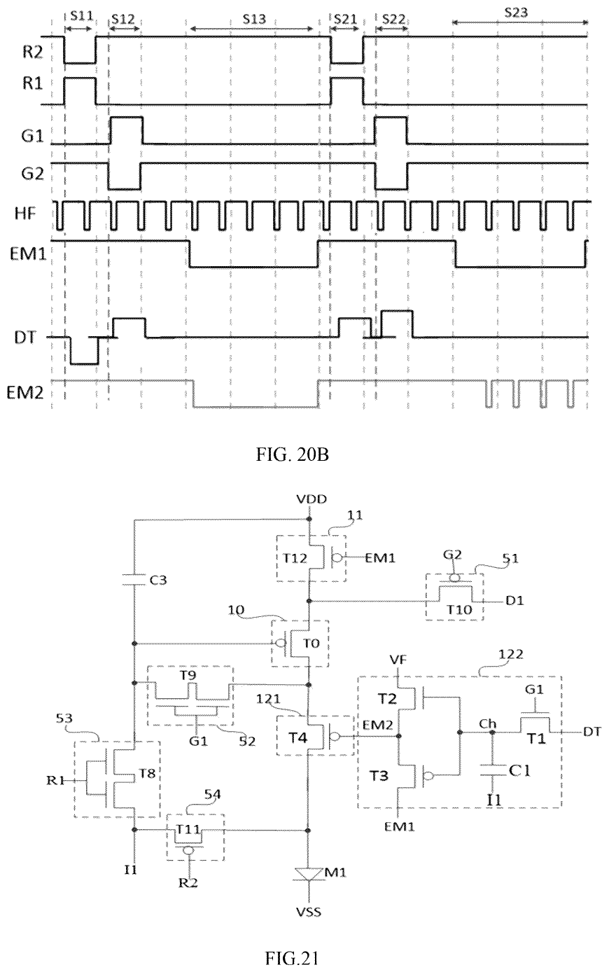

As shown in FIG. 20A, when at least one embodiment of the pixel circuit shown in FIG. 19 of the present disclosure is in operation, the first display period includes a first initialization phase S11, a first data writing-in phase S12, and a first light emitting phase S13 that are successively arranged;
In the first initialization phase S11, R1 provides a high voltage signal, R2 provides a low voltage signal, G1 provides a low voltage signal, G2 provides a high voltage signal, EM1 provides a high voltage signal, T8 and T11 are turned on, and the first initial voltage terminal I1 provides a first initial voltage Vini1 to the gate electrode of T0 and the anode of M1, so that when the first data writing-in phase S121 begins, T0 can be turned on and clear the residual charge on the anode of M1;
In the first initialization phase S11, T9 is turned off, T10 is turned off, and T12 is turned off;
In the first initialization phase S11, T1 is turned on, DT provides a light emitting data voltage, the light emitting data voltage provided by DT is a low voltage, T8 and T11 are turned off, T12 is turned off, T1 is turned on to control DT to be connected with ch, the potential of ch is a low voltage, T3 is turned on, T2 is turned off, to control EM1 to be connected with EM2;
In the first data writing-in phase S12, R1 provides a low voltage signal, R2 provides a high voltage signal, G1 provides a low voltage signal, G2 provides a low voltage signal, EM1 provides a high voltage signal, DT provides a data voltage Vdata, T10 is turned on to write Vdata into the source electrode of T0, and T1 is turned off;
At the beginning of the first data writing-in phase S12, T0 is turned on, T9 is turned on, and C3 is charged by Vdata to change the potential of the gate electrode of T0 until T0 is turned off. The gate potential of T0 is related to the threshold voltage of T0;
In the first light emitting phase S13, R1 provides a low voltage signal, R2 provides a high voltage signal, G1 provides a low voltage signal, G2 provides a high voltage signal, EM1 provides a low voltage signal, T12 is turned on, C1 maintains the potential of ch at a high voltage, T2 is turned off, T3 is turned on, so as to control the connection between EM1 and EM2, the potential of EM2 is a low voltage signal, T4 is turned on, and T0 drives M1 to emit light, so as to perform PAM long-time light emitting;
The second display period includes a second initialization phase S21, a second data writing-in phase S22, and a second light emitting phase S23 which are arranged successively;
In the second initialization phase S21, R1 provides a high voltage signal, R2 provides a low voltage signal, G1 provides a low voltage signal, G2 provides a high voltage signal, EM1 provides a high voltage signal, TS and T11 are turned on, and the first initial voltage terminal I1 provides a first initial voltage Vini1 to the gate electrode of T0 and the anode of M1, so that when the third writing-in time period S221 starts, T0 can be turned on and clear the residual charge of the anode of M1;
In the second initialization phase S21, T9 is turned off, T10 is turned off, and T12 is turned off;
In the second initialization phase S21, T1 is turned on, DT provides a light emitting data voltage, the light emitting data voltage provided by DT is a high voltage, T8 and T11 are turned off, T12 is turned off, T1 is tumed on to control DT to be connected to ch, the potential of ch is a high voltage, T2 is turned on, T3 is turned off, to control EM2 to access HF;
In the second data writing-in phase S22, R1 provides a low voltage signal, R2 provides a high voltage signal, G1 provides a low voltage signal, G2 provides a low voltage signal, EM1 provides a high voltage signal, DT provides a data voltage Vdata, and T10 is turned on to write Vdata into the source electrode of T0;
At the beginning of the second data writing-in phase S22, T0 is turned on, T9 is turned on, and C3 is charged by Vdata to change the potential of the gate electrode of T0 until T0 is turned off. The gate potential of T0 is related to the threshold voltage of T0;
In the second light emitting phase S23, R1 provides a low voltage signal, R2 provides a high voltage signal, G1 provides a low voltage signal, G2 provides a high voltage signal, EM1 provides a low voltage signal, T12 is turned on, C1 maintains the potential of ch at a low voltage, T2 is turned on, and T3 is turned off to control EM2 to access HF. When the voltage value of HF is a low voltage, T4 is turned on. When T4 is turned on, T0 drives M1 to emit light to perform PWM high-frequency short-time light emitting and perform low grayscale display.

In one embodiment shown in FIG. 20A, HE is provided by a GOA (Gate On Array, a gate driving circuit arranged on an array substrate) circuit. In the light emitting phase, HF is a square wave voltage signal. In the time period other than the light emitting phase included in the display period, HF is a high voltage signal.

The difference between the working timing diagram shown in FIG. 20B and the working timing diagram shown in FIG. 20A is that: during the entire display period, HF is a square wave voltage signal. At this time, HF can be provided by a driver IC (integrated circuit). The driver IC periodically gives a signal. Within one frame of display time, the driver IC will provide a square wave voltage signal for VF.

The difference between one embodiment of the pixel circuit shown in FIG. 21 of the present disclosure and at least one embodiment of the pixel circuit shown in FIG. 15 of the present disclosure is that: T8 and T9 are both dual-gate transistors to reduce leakage and maintain the potential of the gate electrode of T0; T8 and T9 are oxide thin film transistors.

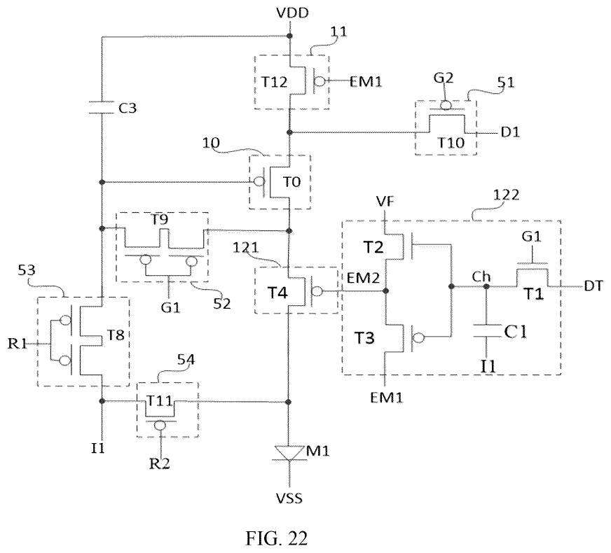

The difference between one embodiment of the pixel circuit shown in FIG. 22 of the present disclosure and at least one embodiment of the pixel circuit shown in FIG. 15 of the present disclosure is that: T8 and T9 are both dual-gate transistors to reduce leakage and maintain the potential of the gate electrode of T0; T8 and T9 are low-temperature polysilicon thin-film transistors.

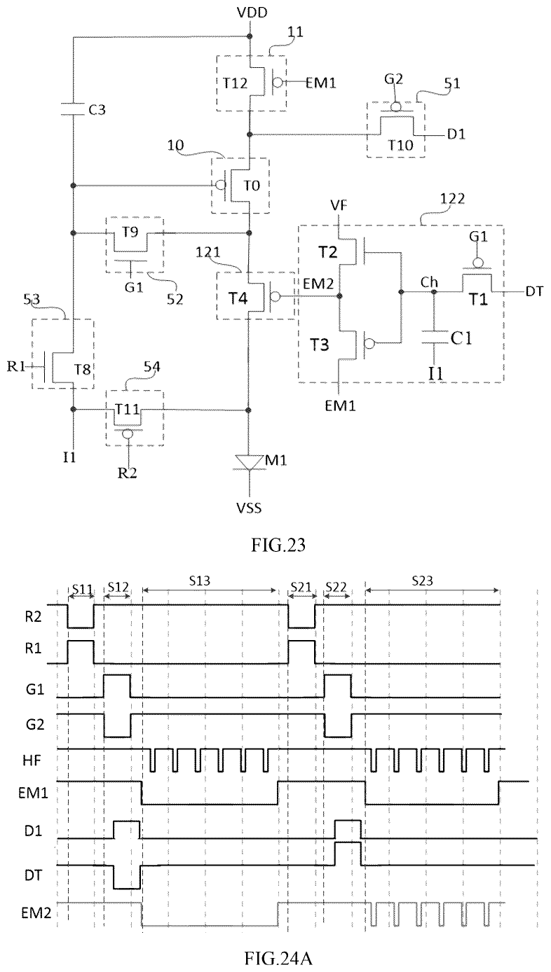

The difference between one embodiment of the pixel circuit shown in FIG. 23 of the present disclosure and at least one embodiment of the pixel circuit shown in FIG. 15 of the present disclosure is that: T1 is a p-type transistor;

The gate electrode of T1 is electrically connected to the second control terminal G2.

In one embodiment of the pixel circuit shown in FIG. 23, the first control terminal and the second control terminal are the same control terminal, and the gate electrode of T0 and the gating control terminal ch are charged simultaneously through D1 and DT respectively.

In one embodiment of the pixel circuit shown in FIG. 23, T8 may be replaced by a p-type transistor, T9 may be replaced by a p-type transistor, and T10 may be replaced by an n-type transistor, but not limited thereto.

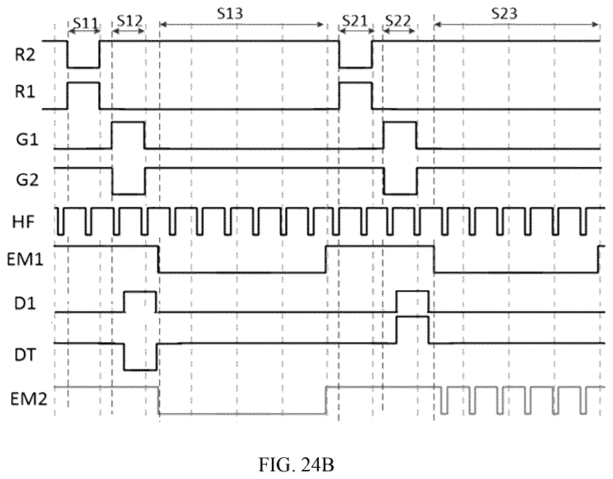

As shown in FIG. 24A, when at least one embodiment of the pixel circuit shown in FIG. 23 of the present disclosure is in operation, the first display period includes a first initialization phase S11, a first data writing-in phase S12, and a first light emitting phase S13 that are successively arranged;

In the first initialization phase S11, R1 provides a high voltage signal, R2 provides a low voltage signal, G2 provides a high voltage signal, EM1 provides a high voltage signal, TS and T11 are turned on, and the first initial voltage terminal I1 provides a first initial voltage Vinil to the gate electrode of T0 and the anode of M1, so that when the first data writing-in phase S12 begins, T0 can be turned on and clear the residual charge on the anode of M1;
In the first initialization phase S11, T9 is turned off, T10 is turned off, and T12 is turned off;
In the first data writing-in phase S12, R1 provides a low voltage signal, R2 provides a high voltage signal, G2 provides a low voltage signal, EM1 provides a high voltage signal, D1 provides a data voltage Vdata, DT provides a low voltage signal, and T10 is turned on to write Vdata into the source electrode of T0;
At the beginning of the first data writing-in phase S12, T0 is turned on, T9 is turned on, and C3 is charged by Vdata to change the potential of the gate electrode of T0 until T0 is turned off. The gate potential of T0 is related to the threshold voltage of T0;
In the first data writing-in phase S12, T8 and T11 are turned off, T12 is turned off, and T1 is turned on to control DT to be connected with ch, the potential of ch is a low voltage, T3 is turned on, and T2 is turned off to control EM1 to be connected with EM2;
In the first light emitting phase S13, R1 provides a low voltage signal, R2 provides a high voltage signal, G2 provides a high voltage signal, EM1 provides a low voltage signal, T12 is turned on, C1 maintains the potential of ch at a low voltage, T2 is turned off, T3 is turned on, so as to control the connection between EM1 and EM2, the potential of EM2 is a low voltage signal, T4 is turned on, and T0 drives M1 to emit light, so as to perform PAM long-time light emitting;
The second display period includes a second initialization phase S21, a second data writing-in phase S22, and a second light emitting phase S23 which are arranged successively;
In the second initialization phase S21, R1 provides a high voltage signal, R2 provides a low voltage signal, G2 provides a high voltage signal, EM1 provides a high voltage signal, TS and T11 are turned on, and the first initial voltage terminal I1 provides a first initial voltage Vini1 to the gate electrode of T0 and the anode of M1, so that when the first data writing-in phase S12 begins, T0 can be turned on and clear the residual charge on the anode of M1;
In the second initialization phase S21, T9 is turned off, T10 is turned off, and T12 is turned off;
In the second data writing-in phase S22, R1 provides a low voltage signal, R2 provides a high voltage signal, G2 provides a low voltage signal, EM1 provides a high voltage signal, D1 provides a data voltage Vdata, DT provides a high voltage signal, and T10 is turned on to write Vdata into the source electrode of T0;
At the beginning of the second data writing-in phase S22, T0 is turned on, T9 is turned on, and C3 is charged by Vdata to change the potential of the gate electrode of T0 until T0 is turned off. The gate potential of T0 is related to the threshold voltage of T0;
In the second data writing-in phase S22, T8 and T11 are turned off, T12 is turned off, and T1 is turned on to control DT to be connected to ch, the potential of ch is a high voltage, T2 is turned on, and T3 is turned off to control EM2 to access HF;
In the second light emitting phase S23, R1 provides a low voltage signal, R2 provides a high voltage signal, G2 provides a high voltage signal, EM1 provides a low voltage signal, T12 is turned on, C1 maintains the potential of ch at a high voltage, T2 is turned on, and T3 is turned off to control EM2 to access HF. When the voltage value of HF is a low voltage, T4 is turned on. When T4 is turned on, T0 drives M1 to emit light to perform PWM high-frequency short-time light emitting and perform low grayscale display.

In one embodiment shown in FIG. 24A, HF is provided by a GOA (Gate On Array, a gate driving circuit arranged on an array substrate) circuit. In the light emitting phase, HF is a square wave voltage signal. In the time period other than the light emitting phase included in the display period, HF is a high voltage signal.

The difference between the working timing diagram shown in FIG. 24B and the working timing diagram shown in FIG. 24A is that: during the entire display period, HF is a square wave voltage signal. At this time, HF can be provided by a driver IC (integrated circuit). The driver IC periodically gives a signal. Within one frame of display time, the driver IC will provide a square wave voltage signal for VF.

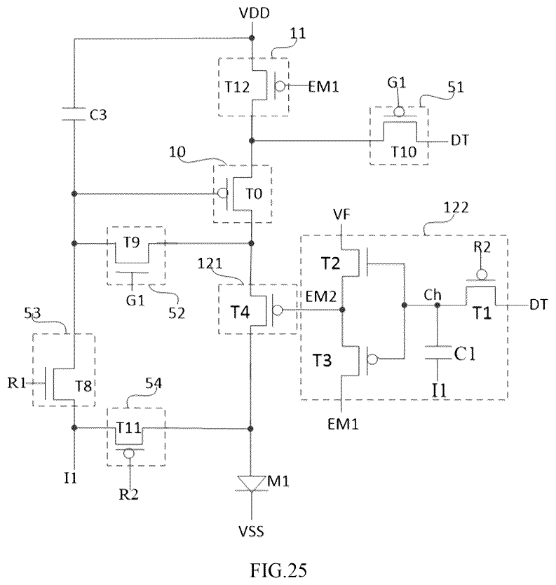

The difference between one embodiment of the pixel circuit shown in FIG. 25 of the present disclosure and at least one embodiment of the pixel circuit shown in FIG. 23 of the present disclosure is that: the gate electrode of T1 is electrically connected to R2; and the source electrode of T10 is electrically connected to DT.

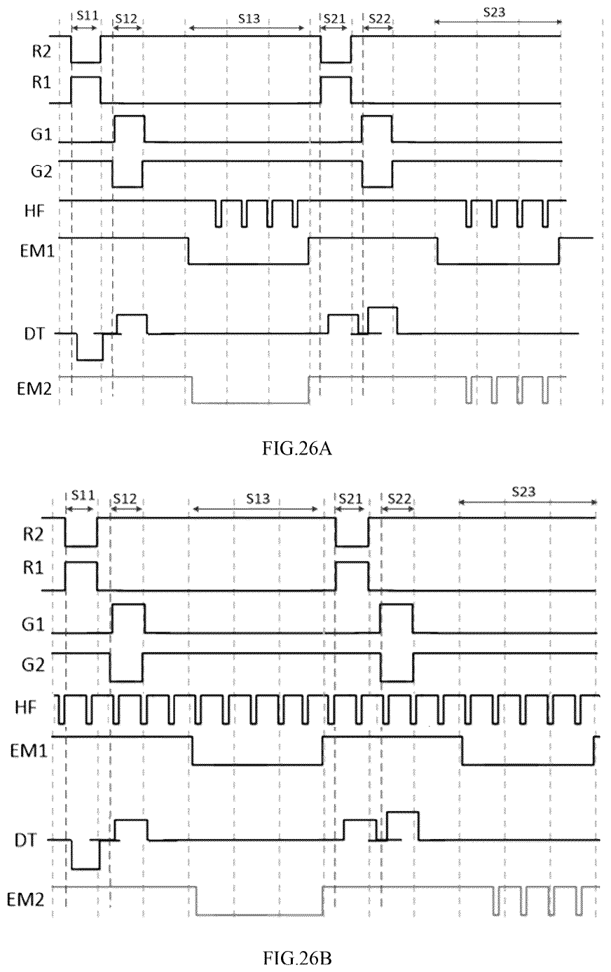

As shown in FIG. 26A, when at least one embodiment of the pixel circuit shown in FIG. 25 of the present disclosure is in operation, the first display period includes a first initialization phase S11, a first data writing-in phase S12, and a first light emitting phase S13 which are successively arranged:
In the first initialization phase S11, R1 provides a high voltage signal, R2 provides a low voltage signal, G1 provides a high voltage signal, G2 provides a high voltage signal, EM1 provides a high voltage signal. T8 and T11 are turned on, and the first initial voltage terminal I1 provides a first initial voltage Vinil to the gate electrode of T0 and the anode of M1, so that when the first data writing-in phase S12 begins, T0 can be turned on and clear the residual charge on the anode of M1;
In the first initialization phase S11, DT provides a light emitting data voltage, which is a low voltage, T8 and T11 are turned off, T12 is turned off, and T1 is turned on to control DT to be connected to ch, the potential of ch is a low voltage, T3 is turned on, and T2 is turned off to control EM1 to be connected to EM2;
In the first initialization phase S11, T9 is turned off, T10 is turned off, and T12 is turned off;
In the first data writing-in phase S12, R1 provides a low voltage signal, R2 provides a high voltage signal, G1 provides a high voltage signal, G2 provides a low voltage signal, EM1 provides a high voltage signal, DT provides a data voltage Vdata, T10 is turned on to write Vdata into the source electrode of T0, and T1 is turned off;
At the beginning of the first data writing-in phase S12, T0 is turned on, T9 is turned on, and C3 is charged by Vdata to change the potential of the gate electrode of T0 until T0 is turned off. The gate potential of T0 is related to the threshold voltage of T0;
In the first light emitting phase S13, R1 provides a low voltage signal, R2 provides a high voltage signal, G1 provides a high voltage signal, G2 provides a high voltage signal, EM1 provides a low voltage signal, T12 is turned on, C1 maintains the potential of ch at a high voltage, T2 is turned off, T3 is turned on, so as to control the connection between EM1 and EM2, the potential of EM2 is a low voltage signal, T4 is turned on, and T0 drives M1 to emit light, so as to perform PAM long-time light emitting;
The second display period includes a second initialization phase S21, a second data writing-in phase S22, and a second light emitting phase S23 which are arranged successively;
In the second initialization phase S21, R1 provides a high voltage signal, R2 provides a low voltage signal, G1 provides a high voltage signal, G2 provides a high voltage signal, EM1 provides a high voltage signal, TS and T11 are turned on, and the first initial voltage terminal I1 provides a first initial voltage Vinil to the gate electrode of T0 and the anode of M1, so that when the third writing-in time period S221 starts, T0 can be turned on and clear the residual charge of the anode of M1;
In the second initialization phase S21, T9 is turned off, T10 is turned off, and T12 is turned off;
In the second initialization phase S21, DT provides a light emitting data voltage, which is a high voltage, T8 and T11 are turned off, T12 is turned off, and T1 is turned on to control DT to be connected to ch, the potential of ch is a high voltage, T2 is turned on, and T3 is turned off to control EM2 to access HF;
In the second data writing-in phase S22, R1 provides a low voltage signal, R2 provides a high voltage signal, G1 provides a high voltage signal, G2 provides a low voltage signal, EM1 provides a high voltage signal, DT provides a data voltage Vdata, and T10 is turned on to write Vdata into the source electrode of T0;
At the beginning of the second data writing-in phase S22, T0 is turned on, T9 is turned on, and C3 is charged by Vdata to change the potential of the gate electrode of T0 until T0 is turned off. The gate potential of T0 is related to the threshold voltage of T0;
In the second light emitting phase S23, R1 provides a low voltage signal, R2 provides a high voltage signal, G1 provides a high voltage signal, G2 provides a high voltage signal, EM1 provides a low voltage signal, T12 is turned on, C1 maintains the potential of ch at a low voltage, T2 is turned on, and T3 is turned off to control EM2 to access HF. When the voltage value of HF is a low voltage, T4 is turned on. When T4 is turned on, T0 drives M1 to emit light to perform PWM high-frequency short-time light emitting and perform low grayscale display.

In one embodiment shown in FIG. 26A, HF is provided by a GOA (Gate On Array, a gate driving circuit arranged on an array substrate) circuit. In the light emitting phase, HF is a square wave voltage signal. In the time period other than the light emitting phase included in the display period, HF is a high voltage signal.

The difference between the working timing diagram shown in FIG. 26B and the working timing diagram shown in FIG. 26A is that: during the entire display period, HF is a square wave voltage signal. At this time, HF can be provided by a driver IC (integrated circuit). The driver IC periodically gives a signal. Within one frame of display time, the driver IC will provide a square wave voltage signal for VF.

In at least one embodiment of the pixel circuit described in the present disclosure, the capacitance value of C1 electrically connected to the drain electrode of T1 can be reduced, or C1 can be removed, which is beneficial to achieve high PPI (Pixels Per Inch, pixel density).

In at least one embodiment of the present disclosure, when T1 is an n-type transistor, T2 is a p-type transistor, and T3 is an n-type transistor, the voltage value of the low voltage signal provided by the first initial voltage Vinil and VSS can be −2V, the voltage value of the high voltage signal provided by VDD can be 8V, the high voltage value of the first control signal provided by G1 can be 7V, and the low voltage value of the first control signal provided by G1 can be −9V; the high voltage value of the first light emitting control signal provided by EM1 can be 7V, and the low voltage value of the first light emitting control signal provided by EM1 can be −7V, the high voltage value of HF can be 7V, and the low voltage value of HF can be −7V, the voltage value of the data voltage provided by D1 can be greater than or equal to 4V and less than or equal to 6V, the high voltage value of the light emitting data voltage provided by DT can be 5V, and the low voltage value of the light emitting data voltage provided by DT can be −8V. In the light emitting phase, DT can provide a OV voltage signal, but is not limited to this.

In at least one embodiment of the present disclosure, when T1 is an n-type transistor, T2 is an n-type transistor, and T3 is a p-type transistor, the voltage value of the low voltage signal provided by the first initial voltage Vinil and VSS may be −2V, the voltage value of the high voltage signal provided by VDD may be 8V, the high voltage value of the first control signal provided by G1 may be 10V, and the low voltage value of the first control signal provided by G1 may be −12V; the high voltage value of the first light emitting control signal provided by EM1 may be 7V, and the low voltage value of the first light emitting control signal provided by EM1 may be −7V, the high voltage value of HF may be 7V, and the low voltage value of HF may be −7V, the voltage value of the data voltage provided by D1 may be greater than or equal to 4V and less than or equal to 6V, the high voltage value of the light emitting data voltage provided by DT may be 9V, and the low voltage value of the light emitting data voltage provided by DT may be −8V, and in the light emitting phase, DT may provide a OV voltage signal, but is not limited to this.

In at least one embodiment of the present disclosure, when T1 is a p-type transistor, T2 is an n-type transistor, and T3 is a p-type transistor, the voltage value of the low voltage signal provided by the first initial voltage Vini1 and VSS may be −2V, the voltage value of the high voltage signal provided by VDD may be 8V, the high voltage value of the first control signal provided by G1 may be 10V, and the low voltage value of the first control signal provided by G1 may be −7V; the high voltage value of the first light emitting control signal provided by EM1 may be 7V, and the low voltage value of the first light emitting control signal provided by EM1 may be −7V, the high voltage value of HF may be 7V, and the low voltage value of HF may be −7V, the voltage value of the data voltage provided by D1 may be greater than or equal to 4V and less than or equal to 6V, the high voltage value of the light emitting data voltage provided by DT may be 9V, and the low voltage value of the light emitting data voltage provided by DT may be −7V, and in the light emitting phase, DT may provide a OV voltage signal, but is not limited to this.

In specific implementation, when the light emitting data voltage provided by DT needs to be positive, In at least one embodiment of the present disclosure, when T1 is an n-type transistor, T2 is a p-type transistor, and T3 is an n-type transistor, the voltage value of the low voltage signal provided by the first initial voltage Vinil and VSS may be −2V, the voltage value of the high voltage signal provided by VDD may be 8V, the high voltage value of the first control signal provided by G1 may be 15V, and the low voltage value of the first control signal provided by G1 may be −1V; the high voltage value of the first light emitting control signal provided by EM1 may be 15V, and the low voltage value of the first light emitting control signal provided by EM1 may be 1V, the high voltage value of HF may be 15V, and the low voltage value of HF may be 1V, the voltage value of the data voltage provided by D1 may be greater than or equal to 12V and less than or equal to 14V, the high voltage value of the light emitting data voltage provided by DT may be 13V, and the low voltage value of the light emitting data voltage provided by DT may be 0V, but is not limited to this.

In specific implementation, when the light emitting data voltage provided by DT needs to be positive,
In at least one embodiment of the present disclosure, when T1 is an n-type transistor, T2 is an n-type transistor, and T3 is a p-type transistor, the voltage value of the low voltage signal provided by the first initial voltage Vini1 and VSS may be −2V, the voltage value of the high voltage signal provided by VDD may be 8V, the high voltage value of the first control signal provided by G1 may be 18V, and the low voltage value of the first control signal provided by G1 may be −4V; the high voltage value of the first light emitting control signal provided by EM1 may be 15V, and the low voltage value of the first light emitting control signal provided by EM1 may be 1V, the high voltage value of HF may be 15V, and the low voltage value of HF may be 1V, the voltage value of the data voltage provided by D1 may be greater than or equal to 12V and less than or equal to 14V, the high voltage value of the light emitting data voltage provided by DT may be 17V, and the low voltage value of the light emitting data voltage provided by DT may be 0V, but is not limited to this.

In specific implementation, when the light emitting data voltage provided by DT needs to be positive,

When T1 is a p-type transistor, T2 is an n-type transistor, and T3 is a p-type transistor, the voltage value of the low voltage signal provided by the first initial voltage Vinil and VSS can be −2V, the voltage value of the high voltage signal provided by VDD can be 8V, the high voltage value of the first control signal provided by G1 can be 17V, and the low voltage value of the first control signal provided by G1 can be OV; the high voltage value of the first light emitting control signal provided by EM1 can be 15V, and the low voltage value of the first light emitting control signal provided by EM1 can be 1V, the high voltage value of HF can be 15V, and the low voltage value of HF can be 1V, the voltage value of the data voltage provided by D1 can be greater than or equal to 12V and less than or equal to 14V, the high voltage value of the light emitting data voltage provided by DT can be 16V, and the low voltage value of the light emitting data voltage provided by DT can be 0V, but is not limited to this.

In at least one embodiment of the present disclosure, when T1 is an n-type transistor, T2 is a p-type transistor, and T3 is an n-type transistor,
In the PWM dimming mode, during the low voltage maintenance phase of ch, T1 requires a lower turn-off voltage, so the low voltage value of the first control signal provided by G1 needs to be lowered;
In the PAM dimming mode, the high voltage of HF can be configured to replace the high voltage of EM1 to enter EM2, which is beneficial to reduce the high voltage value of the first control signal provided by G1 and the high voltage value of the light emitting data voltage provided by DT.

In at least one embodiment of the present disclosure, when T1 is an n-type transistor, T2 is an n-type transistor, and T3 is a p-type transistor, When the light emitting data voltage provided by DT is a low voltage, it is necessary to turn on T3 so that the low voltage signal provided by EM1 passes through;
When the light emitting data voltage provided by DT is a high voltage, it is necessary to turn on T2 so that the high voltage of HF passes through. Therefore, the high and low voltage span of the light emitting data voltage provided by DT is relatively large.

The requirement for the high voltage value of the first control signal provided by G1 is also high. At the same time, in the low voltage maintenance phase of ch, the low voltage value of the first control signal provided by G1 needs to be lowered to turn off T1. Therefore, the high and low voltage spans of the first control signal provided by G1 are large.

In at least one embodiment of the present disclosure, when T1 is a p-type transistor, T2 is an n-type transistor, and T3 is a p-type transistor,
In PWM dimming mode, during the high voltage maintenance phase of ch, T1 requires a higher turn-off voltage;
Increasing the turn-off voltage of the first control signal provided by G1 will result in greater stress on T1 during the PAM light emitting phase.
In at least one embodiment of the present disclosure, the light emitting gating circuit includes a second gating control circuit, a third light emitting control circuit and a fourth light emitting control circuit;
The second gating control circuit is electrically connected to the first control terminal, the light emitting data voltage terminal and the gating control terminal respectively, and is configured to write the light emitting data voltage into the gating control terminal under the control of the first control signal;
The third light emitting control circuit is electrically connected to the gating control terminal, the second electrode of the light emitting element and the second voltage terminal respectively, and is configured to control the connection between the second electrode of the light emitting element and the second voltage terminal under the control of the potential of the gating control terminal;
The fourth light emitting control circuit is electrically connected to the light emitting control voltage terminal, the second electrode of the light emitting element and the second voltage terminal respectively, and is configured to control the connection between the second electrode of the light emitting element and the second voltage terminal under the control of the light emitting control voltage provided by the light emitting control voltage terminal.

When at least one embodiment of the present disclosure is working, the second gating control circuit writes the light emitting data voltage into the gating control terminal under the control of the first control signal. When in the light emitting phase, the third light emitting control circuit controls the connection between the second electrode of the light emitting element and the second voltage terminal under the control of the potential of the gating control terminal to achieve PAM long-time light emitting; when in the light emitting phase, the fourth light emitting control circuit is under the control of the light emitting control voltage (the light emitting control voltage is a high-frequency PWM signal) to achieve high-frequency short-time light emitting for low grayscale display,

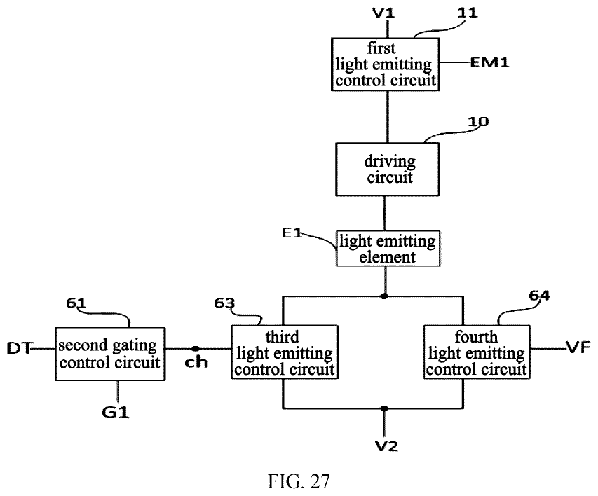

As shown in FIG. 27, the pixel circuit according to at least one embodiment of the present disclosure includes a first light emitting control circuit 11, a light emitting element E1, a driving circuit 10, and a light emitting gating circuit;
The first light emitting control circuit 11 is electrically connected to the first light emitting control terminal EM1, the first voltage terminal V1 and the first terminal of the driving circuit 10 respectively, and is configured to control the connection between the first voltage terminal V1 and the first terminal of the driving circuit 10 under the control of the first light emitting control signal provided by the first light emitting control terminal EM1 during the light emitting phase;
The second terminal of the driving circuit 10 is electrically connected to the first electrode of the light emitting element E1, and the driving circuit 10 is configured to drive the light emitting element E1;
The light emitting gating circuit includes a second gating control circuit 61, a third light emitting control circuit 63 and a fourth light emitting control circuit 64;
The second gating control circuit 61 is electrically connected to the first control terminal G1, the light emitting data voltage terminal DT and the gating control terminal ch respectively, and is configured to write the light emitting data voltage provided by the light emitting data voltage terminal DT into the gating control terminal ch under the control of the first control signal provided by the first control terminal G1;
The third light emitting control circuit 63 is electrically connected to the gating control terminal ch, the second electrode of the light emitting element E1 and the second voltage terminal V2 respectively, and is configured to control the connection between the second electrode of the light emitting element E1 and the second voltage terminal V2 under the control of the potential of the gating control terminal ch;
The fourth light emitting control circuit 64 is electrically connected to the light emitting control voltage terminal VE, the second electrode of the light emitting element E1 and the second voltage terminal V2 respectively, and is configured to control the connection between the second electrode of the light emitting element E1 and the second voltage terminal V2 under the control of the light emitting control voltage HF provided by the light emitting control voltage terminal VF.

In at least one embodiment of the present disclosure, the first voltage terminal may be a high voltage terminal, and the second voltage terminal may be a low voltage terminal, but not limited thereto.

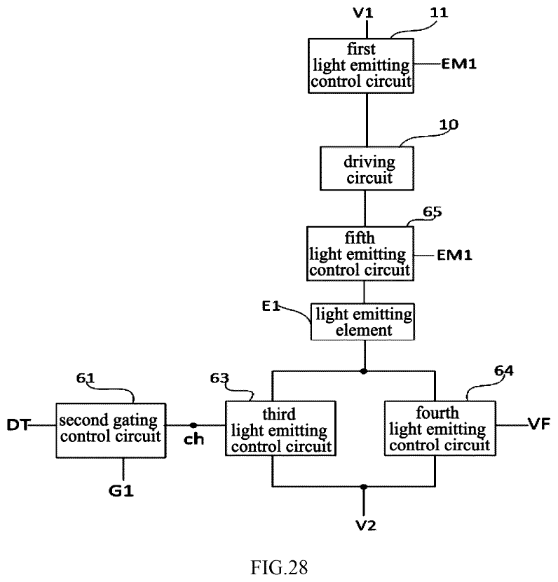

As shown in FIG. 28, based on one embodiment of the pixel circuit shown in FIG. 27, the pixel circuit described in at least one embodiment of the present disclosure may further include a fifth light emitting control circuit 65;
The fifth light emitting control circuit 65 is electrically connected to the first light emitting control terminal EM1, the second terminal of the driving circuit 10 and the first electrode of the light emitting element E1 respectively, and is configured to control the connection between the second terminal of the driving circuit 10 and the first electrode of the light emitting element E1 under the control of the first light emitting control signal.

Optionally, the light emitting gating circuit further includes a second capacitor;
a first terminal of the second capacitor is electrically connected to the gating control terminal, a second terminal of the second capacitor is electrically connected to the first initial voltage terminal, and the second capacitor can be configured to maintain a potential of the gating control terminal.

Optionally, the second gating control circuit includes a fifth transistor, the third light emitting control circuit includes a sixth transistor, and the fourth light emitting control circuit includes a seventh transistor;
a control electrode of the fifth transistor is electrically connected to the first control terminal, a first electrode of the fifth transistor is electrically connected to the light emitting data voltage terminal, and a second electrode of the fifth transistor is electrically connected to the gating control terminal;
a control electrode of the sixth transistor is electrically connected to the gating control terminal, a first electrode of the sixth transistor is electrically connected to the second electrode of the light emitting element, and a second electrode of the sixth transistor is electrically connected to the second voltage terminal;
a control electrode of the seventh transistor is electrically connected to the light emitting control voltage terminal, a first electrode of the seventh transistor is electrically connected to the second electrode of the light emitting element, and a second electrode of the seventh transistor is electrically connected to the second voltage terminal.

Optionally, the seventh transistor is a p-type transistor, the sixth transistor is an n-type transistor, and the fifth transistor is an n-type transistor; or,
The seventh transistor is a p-type transistor, the sixth transistor is an n-type transistor, and the fifth transistor is a p-type transistor; or,
The seventh transistor is an n-type transistor, the sixth transistor is a p-type transistor, and the fifth transistor is an n-type transistor; or,
The seventh transistor is an n-type transistor, the sixth transistor is a p-type transistor, and the fifth transistor is a p-type transistor.

Optionally, the fifth light emitting control circuit may include a thirteenth transistor;
a control electrode of the thirteenth transistor is electrically connected to the first light emitting control terminal, a first electrode of the thirteenth transistor is electrically connected to the second terminal of the driving circuit, and a second electrode of the thirteenth transistor is electrically connected to the first electrode of the light emitting element.

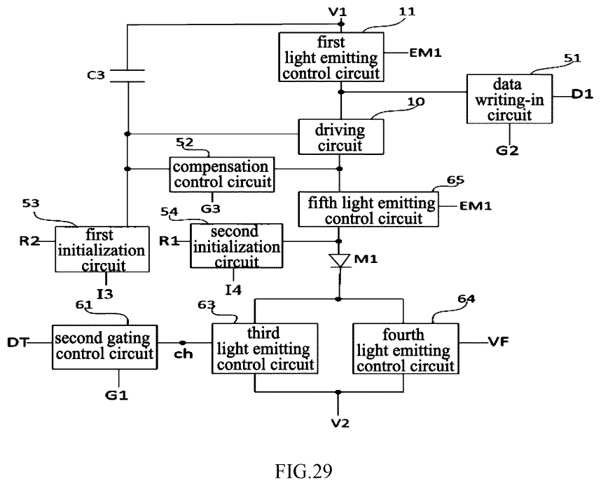

As shown in FIG. 29, based on at least one embodiment of the pixel circuit shown in FIG. 28, the pixel circuit described in at least one embodiment of the present disclosure may further include a data writing-in circuit 51, a compensation control circuit 52, a first initialization circuit 53, a second initialization circuit 54 and a third capacitor C3: the light emitting element is a micro light emitting diode M1;
The data writing-in circuit 51 is electrically connected to the second control terminal G2, the data line D1 and the first terminal of the driving circuit 10 respectively, and is configured to write the data voltage Vdata provided by the data line D1 into the first terminal of the driving circuit 10 under the control of the second control signal provided by the second control terminal G2;
The compensation control circuit 52 is electrically connected to the third control terminal G3, the control terminal of the driving circuit 10 and the second terminal of the driving circuit 10 respectively, and is configured to control the control terminal of the driving circuit 10 to be connected to the second terminal of the driving circuit 10 under the control of the third control signal provided by the third control terminal G3;
The first initialization circuit 53 is electrically connected to the first reset control terminal R1, the control terminal of the driving circuit 10 and the third initial voltage terminal 13 respectively, and is configured to write the third initial voltage provided by the third initial voltage terminal 13 into the control terminal of the driving circuit 10 under the control of the first reset control signal provided by the first reset control terminal R1, so as to initialize the potential of the control terminal of the driving circuit 10;
The second initialization circuit 54 is electrically connected to the second reset control terminal R2, the anode of the micro light emitting diode M1 and the fourth initial voltage terminal 14 respectively, and is configured to write the fourth initial voltage provided by the fourth initial voltage terminal I4 into the anode of the micro light emitting diode M1 under the control of the second reset control signal provided by the second reset control terminal R2;
A first terminal of the third capacitor C3 is electrically connected to the control terminal of the driving circuit 10, and a second terminal of the third capacitor C3 is electrically connected to the first voltage terminal V1.

In one embodiment of the pixel circuit shown in FIG. 29, the first initial voltage terminal, the third initial voltage terminal and the fourth initial voltage terminal can be the same voltage terminal, the first voltage terminal can be a high voltage terminal, and the first control terminal and the third control terminal can be the same control terminal, but are not limited to this.

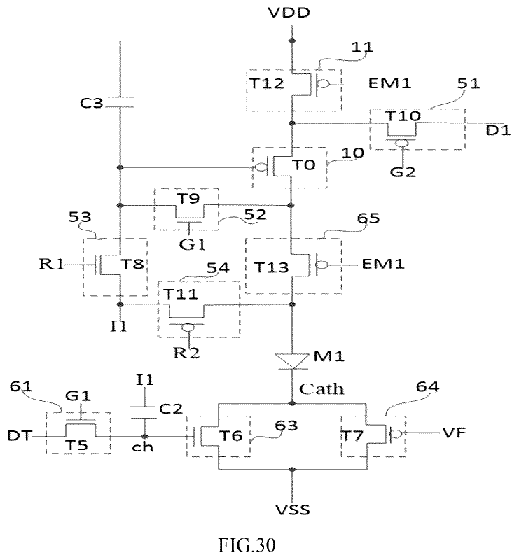

As shown in FIG. 30, based on one embodiment of the pixel circuit shown in FIG. 29, the second gating control circuit includes a fifth transistor T5, the third light emitting control circuit includes a sixth transistor T6, and the fourth light emitting control circuit includes a seventh transistor T7; the light emitting element is a micro light emitting diode M1; and the driving circuit 10 includes a driving transistor T0;
The gate electrode of the fifth transistor T5 is electrically connected to the first control terminal G1, the source electrode of the fifth transistor T5 is electrically connected to the light emitting data voltage terminal DT, and the drain electrode of the fifth transistor T5 is electrically connected to the gating control terminal ch;
The gate electrode of the sixth transistor T6 is electrically connected to the gating control terminal ch, the source electrode of the sixth transistor T6 is electrically connected to the cathode of the micro light emitting diode M1, and the drain electrode of the sixth transistor T6 is electrically connected to the low voltage terminal VSS;
The gate electrode of the seventh transistor T7 is electrically connected to the light emitting control voltage terminal VF, the source electrode of the seventh transistor T7 is electrically connected to the cathode of the micro light emitting diode M1, and the drain electrode of the seventh transistor T7 is electrically connected to the low voltage terminal VSS; the light emitting control voltage terminal VF is configured to provide a light emitting control voltage HF;
The light emitting gating circuit further includes a second capacitor C2;
A first terminal of the second capacitor C2 is electrically connected to the gating control terminal ch, and a second terminal of the second capacitor C2 is electrically connected to the first initial voltage terminal I1;
The first initialization circuit 53 includes an eighth transistor T8, the compensation control circuit 52 includes a ninth transistor T9, the data writing-in circuit 51 includes a tenth transistor T10, and the second initialization circuit 54 includes an eleventh transistor T11;
The gate electrode of the eighth transistor TS is electrically connected to the first reset control terminal R1, the source electrode of the eighth transistor T8 is electrically connected to the first initial voltage terminal I1, and the drain electrode of the eighth transistor T8 is electrically connected to the gate electrode of the driving transistor T0;
The gate electrode of the ninth transistor T9 is electrically connected to the first control terminal G1, the source electrode of the ninth transistor T9 is electrically connected to the gate electrode of the driving transistor T0, and the drain electrode of the ninth transistor T9 is electrically connected to the drain electrode of the driving transistor T0;
The gate electrode of the tenth transistor T10 is electrically connected to the second control terminal G2, the source electrode of the tenth transistor T10 is electrically connected to the data line D1, and the gate electrode of the tenth transistor T10 is electrically connected to the source electrode of the driving transistor T0;
The gate electrode of the eleventh transistor T11 is electrically connected to the second reset control terminal R2, the source electrode of the eleventh transistor T11 is electrically connected to the first initial voltage terminal I1, and the drain electrode of the eleventh transistor T11 is electrically connected to the anode of the micro light emitting diode M1;
The first light emitting control circuit 11 includes a twelfth transistor T12;
The gate electrode of the twelfth transistor T12 is electrically connected to the first light emitting control terminal EM1, the source electrode of the twelfth transistor T12 is electrically connected to the high voltage terminal VDD, and the drain electrode of the twelfth transistor T12 is electrically connected to the source electrode of the driving transistor T0;
The fifth light emitting control circuit 65 may include a thirteenth transistor T13;
A gate electrode of the thirteenth transistor M13 is electrically connected to the first light emitting control terminal EM1, a source electrode of the thirteenth transistor M13 is electrically connected to the drain electrode of the driving transistor T0, and a drain electrode of the thirteenth transistor M13 is electrically connected to the anode of the micro light emitting diode M1.

In FIG. 30, the node labeled Cath is a cathode node, and the cathode node Cath is electrically connected to the cathode of M1.

In one embodiment of the pixel circuit shown in FIG. 30, T5 is an n-type transistor, T6 is an n-type transistor, and T7 is a p-type transistor, but not limited thereto.

In one embodiment of the pixel circuit shown in FIG. 30, T8 and T9 are oxide thin film transistors, and T0, T10, T11, T12, and T13 may be low-temperature polysilicon thin film transistors, but not limited thereto.

In one embodiment of the pixel circuit shown in FIG. 30, T6 and T7 form a transmission gate-like structure, and the light emitting data voltage and the light emitting control voltage HF provided by DT are respectively connected to the two sides of the transmission gate-like structure, and HF is a high-frequency PWM signal; when T6 is turned off, the light emitting current path between VDD and VSS is controlled by HF, and high-frequency short-time light conduction is performed to achieve high-frequency short-time light emitting; when T6 is turned on, the light emitting current path between VDD and VSS is not controlled by HF, and the cathode of M1 is long time conducted to VSS to achieve long-time light emitting.

In one embodiment of the pixel circuit shown in FIG. 30, T6 is an n-type transistor, T7 is a p-type transistor, and the transmission gate-like is a CMOS structure or a LTPO structure.

The pixel circuit in at least one embodiment of the present disclosure can perform PWM dimming to improve the brightness control capability of low grayscale, in order to solve the problems of poor brightness uniformity and insufficient low grayscale control capability of light emitting elements at low current density.

At least one embodiment of the present disclosure is an LTPO pixel circuit with PWM dimming function, which solves the problem of uneven light emitting brightness under low current density, adopts long-time light emitting of PAM mode under high grayscale, and adopts short-time high-frequency light emitting of PWM mode under low grayscale.

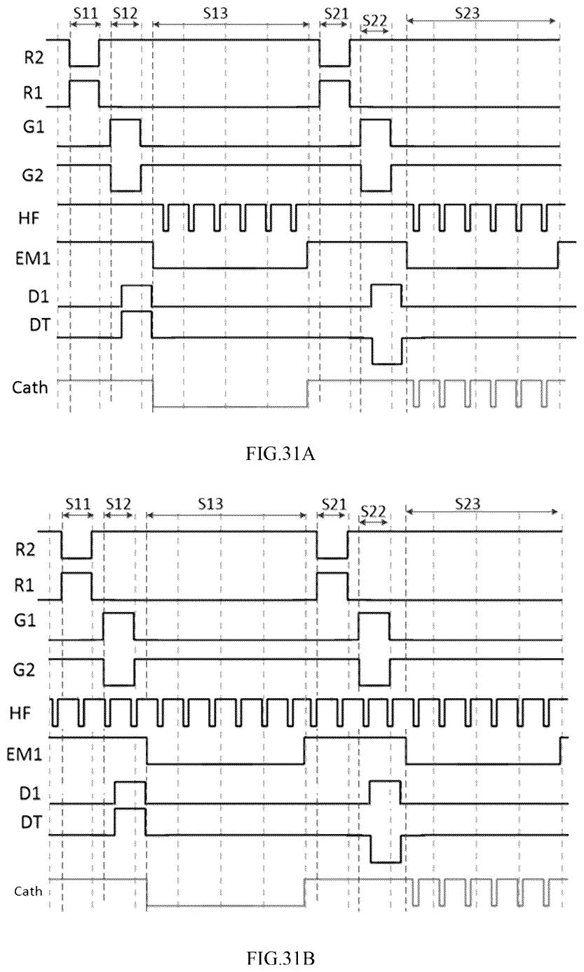

As shown in FIG. 31A, when at least one embodiment of the pixel circuit shown in FIG. 30 of the present disclosure is in operation, the first display period includes a first initialization phase S11, a first data writing-in phase S12, and a first light emitting phase S13 which are successively arranged;
In the first initialization phase S11, R1 provides a high voltage signal, R2 provides a low voltage signal, G1 provides a low voltage signal, G2 provides a high voltage signal, EM1 provides a high voltage signal, T8 and T11 are turned on, and the first initial voltage terminal I1 provides a first initial voltage Vinil to the gate electrode of T0 and the anode of M1, so that when the first data writing-in phase S12 begins, T0 can be turned on and clear the residual charge on the anode of M1;
In the first initialization phase S11, T9 is turned off, T10 is turned off, T12 is turned off, and T13 is turned off;
In the first data writing-in phase S12, R1 provides a low voltage signal, R2 provides a high voltage signal, G1 provides a high voltage signal, G2 provides a low voltage signal, EM1 provides a high voltage signal, D1 provides a data voltage Vdata, DT provides a high voltage signal, and T10 is turned on to write Vdata into the source electrode of T0;
At the beginning of the first data writing-in phase S12, T0 is turned on, T9 is turned on, and C3 is charged by Vdata to change the potential of the gate electrode of T0 until T0 is turned off. The gate potential of T0 is related to the threshold voltage of T0;
In the first data writing-in phase S12, T8 and T11 are turned off, T12 is turned off, T13 is turned off, and T5 is turned on to connect the control DT with ch, the potential of ch is a high voltage, and T6 is turned on;
In the first light emitting phase S13, R1 provides a low voltage signal, R2 provides a high voltage signal, G1 provides a low voltage signal, G2 provides a high voltage signal, EM1 provides a low voltage signal, T12 is turned on, T13 is turned on, C2 maintains the potential of ch at a high voltage, T6 is turned on, T4 is turned on, and T0 drives M1 to emit light, so as to perform PAM long-time light emitting;
The second display period includes a second initialization phase S21, a second data writing-in phase S22, and a second light emitting phase S23 which are arranged successively;
In the second initialization phase S21, R1 provides a high voltage signal, R2 provides a low voltage signal, G1 provides a low voltage signal, G2 provides a high voltage signal, EM1 provides a high voltage signal, T8 and T11 are turned on, and the first initial voltage terminal I1 provides the first initial voltage Vinil to the gate electrode of T0 and the anode of M1, so that when the first data writing-in phase S12 begins, T0 can be turned on and clear the residual charge on the anode of M1;
In the second initialization phase S21, T9 is turned off, T10 is turned off, T12 is turned off, and T13 is turned off;
In the second data writing-in phase S22, R1 provides a low voltage signal, R2 provides a high voltage signal, G1 provides a high voltage signal, G2 provides a low voltage signal, EM1 provides a high voltage signal, D1 provides a data voltage Vdata, DT provides a low voltage signal, and T10 is turned on to write Vdata into the source electrode of T0;
At the beginning of the second data writing-in phase S22, T0 is turned on, T9 is turned on, and C3 is charged by Vdata to change the potential of the gate electrode of T0 until T0 is turned off. The gate potential of T0 is related to the threshold voltage of T0;
In the second data writing-in phase S22, TS and T11 are turned off, T12 is turned off, T13 is turned off, and T5 is turned on to connect the control DT with ch, the potential of ch is a low voltage, and T6 is turned off;
In the second light emitting phase S23, R1 provides a low voltage signal, R2 provides a high voltage signal, G1 provides a low voltage signal, G2 provides a high voltage signal, EM1 provides a low voltage signal, T12 is turned on, T13 is turned on, C1 maintains the potential of ch at a low voltage, T6 is turned off, when the voltage value of HF is a low voltage, T7 is turned on, when T7 is turned on, T0 drives M1 to emit light, so as to perform PWM high-frequency short-time light emitting and perform low grayscale display.

In one embodiment shown in FIG. 31A, HF is provided by a GOA (Gate On Array, a gate driving circuit arranged on an array substrate) circuit. In the light emitting phase, HF is a square wave voltage signal. In the time period other than the light emitting phase included in the display period, HF is a high voltage signal.

The difference between the working timing diagram shown in FIG. 31B and the working timing diagram shown in FIG. 31A is that: during the entire display period, HF is a square wave voltage signal. At this time, HF can be provided by a driver IC (integrated circuit). The driver IC periodically gives a signal. Within one frame of display time, the driver IC will provide a square wave voltage signal for VF.

In FIG. 31A and FIG. 31B, Cath corresponds to the potential of the cathode node Cath.

When the pixel circuit shown in FIG. 30 of the present disclosure is in operation, the voltage value of the first initial voltage Vinil and the voltage value of the low voltage signal provided by VSS may be −2V, the voltage value of the high voltage signal provided by VDD may be 8V, the high voltage value of the first control signal provided by G1 may be 7V, the low voltage value of the first control signal provided by G1 may be −8V, the high voltage value of the first light emitting control signal provided by EM1 may be 7V, the low voltage value of the first light emitting control signal provided by EM1 may be −7V, the high voltage value of the light emitting control voltage HF may be 7V, the low voltage value of the light emitting control voltage HF may be −7V, the voltage value of the data voltage Vdata may be greater than or equal to 4V and less than or equal to 6V, the high voltage value of the light emitting data voltage provided by DT may be 7V, the low voltage value of the light emitting data voltage provided by DT may be −7V, and in the light emitting phase, DT may provide a 0V voltage signal, but is not limited to this.

When one embodiment of the pixel circuit shown in FIG. 30 of the present disclosure is in operation,
In the PWM dimming mode, the potential of ch is kept at a low voltage, and T5 needs a lower turn-off voltage. At this time, the low voltage value of the first control signal provided by G1 can be less than or equal to −8V;

If T7 has a tail, HF needs to select a suitable voltage to prevent the leakage of T7 from causing T7 to turn off poorly and causing nA (nanoampere) level current noise when EM1 provides a low voltage signal during the period of time that HF voltage value is the high voltage in PWM dimming mode.

In at least one embodiment of the pixel circuit shown in FIG. 30 of the present disclosure, in the PWM dimming mode, when the potential of ch is maintained at a low voltage, T5 is not properly turned off, which may easily lead to reverse leakage, causing the potential of ch to decrease, thereby reducing the off ability of T6. Therefore, T5 can use a low-leakage oxide thin-film transistor to be more conducive to maintaining the low potential of ch.

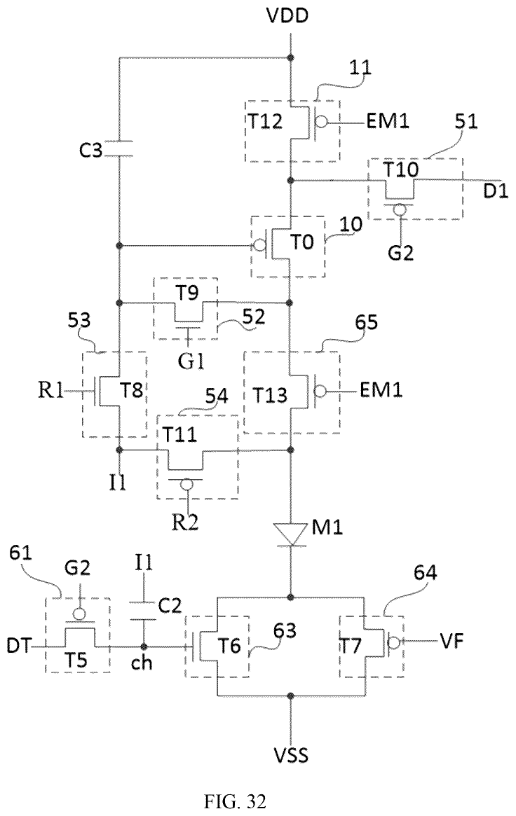

The difference between one embodiment of the pixel circuit shown in FIG. 32 of the present disclosure and at least one embodiment of the pixel circuit shown in FIG. 30 of the present disclosure is that: T5 is a p-type transistor, T5 is a low-temperature polycrystalline silicon thin film transistor; the gate electrode of T5 is electrically connected to the second control terminal G2.

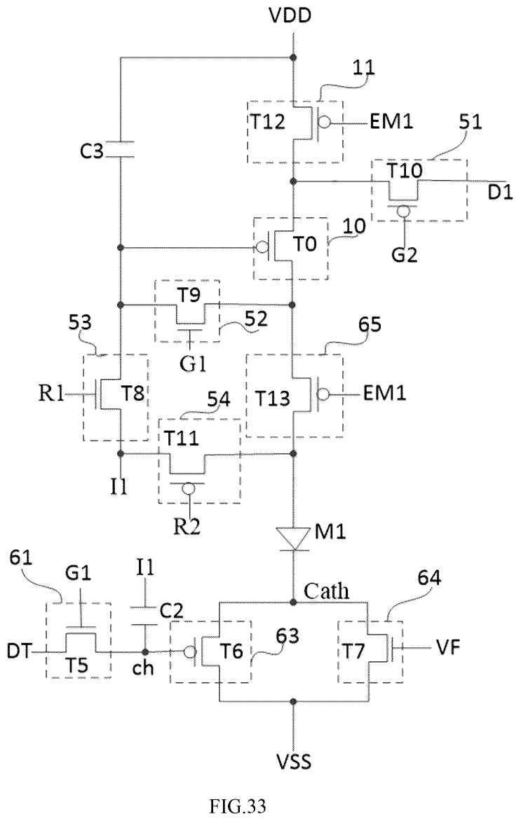

The difference between one embodiment of the pixel circuit shown in FIG. 33 of the present disclosure and at least one embodiment of the pixel circuit shown in FIG. 30 of the present disclosure is that T6 is a p-type transistor and T7 is an n-type transistor.

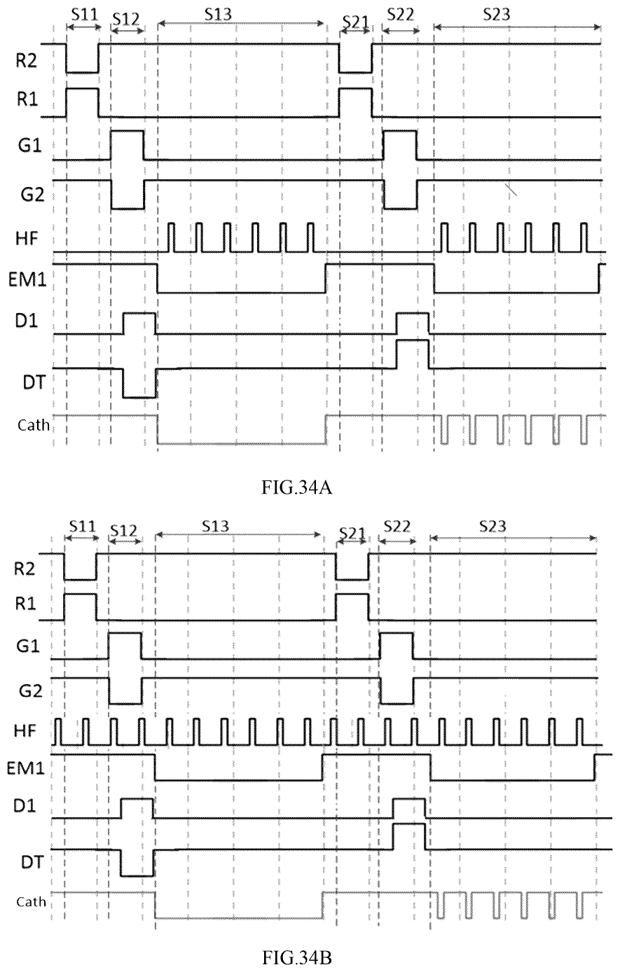

As shown in FIG. 34A, when at least one embodiment of the pixel circuit shown in FIG. 33 of the present disclosure is in operation,

The first display period includes a first initialization phase S11, a first data writing-in phase S12 and a first light emitting phase S13 which are arranged successively;
In the first initialization phase S11, R1 provides a high voltage signal, R2 provides a low voltage signal, G1 provides a low voltage signal, G2 provides a high voltage signal, EM1 provides a high voltage signal, T8 and T11 are turned on, and the first initial voltage terminal I1 provides a first initial voltage Vinil to the gate electrode of T0 and the anode of M1, so that when the first data writing-in phase S12 begins, T0 can be turned on and clear the residual charge on the anode of M1;
In the first initialization phase S11, T9 is turned off, T10 is turned off, T12 is turned off, and T13 is turned off;
In the first data writing-in phase S12, R1 provides a low voltage signal, R2 provides a high voltage signal, G1 provides a high voltage signal, G2 provides a low voltage signal, EM1 provides a high voltage signal, D1 provides a data voltage Vdata, DT provides a low voltage signal, and T10 is turned on to write Vdata into the source electrode of T0;
At the beginning of the first data writing-in phase S12, T0 is turned on, T9 is turned on, and C3 is charged by Vdata to change the potential of the gate electrode of T0 until T0 is turned off. The gate potential of T0 is related to the threshold voltage of T0;
In the first data writing-in phase S12, T8 and T11 are turned off, T12 is turned off, T13 is turned off, and T5 is turned on to connect the control DT with ch, the potential of ch is a low voltage, and T6 is turned on;
In the first light emitting phase S13, R1 provides a low voltage signal, R2 provides a high voltage signal, G1 provides a low voltage signal, G2 provides a high voltage signal, EM1 provides a low voltage signal, T12 is turned on, T13 is turned on, C2 maintains the potential of ch at a low voltage, T6 is turned on, T4 is turned on, and T0 drives M1 to emit light, so as to perform PAM long-time light emitting;
The second display period includes a second initialization phase S21, a second data writing-in phase S22, and a second light emitting phase S23 which are arranged successively;
In the second initialization phase S21, R1 provides a high voltage signal, R2 provides a low voltage signal, G1 provides a low voltage signal, G2 provides a high voltage signal, EM1 provides a high voltage signal, TS and T11 are turned on, and the first initial voltage terminal I1 provides the first initial voltage Vinil to the gate electrode of T0 and the anode of M1, so that when the first data writing-in phase $12 begins, T0 can be turned on and clear the residual charge on the anode of M1:
In the second initialization phase S21, T9 is turned off, T10 is turned off, T12 is turned off, and T13 is turned off;
In the second data writing-in phase S22, R1 provides a low voltage signal, R2 provides a high voltage signal, G1 provides a high voltage signal, G2 provides a low voltage signal, EM1 provides a high voltage signal, D1 provides a data voltage Vdata, DT provides a high voltage signal, and T10 is turned on to write Vdata into the source electrode of T0;
At the beginning of the second data writing-in phase S22, T0 is turned on. T9 is turned on, and C3 is charged by Vdata to change the potential of the gate electrode of T0 until T0 is turned off. The gate potential of T0 is related to the threshold voltage of T0;
In the second data writing-in phase S22, TS and T11 are turned off, T12 is turned off, T13 is turned off, and TS is turned on to connect the control DT to ch, the potential of ch is a high voltage, and T6 is turned off;
In the second light emitting phase S23, R1 provides a low voltage signal, R2 provides a high voltage signal, G1 provides a low voltage signal, G2 provides a high voltage signal, EM1 provides a low voltage signal, T12 is turned on, T13 is turned on, C1 maintains the potential of ch at a high voltage, T6 is turned off, when the voltage value of HF is a low voltage, T7 is turned on, when T7 is turned on, T0 drives M1 to emit light, so as to perform PWM high-frequency short-time light emitting and perform low grayscale display.

In one embodiment shown in FIG. 34A, HF is provided by a GOA (Gate On Array, a gate driving circuit arranged on an array substrate) circuit. In the light emitting phase, HF is a square wave voltage signal. In the time period other than the light emitting phase included in the display period, HF is a low voltage signal.

The difference between the working timing diagram shown in FIG. 34B and the working timing diagram shown in FIG. 34A is that: during the entire display period, HF is a square wave voltage signal. At this time, HF can be provided by a driver IC (integrated circuit). The driver IC periodically gives a signal. Within one frame of display time, the driver IC will provide a square wave voltage signal for VF.

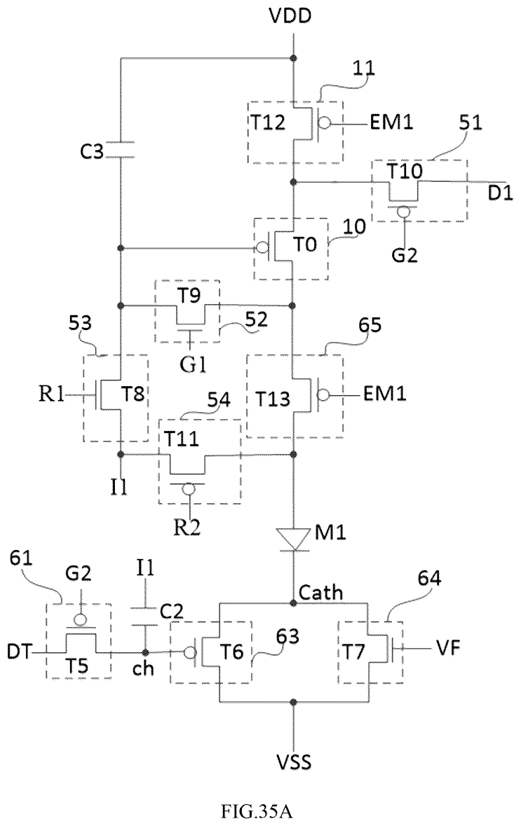

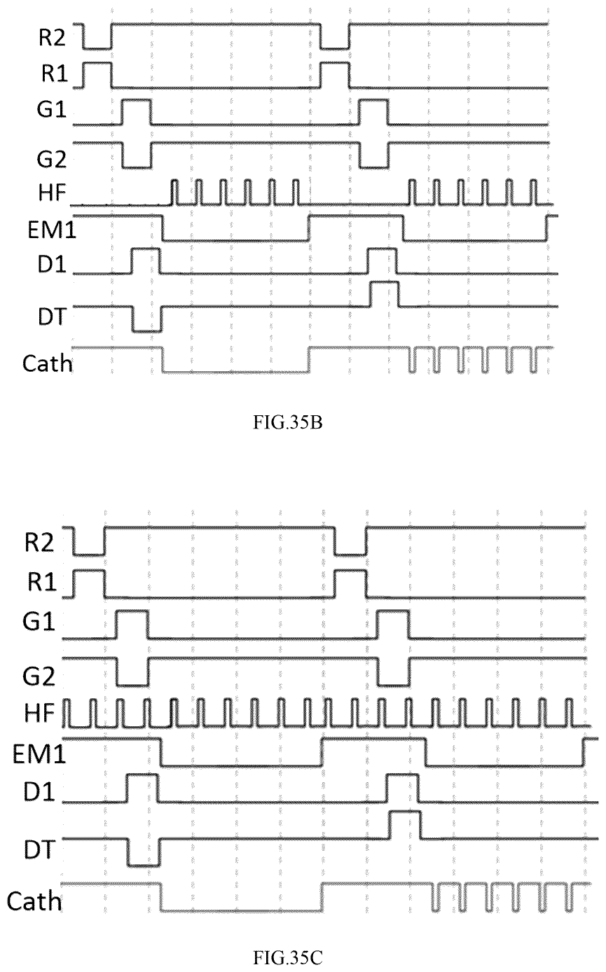

The difference between one embodiment of the pixel circuit shown in FIG. 35A of the present disclosure and at least one embodiment of the pixel circuit shown in FIG. 33 of the present disclosure is that: T5 is a p-type transistor; and the gate electrode of T5 is electrically connected to the second control terminal G2.

In FIG. 35A, the node labeled Cath is a cathode node, and the cathode node Cath is electrically connected to the cathode of M1.

FIG. 35B is a timing diagram of the pixel circuit shown in FIG. 35A of the present disclosure;

FIG. 35C is a timing diagram of the pixel circuit shown in FIG. 35A of the present disclosure.

In one embodiment shown in FIG. 35B, HF is provided by a GOA (Gate On Array, a gate driving circuit arranged on an array substrate) circuit. In the light emitting phase, HF is a square wave voltage signal. In the time period other than the light emitting phase included in the display period, HF is a low voltage signal.

The difference between the working timing diagram shown in FIG. 35C and the working timing diagram shown in FIG. 35B is that: during the entire display period, HF is a square wave voltage signal. At this time, HF can be provided by a driver IC (integrated circuit). The driver IC periodically gives a signal. Within one frame of display time, the driver IC will provide a square wave voltage signal for VF.

In one embodiment of the pixel circuit shown in FIG. 30, FIG. 32, FIG. 33, and FIG. 35A of the present disclosure, D1 and DT may be shared, and the gate electrode of T0 and the gating control terminal ch may be charged successively by the second control signal and the first control signal which are turned on successively.

In one embodiment of the pixel circuit shown in FIGS. 30, 32, 33, and 35A of the present disclosure, when the type of T5 is the same as the type of T10, that is, when T5 and T10 are both p-type transistors or both n-type transistors, the control signal connected to the gate electrode of T5 and the control signal connected to the gate electrode of T10 can be shared, and the gate electrode of T0 and the gating control terminal ch are charged simultaneously by different data voltages and light emitting data voltages.

In at least one embodiment of the present disclosure, C2 may not be provided. If the leakage of T5 is small and the voltage stability of the gating control terminal ch can meet the gate on/off state of T6, C2 may be removed.

In one embodiment of the pixel circuit shown in FIGS. 30, 32, 33, and 35A of the present disclosure, T8 can be replaced by a p-type transistor, T9 can be replaced by a p-type transistor, and T10 can be replaced by an n-type transistor, but is not limited thereto.

In one embodiment of the pixel circuit shown in FIGS. 30, 32, 33, and 35A of the present disclosure, T8 and T9 can be dual-gate transistors. In this case, T8 and T9 can be oxide thin film transistors, or T8 and T9 can be low-temperature polysilicon thin film transistors.

In one embodiment of the pixel circuit shown in FIGS. 30, 32, 33, and 35A of the present disclosure, since T6 and T7 are on the light emitting current path, the channel width of T6 and the channel width of T7 can be appropriately increased. For example, the channel width of T6 and the channel width of T7 can be greater than or equal to 5 um and less than or equal to 10 um, but not limited to this.

In at least one embodiment of the present disclosure, when T7 is a p-type transistor, T6 is an n-type transistor, and T5 is an n-type transistor, the voltage value of the low voltage signal provided by the first initial voltage Vinil and VSS can be −2V, the voltage value of the high voltage signal provided by VDD can be 8V, the high voltage value of the first control signal provided by G1 can be 7V, and the low voltage value of the first control signal provided by G1 can be −8V; the high voltage value of the first light emitting control signal provided by EM1 can be 7V, and the low voltage value of the first light emitting control signal provided by EM1 can be −7V, the high voltage value of HF can be 7V, and the low voltage value of HF can be −7V, the voltage value of the data voltage provided by D1 can be greater than or equal to 4V and less than or equal to 6V, the high voltage value of the light emitting data voltage provided by DT can be 7V, and the low voltage value of the light emitting data voltage provided by DT can be −7V. In the light emitting phase, DT can provide a OV voltage signal, but is not limited to this.

In at least one embodiment of the present disclosure, when T7 is an n-type transistor, T6 is a p-type transistor, and T5 is an n-type transistor, the voltage value of the low voltage signal provided by the first initial voltage Vini1 and VSS can be −2V, the voltage value of the high voltage signal provided by VDD can be 8V, the high voltage value of the first control signal provided by G1 can be 7V, and the low voltage value of the first control signal provided by G1 can be −8V; the high voltage value of the first light emitting control signal provided by EM1 can be 7V, and the low voltage value of the first light emitting control signal provided by EM1 can be −7V, the high voltage value of HF can be 7V, and the low voltage value of HF can be −7V, the voltage value of the data voltage provided by D1 can be greater than or equal to 4V and less than or equal to 6V, the high voltage value of the light emitting data voltage provided by DT can be 7V, and the low voltage value of the light emitting data voltage provided by DT can be −7V. In the light emitting phase, DT can provide a 0V voltage signal, but is not limited to this.

In at least one embodiment of the present disclosure, when T7 is a p-type transistor, T6 is an n-type transistor, and T5 is a p-type transistor, the voltage value of the low voltage signal provided by the first initial voltage Vinil and VSS can be −2V, the voltage value of the high voltage signal provided by VDD can be 8V, the high voltage value of the first control signal provided by G1 can be 8V, and the low voltage value of the first control signal provided by G1 can be −8V; the high voltage value of the first light emitting control signal provided by EM1 can be 7V, and the low voltage value of the first light emitting control signal provided by EM1 can be −7V, the high voltage value of HF can be 7V, and the low voltage value of HF can be −7V, the voltage value of the data voltage provided by D1 can be greater than or equal to 4V and less than or equal to 6V, the high voltage value of the light emitting data voltage provided by DT can be 7V, and the low voltage value of the light emitting data voltage provided by DT can be −7V. In the light emitting phase, DT can provide a 0V voltage signal, but is not limited to this.

In at least one embodiment of the present disclosure, when T7 is an n-type transistor, T6 is a p-type transistor, and T5 is a p-type transistor, the voltage value of the low voltage signal provided by the first initial voltage Vini1 and VSS can be −2V, the voltage value of the high voltage signal provided by VDD can be 8V, the high voltage value of the first control signal provided by G1 can be 8V, and the low voltage value of the first control signal provided by G1 can be −8V; the high voltage value of the first light emitting control signal provided by EM1 can be 7V, and the low voltage value of the first light emitting control signal provided by EM1 can be −7V, the high voltage value of HF can be 7V, and the low voltage value of HF can be −7V, the voltage value of the data voltage provided by D1 can be greater than or equal to 4V and less than or equal to 6V, the high voltage value of the light emitting data voltage provided by DT can be 7V, and the low voltage value of the light emitting data voltage provided by DT can be −7V. In the light emitting phase, DT can provide a 0V voltage signal, but is not limited to this.

In specific implementation, when the light emitting data voltage provided by DT needs to be positive,

When T7 is a p-type transistor, T6 is an n-type transistor, and T5 is an n-type transistor, the voltage value of the low voltage signal provided by the first initial voltage Vini1 and VSS can be −2V, the voltage value of the high voltage signal provided by VDD can be 8V, the high voltage value of the first control signal provided by G1 can be 14V, and the low voltage value of the first control signal provided by G1 can be −1V; the high voltage value of the first light emitting control signal provided by EM1 can be 7V, and the low voltage value of the first light emitting control signal provided by EM1 can be −7V, the high voltage value of HF can be 7V, and the low voltage value of HF can be −7V, the voltage value of the data voltage provided by D1 can be greater than or equal to 4V and less than or equal to 6V, the high voltage value of the light emitting data voltage provided by DT can be 14V, and the low voltage value of the light emitting data voltage provided by DT can be 0V, but is not limited to this.

In specific implementation, when the light emitting data voltage provided by DT needs to be positive,

When T7 is an n-type transistor, T6 is a p-type transistor, and T5 is an n-type transistor, the voltage value of the low voltage signal provided by the first initial voltage Vini1 and VSS can be −2V, the voltage value of the high voltage signal provided by VDD can be 8V, the high voltage value of the first control signal provided by G1 can be 14V, and the low voltage value of the first control signal provided by G1 can be −1V; the high voltage value of the first light emitting control signal provided by EM1 can be 7V, and the low voltage value of the first light emitting control signal provided by EM1 can be −7V, the high voltage value of HF can be 7V, and the low voltage value of HF can be −7V, the voltage value of the data voltage provided by D1 can be greater than or equal to 4V and less than or equal to 6V, the high voltage value of the light emitting data voltage provided by DT can be 14V, and the low voltage value of the light emitting data voltage provided by DT can be 0V, but is not limited to this.

In specific implementation, when the light emitting data voltage provided by DT needs to be positive,

When T7 is a p-type transistor, T6 is an n-type transistor, and T5 is a p-type transistor, the voltage value of the low voltage signal provided by the first initial voltage Vini1 and VSS can be −2V, the voltage value of the high voltage signal provided by VDD can be 8V, the high voltage value of the first control signal provided by G1 can be 15V, and the low voltage value of the first control signal provided by G1 can be −1V; the high voltage value of the first light emitting control signal provided by EM1 can be 7V, and the low voltage value of the first light emitting control signal provided by EM1 can be −7V, the high voltage value of HF can be 7V, and the low voltage value of HF can be −7V, the voltage value of the data voltage provided by D1 can be greater than or equal to 4V and less than or equal to 6V, the high voltage value of the light emitting data voltage provided by DT can be 14V, and the low voltage value of the light emitting data voltage provided by DT can be 0V, but is not limited to this.

In specific implementation, when the light emitting data voltage provided by DT needs to be positive, When T7 is an n-type transistor, T6 is a p-type transistor, and T5 is a p-type transistor, the voltage value of the low voltage signal provided by the first initial voltage Vini1 and VSS can be −2V, the voltage value of the high voltage signal provided by VDD can be 8V, the high voltage value of the first control signal provided by G1 can be 15V, and the low voltage value of the first control signal provided by G1 can be −1V; the high voltage value of the first light emitting control signal provided by EM1 can be 7V, and the low voltage value of the first light emitting control signal provided by EM1 can be −7V, the high voltage value of HF can be 7V, and the low voltage value of HF can be −7V, the voltage value of the data voltage provided by D1 can be greater than or equal to 4V and less than or equal to 6V, the high voltage value of the light emitting data voltage provided by DT can be 14V, and the low voltage value of the light emitting data voltage provided by DT can be 0V, but is not limited to this.

In at least one embodiment of the present disclosure, when T7 is a p-type transistor, T6 is an n-type transistor, and T5 is an n-type transistor,

In the PWM dimming mode, during the low voltage maintenance phase of ch, T5 requires a lower turn-off voltage, so the low voltage value of the first control signal provided by G1 needs to be lowered.

In at least one embodiment of the present disclosure, when T7 is an n-type transistor, T6 is a p-type transistor, and T5 is an n-type transistor,

In the PAM dimming mode, when the potential of ch is kept at a high voltage, the high voltage value of the first control signal provided by G1 is required to be greater than or equal to 8V;

In PWM dimming mode, when the potential of the first control signal provided by G1 is low voltage, T5 is turned on, and the light emitting data voltage provided by DT performs low voltage charging on ch, which requires that the low voltage value of the first control signal provided by G1 is less than or equal to −8V.

In at least one embodiment of the present disclosure, when T7 is a p-type transistor, T6 is an n-type transistor, and TS is a p-type transistor,

In the PAM dimming mode, during the low voltage maintenance phase of ch, the potential of the first control signal provided by G1 needs to be low to ensure the morning-off capability of T5.

In at least one embodiment of the present disclosure, when T7 is an n-type transistor, T6 is a p-type transistor, and T5 is a p-type transistor,

In the PAM dimming mode, during the low voltage maintenance phase of ch, the potential of the first control signal provided by G1 needs to be low to ensure the turning-off capability of T5.

The pixel driving method according to at least one embodiment of the present disclosure is applied to the above-mentioned pixel circuit, and the pixel driving method includes:
In the light emitting phase, controlling, by the first light emitting control circuit, the first voltage terminal to be connected to the first terminal of the driving circuit under the control of the first light emitting control signal;
Controlling, by the light emitting gating circuit, under the control of the first control signal, according to the light emitting data voltage, during the light emitting phase and under the control of the light emitting control voltage provided by the light emitting control voltage terminal, to generate a current path between the second terminal of the driving circuit and the light emitting element, so as to control the driving circuit to control the light emitting element to emit light, or to generate a current path between the second terminal of the driving circuit and the light emitting element during the light emitting phase, so as to control the driving circuit to control the light emitting element to emit light.

In at least one embodiment of the present disclosure, the light emitting gating circuit includes a second light emitting control circuit and a first gating control circuit; and the pixel driving method includes:
Writing, by the first gating control circuit, under the control of the first control signal, the light emitting data voltage into the gating control terminal, and, under the control of the potential of the gating control terminal, controlling the second light emitting control terminal to be connected to the light emitting control voltage terminal, or controlling the second light emitting control terminal to be connected to the first light emitting control terminal;
Controlling, by the second light emitting control circuit, the connection between the second terminal of the driving circuit and the first electrode of the light emitting element under the control of the potential of the second light emitting control terminal.

In at least one embodiment of the present disclosure, the light emitting gating circuit includes a second gating control circuit, a third light emitting control circuit and a fourth light emitting control circuit; and the pixel driving method includes:
Writing, by the second gating control circuit, the light emitting control voltage into the gating control terminal under the control of the first control signal;
Controlling, by the third light emitting control circuit, the second electrode of the light emitting element to be connected to the second voltage terminal under the control of the potential of the gating control terminal;
Controlling, by the fourth light emitting control circuit, the second electrode of the light emitting element to be connected to the second voltage terminal under the control of the light emitting control voltage.

In the related art, when the light emitting element is a mini light emitting diode or a micro light emitting diode, when the current density of the light emitting element is higher, the brightness uniformity of the light emitting element is better, and when the current density of the light emitting element is lower, the brightness uniformity of the light emitting element is worse.

In at least one embodiment of the present disclosure, PWM dimming can be used when performing high grayscale display and low grayscale display to control the light emitting current flowing through the light emitting element to be larger. For example, the light emitting element can be operated at a specific high current density (15000 mA/cm²) to optimize the light emitting efficiency of the light emitting element, and the light emitting brightness can be adjusted by controlling the light emitting time of the light emitting element.

The pixel driving method according to the present disclosure is applied to the above-mentioned pixel circuit, and the display period includes a first phase and a light emitting phase which are arranged successively; the pixel driving method includes:
In the first phase, writing, by the light emitting gating circuit, the light emitting data voltage provided by the light emitting data voltage terminal under the control of the first control signal; controlling, by the first light emitting control circuit, the first voltage terminal to be disconnected from the first terminal of the driving circuit under the control of the first light emitting control signal;
In the light emitting phase, controlling, by the first light emitting control circuit, the first voltage terminal to be connected to the first terminal of the driving circuit under the control of the first light emitting control signal;
In the light emitting phase, controlling, by the light emitting gating circuit, the generation of a current path between the second terminal of the driving circuit and the light emitting element according to the light emitting data voltage and under the control of the light emitting control voltage provided by the light emitting control voltage terminal, so as to control the driving circuit to control the light emitting element to emit light, or controlling, by the light emitting gating circuit, the generation of a current path between the second terminal of the driving circuit and the light emitting element under the control of the first light emitting control signal, so as to control the driving circuit to control the light emitting element to emit light.

Optionally, the first phase may be a data writing-in phase or an initialization phase.

In a specific implementation, the display period may include a first phase and a light emitting phase which are arranged in sequence. In the first phase, the first light emitting control circuit, under the control of a first light emitting control signal, controls the first voltage terminal to be disconnected from the first terminal of the driving circuit, and the light emitting gating circuit writes the light emitting data voltage. In the light emitting phase, the light emitting gating circuit, according to the light emitting data voltage and under the control of the light emitting control voltage, controls the generation of a current path between the second terminal of the driving circuit and the light emitting element, or the light emitting gating circuit, under the control of the first light emitting control signal, controls the generation of a current path between the second terminal of the driving circuit and the light emitting element.

In at least one embodiment of the present disclosure, in the light emitting phase, both the first light emitting control signal and the light emitting control voltage are square wave voltage signals.

In a specific implementation, in the light emitting phase, the duty ratio of the first light emitting control signal may be greater than the duty ratio of the light emitting control voltage.

In at least one embodiment of the present disclosure, when low grayscale display is required, in the light emitting phase, the first light emitting control circuit controls the first voltage terminal to be connected to the first terminal of the driving circuit under the control of the first light emitting control signal; the light emitting gating circuit controls the generation of a current path between the second terminal of the driving circuit and the light emitting element under the control of the light emitting control voltage provided by the light emitting control voltage terminal according to the light emitting data voltage, so as to control the driving circuit to control the light emitting element to emit light;
When high grayscale display is required, in the light emitting phase, under the control of the first light emitting control signal, the first voltage terminal is controlled to be connected to the first terminal of the driving circuit; the light emitting gating circuit is controlled to generate a current path between the second terminal of the driving circuit and the light emitting element under the control of the first light emitting control signal, so as to control the driving circuit to control the light emitting element to emit light.

When the pixel circuit in at least one embodiment of the present disclosure is in operation, when performing low grayscale display and high grayscale display, in the light emitting phase,
When the first light emitting control signal is a valid voltage signal, the first light emitting control circuit controls the first voltage terminal to be connected to the first terminal of the driving circuit;
When the first light emitting control signal is a valid voltage signal, the first light emitting control circuit controls the first voltage terminal to be disconnected from the first terminal of the driving circuit.

In at least one embodiment of the present disclosure, the light emitting gating circuit includes a second light emitting control circuit and a first gating control circuit; the pixel driving method includes: in a first display mode,
In the first phase, the first gating control circuit writes the light emitting data voltage into the gating control terminal under the control of the first control signal, and the first gating control circuit controls the second light emitting control terminal to be connected to the first light emitting control terminal under the control of the potential of the gating control terminal;
In the light emitting phase, when the first light emitting control signal is a valid voltage signal, the first light emitting control circuit controls the connection between the first voltage terminal and the first terminal of the driving circuit under the control of the first light emitting control signal, and the second light emitting control circuit controls the connection between the second terminal of the driving circuit and the first electrode of the light emitting element under the control of the first light emitting control signal, and the driving circuit drives the light emitting element to emit light.

In a specific implementation, the first display mode may be a high grayscale display mode, in which case, in the first phase, the first gating control circuit controls the second light emitting control terminal to be connected to the first light emitting control terminal; in the light emitting phase, when the first light emitting control signal is a valid voltage signal, the first light emitting control circuit controls the first voltage terminal to be connected to the first terminal of the driving circuit, the second light emitting control circuit controls the second terminal of the driving circuit to be connected to the first electrode of the light emitting element, and the driving circuit drives the light emitting element to emit light;
In the light emitting phase, when the first light emitting control signal is an invalid voltage signal, the first light emitting control circuit controls the first voltage terminal to be disconnected from the first terminal of the driving circuit, and the second light emitting control circuit controls the second terminal of the driving circuit to be disconnected from the first electrode of the light emitting element, and the light emitting element does not emit light.

In at least one embodiment of the present disclosure, the light emitting gating circuit includes a second light emitting control circuit and a first gating control circuit; the pixel driving method includes: in a second display mode,

In the first phase, the first gating control circuit writes the light emitting data voltage into the gating control terminal under the control of the first control signal, and the first gating control circuit controls the connection between the second light emitting control terminal and the light emitting control voltage terminal under the control of the potential of the gating control terminal;
In the light emitting phase, when the first light emitting control signal is a valid voltage signal, the first light emitting control circuit controls the first voltage terminal to be connected to the first terminal of the driving circuit under the control of the first light emitting control signal;
In the light emitting phase, when the light emitting control voltage is a valid voltage, the second light emitting control circuit, under the control of the first light emitting control signal, controls the second terminal of the driving circuit to be connected to the first electrode of the light emitting element, and the driving circuit drives the light emitting element to emit light; when the light emitting control voltage is an invalid voltage, the second light emitting control circuit, under the control of the first light emitting control signal, controls the second terminal of the driving circuit to be disconnected from the first electrode of the light emitting element.

In a specific implementation, the second display mode may be a low grayscale display mode, in which the duty ratio of the first light emitting control signal is relatively large, and the duty ratio of the light emitting control voltage is relatively small.

The pixel circuit in one embodiment of the pixel circuit shown in FIG. 7A of the present disclosure is in operation.

When high grayscale display is performed, in the first phase, EM1 provides a high voltage signal, DT provides a high voltage signal, T1 is turned on, the potential of Ch is a high voltage, T3 is turned on, and EM1 and EM2 are connected; in the light emitting phase, EM1 provides a square wave voltage signal with a large duty ratio, when EM1 provides a low voltage signal, T0 drives M1 to emit light; when EM1 provides a high voltage signal, M1 does not emit light;
When performing low grayscale display, in the first phase, EM1 provides a high voltage signal, DT provides a low voltage signal, T2 is turned on, and the light emitting control voltage HF provided by VF is written into EM2; in the light emitting phase, EM1 provides a square wave voltage signal with a large duty ratio, and the light emitting control voltage HF is a square wave signal with a small duty ratio.

In specific implementation, the duty ratio of the first light control signal and the duty ratio of the light control voltage HF can be calculated according to the required brightness, so that the light emitting element can operate at a specific high current density, for example, the current density can be 15000 mA/cm²;

If the required brightness is 29 wnit (290,000 nits), according to the LED (light emitting diode) display color scheme, the required green backplane brightness is 18.9 wnit. By calculation, when the PPI (pixel density) of the display panel is 500, the duty ratio of the first light emitting control signal provided by EM1 can be 38.7;

When performing low grayscale display, according to the requirement that the frequency of the light emitting control voltage HF needs to be greater than or equal to 2000 Hz during healthy display, in the test, the optimal duty ratio of HF obtained can be 1%; therefore, in at least one embodiment of the present disclosure, the duty ratio of the light emitting control voltage HF can be set to 1%, but is not limited to this.

According to a specific implementation, the frequency of the first light emitting control signal is less than the frequency of the light emitting control voltage;

In the display period, the time length during which the potential of the first light emitting control signal continues to be an invalid voltage is shorter than the time length during which the light emitting control voltage continues to be an invalid voltage.

In a specific implementation, the frequency of the first light emitting control signal may be lower than the frequency of the light emitting control voltage. During the display period, the time length of the first light emitting control signal being an invalid voltage may be smaller than the time length of the light emitting control voltage being an invalid voltage.

Optionally, a pixel density of a display panel in which the pixel circuit is included is less than a pixel density threshold.

In one embodiment of the pixel circuit shown in FIG. 7A, since both T5 and T6 are p-type transistors, the effective voltage can be a low voltage and the invalid voltage can be a high voltage. In a specific implementation, when T5 and T6 are n-type transistors, the valid voltage can be a high voltage and the invalid voltage can be a low voltage.

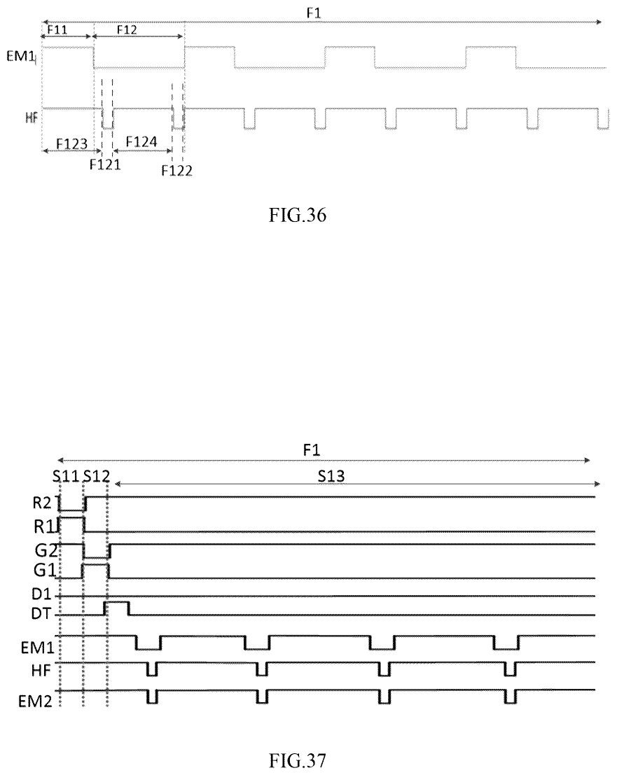

FIG. 36 is a waveform diagram of a first light emitting control signal provided by EM1 and a waveform diagram of a light emitting control voltage HF when the pixel circuit shown in FIG. 7A performs low grayscale display.

As shown in FIG. 36, the one labeled F1 is the first display period;
The one labeled F11 is a time period during which the potential of the first light emitting control signal provided by the first EM1 included in the first display period continues to be an invalid voltage (high voltage);
The one labeled F12 is a time period during which the potential of the first light emitting control signal provided by the first EM1 included in the first display period continues to be a valid voltage (low voltage);
F121 is a time period during which the first light emitting control voltage HF included in the first display period F1 continues to be a valid voltage (low voltage);
F122 is a time period during which the second light emitting control voltage HF included in the first display period F1 continues to be a valid voltage (low voltage);
F123 is a time period during which the first light emitting control voltage HF included in the first display period F1 continues to be an invalid voltage (high voltage);
F124 is a time period during which the second light emitting control voltage HF included in the first display period F1 continues to be an invalid voltage (high voltage).

As shown in FIG. 36, the duration of F11 is less than the duration of F123, and the duration of F11 is less than the duration of F124, that is, in the first display period F1, the duration of the first light emitting control signal being a high voltage needs to be less than the duration of the light emitting control voltage being a high voltage. Therefore, after calculation, when the frequency of the first light emitting control signal is less than the frequency of the light emitting control voltage, the pixel density of the display panel in which the pixel circuit is included needs to be less than or equal to the pixel density threshold, for example, the pixel density threshold may be 300, but is not limited thereto.

In at least one embodiment of the present disclosure, a frequency of the light emitting control voltage is greater than or equal to twice a frequency of the first light emitting control signal.

In one embodiment shown in FIG. 36, in order to ensure that the potential of the light emitting control voltage HF is a high voltage in F11, the frequency of the light emitting control voltage HF needs to be set to be greater than or equal to twice the frequency of the first light emitting control signal. For example, the frequency of the light emitting control voltage HF may be 2040, and the frequency of the first light emitting control signal may be 1020, but not limited thereto. In at least one embodiment of the present disclosure, during the display period, the time length during which the potential of the first light emitting control signal continues to be a valid voltage is greater than 2×t1+t2;

Wherein, t1 is the time during which the light emitting control voltage continues to be a valid voltage, and t2 is the time during which the light emitting control voltage continues to be an invalid voltage.

In one embodiment shown in FIG. 36, the time duration during which the potential of the first light emitting control signal continues to be the valid voltage (low voltage) is the time duration of F12;
t1 is the duration of F122, t2 is the duration of F123;

As shown in FIG. 36, the duration of F12 is greater than the sum of the duration of F122 and twice the duration of F123, that is, the duration of F2 is greater than 2×t1+t2. In a specific implementation, when the waveform of the first light-emitting control signal and the waveform of the light emitting control voltage as shown in FIG. 36 are adopted, the duty ratio of the first light emitting control signal may be 59.78%, the duty ratio of the light emitting control voltage HF may be 1%, the frequency of the first light emitting control signal may be 1020, the frequency of the light emitting control voltage HF may be 2040, the duration of the light emitting control voltage HF being a low voltage may be 4.9 μs, the duration of the potential of the first light emitting control signal being a high voltage may be 394.27 μs, and the duration of the light emitting control voltage HF being a high voltage may be 485.29 μs.

According to another specific embodiment, the frequency of the first light emitting control signal is equal to the frequency of the light emitting control voltage;
In the display period, the time duration during which the potential of the first light emitting control signal continues to be an invalid voltage is shorter than the time duration during which the light emitting control voltage continues to be an invalid voltage.

In a specific implementation, the frequency of the first light emitting control signal can be set to be equal to the frequency of the light emitting control voltage, so as to ensure that the light emitting control voltage is an invalid voltage during the time period when the potential of the first light emitting control signal is an invalid voltage.

Optionally, a pixel density of a display panel in which the pixel circuit is included is greater than a pixel density threshold.

In specific implementation, when the pixel density of the display panel is relatively large, the frequency of the first light emitting control signal may be set to be equal to the frequency of the light emitting control voltage. For example, the pixel density threshold may be 300, but is not limited thereto. In actual operation, when the pixel density of the display panel is relatively small, the technical solution that the frequency of the first light emitting control signal is equal to the frequency of the light emitting control voltage may also be applied.

FIG. 37 is a timing diagram of the pixel circuit shown in FIG. 10 when performing low grayscale display.

In FIG. 37, the first display period is labeled F1, the first initialization phase is labeled S11, the first data writing-in phase is labeled S12, and the first light emitting phase is labeled S13;
In the first initialization phase S11 and the first data writing-in phase S12, EM1 provides a high voltage signal;
In the first light emitting phase S13, the first light emitting control signal provided by EM1 is a square wave voltage signal with a large duty ratio, the light emitting control voltage HF is a square wave voltage signal with a small duty ratio, the frequency of the first light emitting control signal is equal to the frequency of the light emitting control voltage HF, and the length of time that the potential of the first light emitting control signal continues to be an invalid voltage (high voltage) is less than the length of time that the light emitting control voltage HF continues to be an invalid voltage (high voltage).

When the pixel circuit in one embodiment of the pixel circuit shown in FIG. 10 of the present disclosure is in operation, during a display period, the frequency of the first light emitting control signal is set to be equal to the frequency of the light emitting control voltage; during the display period,
When the PPI of the display panel is 400, the duty ratio of the first light emitting control signal may be 33.63%, the duty ratio of the light emitting control voltage HF may be 1%, the frequency of the first light emitting control signal and the frequency of the light emitting control voltage HF may be 2040 Hz, the time length of the light emitting control voltage HF being a low voltage may be 4.9 μs, the time length of the potential of the first light emitting control signal being a high voltage may be 325.35 μs, and the time length of the light emitting control voltage HF being a high voltage may be 485.29 μs;
When the PPI of the display panel is 500, the duty ratio of the first light emitting control signal may be 21.52%, the duty ratio of the light emitting control voltage HF may be 1%, the frequency of the first light emitting control signal and the frequency of the light emitting control voltage HF may be 2040 Hz, the time length of the light emitting control voltage HF being a low voltage may be 4.9 μs, the time length of the potential of the first light emitting control signal being a high voltage may be 384.69 μs, and the time length of the light emitting control voltage HF being a high voltage may be 485.29 μs;
When the PPI of the display panel is 600, the duty ratio of the first light emitting control signal may be 14.95%, the duty ratio of the light emitting control voltage HF may be 1%, the frequency of the first light emitting control signal and the frequency of the light emitting control voltage HF may be 2040 Hz, the time length of the light emitting control voltage HF being a low voltage may be 4.9 μs, the time length of the potential of the first light emitting control signal being a high voltage may be 416.93 μs, and the time length of the light emitting control voltage HF being a high voltage may be 485.29 μs;
When the PPI of the display panel is 700, the duty ratio of the first light emitting control signal may be 10.98%, the duty ratio of the light emitting control voltage HF may be 1%, the frequency of the first light emitting control signal and the frequency of the light emitting control voltage HF may be 2040 Hz, the time length of the light emitting control voltage HF being a low voltage may be 4.9 μs, the time length of the potential of the first light emitting control signal being a high voltage may be 436.37 μs, and the time length of the light emitting control voltage HF being a high voltage may be 485.29 μs;
When the PPI of the display panel is 800, the duty ratio of the first light emitting control signal may be 8.41%, the duty ratio of the light emitting control voltage HF may be 1%, the frequency of the first light emitting control signal and the frequency of the light emitting control voltage HF may be 2040 Hz, the time length of the light emitting control voltage HF being a low voltage may be 4.9 μs, the time length of the potential of the first light emitting control signal being a high voltage may be 448.98 μs, and the time length of the light emitting control voltage HF being a high voltage may be 485.29 μs;
When the PPI of the display panel is 900, the duty ratio of the first light emitting control signal may be 6.64%, the duty ratio of the light emitting control voltage HF may be 1%, the frequency of the first light emitting control signal and the frequency of the light emitting control voltage HF may be 2040 Hz, the time length of the light emitting control voltage HF being a low voltage may be 4.9 μs, the time length of the potential of the first light emitting control signal being a high voltage may be 457.63 μs, and the time length of the light emitting control voltage HF being a high voltage may be 485.29 μs;
When the PPI of the display panel is 1000, the duty ratio of the first light emitting control signal may be 5.38%, the duty ratio of the light emitting control voltage HF may be 1%, the frequency of the first light emitting control signal and the frequency of the light emitting control voltage HF may be 2040 Hz, the time length that the light emitting control voltage HF continues to be a low voltage may be 4.9 μs, the time length that the potential of the first light emitting control signal continues to be a high voltage may be 463.82 μs, and the time length that the light emitting control voltage HF continues to be a high voltage may be 485.29 μs.

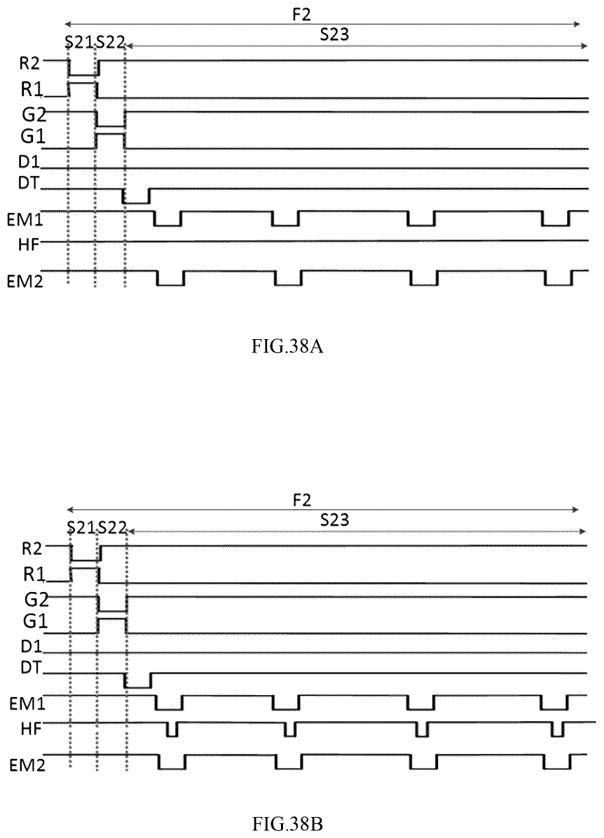

FIG. 38A is a timing diagram of the pixel circuit shown in FIG. 10 when performing high grayscale display.

In FIG. 38A, the one labeled F2 is the second display period, the one labeled S21 is the second initialization period, the one labeled S22 is the second data writing-in period, and the one labeled S23 is the second light emitting period;

In the second light emitting phase S23, the first light emitting control signal provided by EM1 is a square wave voltage signal with a large duty ratio, and HF provides a high voltage signal.

The difference between the working timing diagram shown in FIG. 38B and the working timing diagram shown in FIG. 38A is that: during the entire display period, HF is a square wave voltage signal. At this time, HF can be provided by a driver IC (integrated circuit). The driver IC periodically gives a signal. Within one frame of display time, the driver IC will provide a square wave voltage signal for VF.

The display device described in the embodiment of the present disclosure includes the above-mentioned pixel circuit.

The display device in the embodiments of the present disclosure may be any product or component with a display function, such as a wearable device, a mobile phone, a tablet computer, a television, a monitor, a laptop computer, a digital photo frame, a navigator, or the like.

The above descriptions are implementations of the present disclosure. It should be pointed out that those skilled in the art can make some improvements and modifications without departing from the principle of the present disclosure. These improvements and modifications shall also fall within the scope of the present disclosure.

1. A pixel circuit, comprising a first light emitting control circuit, a light emitting element, a driving circuit and a light emitting gating circuit; wherein
the first light emitting control circuit is electrically connected to a first light emitting control terminal, a first voltage terminal and a first terminal of the driving circuit respectively, and is configured to control the connection between the first voltage terminal and the first terminal of the driving circuit under the control of a first light emitting control signal provided by the first light emitting control terminal during a light emitting phase;
a second terminal of the driving circuit is electrically connected to a first electrode of the light emitting element, and the driving circuit is configured to drive the light emitting element;
the light emitting gating circuit is configured to control, under the control of a first control signal provided by the first control terminal, according to a light emitting data voltage provided by the light emitting data voltage terminal, to form a current path between the second terminal of the driving circuit and the light emitting element in the light emitting phase under the control of a light emitting control voltage provided by the light emitting control voltage terminal, to control the driving circuit to control the light emitting element to emit light, or to control to form the current path between the second terminal of the driving circuit and the light emitting element in the light emitting phase, to control the driving circuit to control the light emitting element to emit light, or to control to generate the current path between the second terminal of the driving circuit and the light emitting element in the light emitting phase under the control of the first light emitting control signal, to control the driving circuit to control the light emitting element to emit light.

2. The pixel circuit according to claim 1, wherein the light emitting gating circuit includes a second light emitting control circuit and a first gating control circuit;
the first gating control circuit is electrically connected to the first control terminal, the light emitting data voltage terminal, a gating control terminal, a second light emitting control terminal, a light emitting control voltage terminal and the first light emitting control terminal respectively, and is configured to write a light emitting data voltage provided by the light emitting data voltage terminal into the gating control terminal under the control of the first control signal, and control the second light emitting control terminal to be connected to the light emitting control voltage terminal or to be connected to the first light emitting control terminal under the control of a potential of the gating control terminal;
the second light emitting control circuit is electrically connected to the second light emitting control terminal, the second terminal of the driving circuit and the first electrode of the light emitting element respectively, and is configured to control the second terminal of the driving circuit to be connected to the first electrode of the light emitting element under the control of a potential of the second light emitting control terminal;
a second electrode of the light emitting element is electrically connected to the second voltage terminal.

3. The pixel circuit according to claim 2, wherein the light emitting gating circuit further comprises a first capacitor;
a first terminal of the first capacitor is electrically connected to the gating control terminal, and a second terminal of the first capacitor is electrically connected to the first initial voltage terminal.

4. The pixel circuit according to claim 2, wherein the first gating control circuit comprises a first transistor, a second transistor and a third transistor;
a control electrode of the first transistor is electrically connected to the first control terminal, a first electrode of the first transistor is electrically connected to the light emitting data voltage terminal, and a second electrode of the first transistor is electrically connected to the gating control terminal;
a control electrode of the second transistor is electrically connected to the gating control terminal, a first electrode of the second transistor is electrically connected to the light emitting control voltage terminal, and a second electrode of the second transistor is electrically connected to the second light emitting control terminal;
a control electrode of the third transistor is electrically connected to the gating control terminal, a first electrode of the third transistor is electrically connected to the first light emitting control terminal, and a second electrode of the third transistor is electrically connected to the second light emitting control terminal.

5. The pixel circuit according to claim 2, wherein the second light emitting control circuit comprises a fourth transistor;
a control electrode of the fourth transistor is electrically connected to the second light emitting control terminal, a first electrode of the fourth transistor is electrically connected to the second terminal of the driving circuit, and a second electrode of the fourth transistor is electrically connected to the first electrode of the light emitting element.

6. The pixel circuit according to claim 4, wherein the first transistor is an n-type transistor, the second transistor is a p-type transistor, and the third transistor is an n-type transistor; or,
the first transistor is an n-type transistor, the second transistor is an n-type transistor, and the third transistor is a p-type transistor; or,
the first transistor is a p-type transistor, the second transistor is an n-type transistor, and the third transistor is a p-type transistor,
wherein when the second transistor is a p-type transistor and the third transistor is an n-type transistor, a width-to-length ratio of a channel of the third transistor is greater than a width-to-length ratio of a channel of the second transistor.

7. (canceled)

8. The pixel circuit according to claim 2, wherein the light emitting gating circuit includes a second gating control circuit, a third light emitting control circuit and a fourth light emitting control circuit;
the second gating control circuit is electrically connected to the first control terminal, the light emitting data voltage terminal and the gating control terminal respectively, and is configured to write the light emitting data voltage into the gating control terminal under the control of the first control signal;
the third light emitting control circuit is electrically connected to the gating control terminal, the second electrode of the light emitting element and the second voltage terminal respectively, and is configured to control the connection between the second electrode of the light emitting element and the second voltage terminal under the control of the potential of the gating control terminal;
the fourth light emitting control circuit is electrically connected to the light emitting control voltage terminal, the second electrode of the light emitting element and the second voltage terminal respectively, and is configured to control the connection between the second electrode of the light emitting element and the second voltage terminal under the control of the light emitting control voltage provided by the light emitting control voltage terminal.

9. The pixel circuit according to claim 8, further comprising a fifth light emitting control circuit; wherein
the fifth light emitting control circuit is electrically connected to the first light emitting control terminal, the second terminal of the driving circuit and the first electrode of the light emitting element respectively, and is configured to control the connection between the second terminal of the driving circuit and the first electrode of the light emitting element under the control of the first light emitting control signal;
or
wherein the light emitting gating circuit further comprises a second capacitor; a first terminal of the second capacitor is electrically connected to the gating control terminal, a second terminal of the second capacitor is electrically connected to the first initial voltage terminal.

10. (canceled)

11. The pixel circuit according to claim 8, wherein the second gating control circuit includes a fifth transistor, the third light emitting control circuit includes a sixth transistor, and the fourth light emitting control circuit includes a seventh transistor;
a control electrode of the fifth transistor is electrically connected to the first control terminal, a first electrode of the fifth transistor is electrically connected to the light emitting data voltage terminal, and a second electrode of the fifth transistor is electrically connected to the gating control terminal:
a control electrode of the sixth transistor is electrically connected to the gating control terminal, a first electrode of the sixth transistor is electrically connected to the second electrode of the light emitting element, and a second electrode of the sixth transistor is electrically connected to the second voltage terminal;
a control electrode of the seventh transistor is electrically connected to the light emitting control voltage terminal, a first electrode of the seventh transistor is electrically connected to the second electrode of the light emitting element, and a second electrode of the seventh transistor is electrically connected to the second voltage terminal,
wherein the seventh transistor is a p-type transistor, the sixth transistor is an n-type transistor, and the fifth transistor is an n-type transistor: or the seventh transistor is a p-type transistor, the sixth transistor is an n-type transistor, and the fifth transistor is a p-type transistor; or the seventh transistor is an n-type transistor, the sixth transistor is a p-type transistor, and the fifth transistor is an n-type transistor: or, the seventh transistor is an n-type transistor, the sixth transistor is a p-type transistor, and the fifth transistor is a p-type transistor.

12. (canceled)

13. The pixel circuit according to claim 1, further comprising a data writing-in circuit, a compensation control circuit, a first initialization circuit, a second initialization circuit and a third capacitor; wherein
the data writing-in circuit is electrically connected to the second control terminal, a data line and the first terminal of the driving circuit respectively, and is configured to write a data voltage provided by the data line into the first terminal of the driving circuit under the control of the second control signal provided by the second control terminal;
the compensation control circuit is electrically connected to a third control terminal, the control terminal of the driving circuit and the second terminal of the driving circuit respectively, and is configured to control the communication between the control terminal of the driving circuit and the second terminal of the driving circuit under the control of a third control signal provided by the third control terminal;
the first initialization circuit is electrically connected to a first reset control terminal, the control terminal of the driving circuit and a third initial voltage terminal respectively, and is configured to write a third initial voltage provided by the third initial voltage terminal into the control terminal of the driving circuit under the control of a first reset control signal provided by the first reset control terminal;
the second initialization circuit is electrically connected to a second reset control terminal, the first electrode of the light emitting element and a fourth initial voltage terminal respectively, and is configured to write a fourth initial voltage provided by the fourth initial voltage terminal into the first electrode of the light emitting element under the control of a second reset control signal provided by the second reset control terminal;
a first terminal of the third capacitor is electrically connected to the control terminal of the driving circuit, and a second terminal of the third capacitor is electrically connected to the first voltage terminal.

14. The pixel circuit according to claim 13, wherein the first initialization circuit includes an eighth transistor, the compensation control circuit includes a ninth transistor, the data writing-in circuit includes a tenth transistor, and the second initialization circuit includes an eleventh transistor;
a control electrode of the eighth transistor is electrically connected to the first reset control terminal, a first electrode of the eighth transistor is electrically connected to the third initial voltage terminal, and a second electrode of the eighth transistor is electrically connected to the control terminal of the driving circuit;
a control electrode of the ninth transistor is electrically connected to the third control terminal, a first electrode of the ninth transistor is electrically connected to the control terminal of the driving circuit, and a second electrode of the ninth transistor is electrically connected to the second terminal of the driving circuit;
a control electrode of the tenth transistor is electrically connected to the second control terminal, a first electrode of the tenth transistor is electrically connected to the data line, and a second electrode of the tenth transistor is electrically connected to the first terminal of the driving circuit; or the control electrode of the tenth transistor is electrically connected to the first reset control terminal, the first electrode of the tenth transistor is electrically connected to the light emitting data voltage terminal, and a second electrode of the tenth transistor is electrically connected to the first terminal of the driving circuit;
a control electrode of the eleventh transistor is electrically connected to the second reset control terminal, a first electrode of the eleventh transistor is electrically connected to the fourth initial voltage terminal, and a second electrode of the eleventh transistor is electrically connected to the first electrode of the light emitting element.

15. (canceled)

16. (canceled)

17. (canceled)

18. (canceled)

19. A pixel driving method, applied to the pixel circuit according to claim 1, the pixel driving method comprising:
in the light emitting phase, controlling, by the first light emitting control circuit, the first voltage terminal to be connected to the first terminal of the driving circuit under the control of the first light emitting control signal;
controlling, by the light emitting gating circuit, under the control of the first control signal, according to the light emitting data voltage, during the light emitting phase and under the control of the light emitting control voltage provided by the light emitting control voltage terminal, to generate the current path between the second terminal of the driving circuit and the light emitting element, to control the driving circuit to control the light emitting element to emit light, or to generate the current path between the second terminal of the driving circuit and the light emitting element during the light emitting phase, so as to control the driving circuit to control the light emitting element to emit light.

20. The pixel driving method according to claim 19, wherein the light emitting gating circuit includes a second light emitting control circuit and a first gating control circuit; and the pixel driving method includes:
writing, by the first gating control circuit, under the control of the first control signal, the light emitting data voltage into the gating control terminal, and, under the control of the potential of the gating control terminal, controlling the second light emitting control terminal to be connected to the light emitting control voltage terminal, or controlling the second light emitting control terminal to be connected to the first light emitting control terminal;
controlling, by the second light emitting control circuit, the connection between the second terminal of the driving circuit and the first electrode of the light emitting element under the control of the potential of the second light emitting control terminal;
or
wherein the light emitting gating circuit includes a second gating control circuit, a third light emitting control circuit and a fourth light emitting control circuit; and the pixel driving method includes:
writing, by the second gating control circuit, the light emitting control voltage into the gating control terminal under the control of the first control signal:
controlling, by the third light emitting control circuit, the second electrode of the light emitting element to be connected to the second voltage terminal under the control of the potential of the gating control terminal;
controlling, by the fourth light emitting control circuit. the second electrode of the light emitting element to be connected to the second voltage terminal under the control of the light emitting control voltage.

21. (canceled)

22. A pixel driving method, applied to the pixel circuit according to claim 1, wherein the display period includes a first phase and a light emitting phase which are arranged successively; the pixel driving method includes:
in the first phase, writing, by the light emitting gating circuit, the light emitting data voltage provided by the light emitting data voltage terminal under the control of the first control signal;
controlling, by the first light emitting control circuit, the first voltage terminal to be disconnected from the first terminal of the driving circuit under the control of the first light emitting control signal;
in the light emitting phase, controlling, by the first light emitting control circuit, the first voltage terminal to be connected to the first terminal of the driving circuit under the control of the first light emitting control signal;
in the light emitting phase, controlling, by the light emitting gating circuit, to generate the current path between the second terminal of the driving circuit and the light emitting element according to the light emitting data voltage and under the control of the light emitting control voltage provided by the light emitting control voltage terminal, to control the driving circuit to control the light emitting element to emit light, or controlling, by the light emitting gating circuit, to generate the current path between the second terminal of the driving circuit and the light emitting element under the control of the first light emitting control signal, to control the driving circuit to control the light emitting element to emit light.

23. The pixel driving method according to claim 22, wherein in the light emitting phase, both the first light emitting control signal and the light emitting control voltage are square wave voltage signals.

24. The pixel driving method according to claim 23, wherein the light emitting gating circuit includes a second light emitting control circuit and a first gating control circuit; the pixel driving method includes: in a first display mode,
in the first phase, writing, by the first gating control circuit, the light emitting data voltage into the gating control terminal under the control of the first control signal, and controlling, by the first gating control circuit, the second light emitting control terminal to be connected to the first light emitting control terminal under the control of the potential of the gating control terminal;
in the light emitting phase, when the first light emitting control signal is a valid voltage signal, controlling, by the first light emitting control circuit, the connection between the first voltage terminal and the first terminal of the driving circuit under the control of the first light emitting control signal, and controlling, by the second light emitting control circuit, the connection between the second terminal of the driving circuit and the first electrode of the light emitting element under the control of the first light emitting control signal, and driving, by the driving circuit, the light emitting element to emit light.

25. The pixel driving method according to claim 23, wherein the light emitting gating circuit comprises a second light emitting control circuit and a first gating control circuit; the pixel driving method comprises: in a second display mode,
in the first phase, writing, by the first gating control circuit, the light emitting data voltage into the gating control terminal under the control of the first control signal, and controlling, by the first gating control circuit, the connection between the second light emitting control terminal and the light emitting control voltage terminal under the control of the potential of the gating control terminal;
in the light emitting phase, when the first light emitting control signal is a valid voltage signal, controlling, by the first light emitting control circuit, the first voltage terminal to be connected to the first terminal of the driving circuit under the control of the first light emitting control signal;
in the light emitting phase, when the light emitting control voltage is a valid voltage, controlling, by the second light emitting control circuit, under the control of the first light emitting control signal, the second terminal of the driving circuit to be connected to the first electrode of the light emitting element, and driving, by the driving circuit, the light emitting element to emit light; when the light emitting control voltage is an invalid voltage, controlling, by the second light emitting control circuit, under the control of the first light emitting control signal, the second terminal of the driving circuit to be disconnected from the first electrode of the light emitting element.

26. The pixel driving method according to claim 25, wherein a frequency of the first light emitting control signal is less than a frequency of the light emitting control voltage;
in the display period, a time length during which a potential of the first light emitting control signal continues to be an invalid voltage is shorter than a time length during which the light emitting control voltage continues to be an invalid voltage,
wherein a frequency of the light emitting control voltage is greater than or equal to twice a frequency of the first light emitting control signal.
in the display period, a time length during which the potential of the first light emitting control signal continues to be the valid voltage is greater than 2×t1+t2; wherein t1 is a time during which the light emitting control voltage continues to be a valid voltage, and 12 is a time during which the light emitting control voltage continues to be an invalid voltage.
a pixel density of the pixel circuit included in a display panel is less than or equal to a pixel density threshold.

27. (canceled)

28. (canceled)

29. (canceled)

30. The pixel driving method according to claim 25, wherein the frequency of the first light emitting control signal is equal to the frequency of the light emitting control voltage;
in the display period, a time length during which the potential of the first light emitting control signal continues to be an invalid voltage is shorter than a time length during which the light emitting control voltage continues to be an invalid voltage.
wherein a pixel density of the pixel circuit included in the display panel is greater than a pixel density threshold.

31. (canceled)

32. A display device comprising the pixel circuit according to claim 1.
